(19) United States
(12) Patent Application Publication
(10) Pub. No.: US 2003/0023435 A1
(43) Pub. Date: Jan. 30, 2003

(54) Interfacing apparatus and methods

(76) Inventor: Daryl Craig Josephson, Burlingame, CA (US)

Correspondence Address: Daryl C. Josephson, 1500 Broadway, #204, Burlingame, CA, 94010, US

(21) Appl. No.: 09/905,590

(22) Filed: Jul. 13, 2001

Related U.S. Application Data
(60) Provisional application No. 60/217,963, filed on Jul. 13, 2000.

(51) Int. Cl. G10L 15/26

(52) U.S. Cl. 704/235

(57) ABSTRACT

Aspects of the invention provide for interfacing one or more users or groups of users with one or more machines or groups of machines in a manner adaptable to conventional and non-conventional control and data entry capabilities, and that can be used alone and in conjunction with other interfacing elements, approaches and operabilities. Complete interfaces, command sets, commands, feedback, and new environments and operations are also enabled in a modifiable, extensible, broadly applicable and portable manner that is capable of exploiting flexibility, suggestibility and other aspects of human expression. New interfacing and programming tools also can also be used to replace, extend and/or be superimposed with conventional/non-conventional interface elements, capabilities and/or other more useful “expressive” and/or “event-based” interfacing.

### CROSS-REFERENCE TO RELATED APPLICATIONS

The present application hereby claims priority to U.S. Provisional Application No. 60/217,963, by Daryl C. Josephson, filed on Jul. 13, 2000, and entitled “Conversational Voice Interfacing Apparatus and Methods.” Application No. 60/217,963 is hereby fully incorporated herein by reference.

### BACKGROUND OF THE INVENTION

1. Field of the Invention

The present invention relates generally to processing systems and, more particularly, to user-interface construction and implementation.

2. Background

Maturing speech technologies hold great promise for human-machine interaction.

Continuous voice dictation (“speech-to-text”) and machine recitation (“speech synthesis” or “text-to-speech”) continue to improve. Speech programs provide better dictaphone-like recording and transcription. More capable programming tools for driving corresponding speech engines are also becoming available, and reduced resource requirements are making “voice enabling” of less capable devices more practicable. Despite such improvements, however, interfacing and programming-tools remain inefficient in several respects.

One problem is that the basis for nearly all interfacing remains that of traditional graphical user interfaces (“GUIs”). Compared with typed “command-lines,” GUIs offer a more intuitive pointer-based mechanism for stepping programs through their operational steps. Traditional GUIs form separate graphic depictions according to displayable functional divisions (e.g. windows) within which a user finds and selects data indicators; the user can then select a tool to affect the already-selected data. Each mouse movement and “click” is simple and encapsulated, and a simple feedback indicator reflects that function has been initiated (e.g. menu item graying, button “pushing”, and so on). Unfortunately, using such a GUI to find items, enter data and execute mouse motions can be time consuming, confusing and distracting.

Current “voice-mousing” approaches essentially mirror physical GUI mouse motions with nearly interchangeable independent and encapsulated spoken phrases. In Dragon Systems' NaturallySpeaking®, for example, a user can use a voice/mouse command to move to a window section (e.g. “Type tab”), another to select one or (sometimes) more previous or following data items in the section (e.g. “Select next”, “Select previous n”), and another to invoke a graphic tool to affect the selected data, e.g. saying “Click edit” [menu] then “Cut” [menu item]. (The bracketed words are not spoken.) Unfortunately, current voice-mousing can feel even more awkward and confusing than using a physical mouse, especially when interposed with dictating.

Enunciating each of often numerous voice-mousing commands can also become difficult, and different commands tend to apply depending on a current PC program, window, window segment or function.

In a different “question and answer” interfacing approach, a user typically performs data or function selection responsively to a presented question and a traditional GUI-window like set of responsive options (by speaking into a phone, mousing, etc.). However, narrow questions, limited real estate, etc. enable only a limited set of alternative responses. Additionally, listening or looking and responding can nevertheless become time consuming and even confusing (e.g. when trying to find a particular desired option), and current attempts can become interruptive, imposing and inefficient. Initiating each response (particularly using speech) can also once again be problematic.

A further “conversation” type voice interfacing is also expected that will enable a user to communicate back-and-forth with his personal computer (“PC”) as in free-form conversation with another person. Unfortunately, on the one hand, a user will likely be presented with a confusingly numerous array of potential wordings for referencing a particular “available” data item or function for a particular PC and program. On the other hand, providing the extensive phrase possibilities quickly increases resource requirements, and given the associated overhead, many possibilities might not be supported (at least, using current technology). Worse yet, supported possibilities will likely again be based on the traditional GUI constructs with which programmers are most familiar, giving rise to problems such as those already noted.

This applicant has further observed that conventional and emerging implementations of the above approaches -though potentially useful—fail to address, let alone facilitate or exploit characteristics of human interaction, such as with speech. Each approach also tends to be device dependent and to inherently exclude the others.

The above and other problems are also exacerbated due to conventional programming tools. Some are limited by their adherence to existing GUI programs (e.g. using traditional, GUI-function based macros or functions). Others complicate useful command production with traditional instruction sets tied to a (speech) recognition engine, synthesis engine and existing command for a particular platform, program, function and user. (Naturally Speaking commands, for example, are speaker dependent and programmed as either always active or “global”, or always active within a particular window of a given PC program, or “program-specific.”) Current tools also fail to address unique considerations in applying speech interfacing to existing programs and environments, as well as to other potential applications and operability to which speech interfacing might otherwise be applicable.

Accordingly, there is a need for interface systems and methods that are capable of providing more intuitive and efficient control. There is further a need for interface apparatus and methods that enable efficient commands to be determined and constructed for providing such control. There is also a need for methods and apparatus that enable voice control and dictation interfacing to be accomplished in a manner that accommodates and exploits the use of speech, and which are applicable to traditional and/or other bases, approaches, tools, devices, and so on.

### SUMMARY OF THE INVENTION

Aspects of the invention provide for interfacing one or more users or groups of users with one or more machines or groups of machines in a manner adaptable to conventional and non-conventional control and data entry capabilities, and that can be used alone and in conjunction with other interfacing elements, approaches and operabilities. Complete interfaces, command sets, commands, feedback, and new environments and operations are also enabled in a modifiable, extensible, broadly applicable and portable manner that is capable of exploiting flexibility, suggestibility and other aspects of human expression. New interfacing and programming tools also can also be used to replace, extend and/or be superimposed with conventional/non-conventional interface elements, capabilities and/or other more useful “expressive” and/or “event-based” interfacing.

Embodiments of the invention provide for constructing “conversant” control and data entry/modification forming all or part of a voice, non-voice or combined interface. Interface elements can be constructed, for example, by analyzing the “nature” of an application and its purposes/uses, ascertaining underlying machine capabilities and interface aspects if one or more underlying machines are used, determining abstracted or distilled contextual applicability of the determinations, and forming, in accordance therewith, conversant commands for accomplishing basic tasks and task permutations. A resulting command set or “language” can also be similarly extended using stored or received information to copy/modify existing command elements, form consistent or complimentary elements or accommodate specific unique elements (e.g. via local installation, more temporary/persistent mobile code, user/interface information transfer, and so on).

Embodiments also enable a command-set or “group” to be formed including aspects applicable to data input, manipulation, control or some combination. Basic tasks and task permutations can, for example, be received and a basic command and command permutations can be formed using verbiage selected to express, in a consistent manner, specificities applicable to one or more conventional functional division (e.g. within different windows, window groups, programs, environments, devices, applications, and so on). Embodiments further provide “conversational factors” and other aspects according to which commands can be structured, populated with verbiage and rendered operable in a replacing, independent, complimentary, integrateable and/or superimposed manner. For example, a user's ongoing expectations can be met/guided by forming conversant structures and populating the structures with verbiage to apply consistent “rhythmic flow” within a general or specific conversant context (e.g. working with lists); rhythmic flow can also be made to vary in a determinable manner according to factors such as a new, sub or intermittent context, and/or mentally combinable verbiage portions for providing varying degrees of implicit or explicit specificities of user, subject object or action/tool variations. Such structures/verbiage can further enable direct/indirect and explicit/implicit data input (e.g. dictation) as well as control, e.g. via generally applicable, specific or automatically relatable “designations”.

Embodiments also enable the forming of command structures and populating of the structures with one or more expectable data, tool and environment designations which designations are further adaptable to the conversational factors. Designations can be provided according to relative, absolute, aliased, “anti-aliased”, combined, cued and/or direct bases (among others). Thus, for example, suitable interface embodiments can enable one or more users to intuitively and continuously recite commands, each command being capable of intuitively designating varying specificities of local/remote, not displayed and/or otherwise not available controls, user indications, cues and/or data according to variable approaches.

Among other aspects, embodiments further enable adjunct actions and/or feedback to be automatically (e.g. programmatically) provided in conjunction with commands. One method, for example, receives a partially expressed user task, determines corresponding machine control specifics (e.g. corresponding data, tools, machines), executes corresponding machine functionalities, and then repositions a “current” designation according to the task. Other methods provide capabilities for facilitating “filling out forms”, demonstrating features, completing tasks, adding guiding feedback, “carrying” data, executing cues, providing source-directed machine responses, and so on, as is/are contextually or otherwise desirable. Commands can also exploit new, otherwise unavailable or less accessible underlying machine(s) capabilities.

Particularly useful in conjunction with these and other embodiments is interfacing consistently with “instructing a machine as with an assistant”, or alternatively, instructing a machine as with “instructing a machine operator who correspondingly controls a machine” (or otherwise completes tasks).

Advantageously, these and other aspects enable a user to conduct interfacing in a more intuitive, largely subliminally guided manner using a variety of interfacing, environments, applications, interface elements, speech engines and/or machines. Functional steps, such as preparatory movement, selection, searching and switching, can be minimized. Functional divisions can be made substantially ignorable or selectively apparent to a user. Continuous/interrupted enunciation and user progress can be facilitated, while enabling a user to continue/interject tasks or move on in an “expectable” manner. A command or command group can also obviate pointer gestures, maximize user efficiency and minimize user memorization/system resource requirements, while even disparate interaction becomes more intuitive and easily effectuated.

A resultant “language” is further not only easier to articulate and less arduous than prior speech controls, but is also more intuitive, flexible, accurately recognized and portable and extensible as well. A merging among various types of control, data entry and “gesturing” is also provided, and creation of new commands is also facilitated since new commands (e.g. for a new machine or application) can be simply loaded, downloaded or otherwise added as needed, or the language itself can be readily modified to more conversantly accommodate new uses, among other examples.

### BRIEF DESCRIPTION OF THE DRAWINGS

FIG. 1 is a flow diagram illustrating a conversance-enabled system according to an embodiment of the invention;

FIG. 2 is a block diagram illustrating a processing system according to an embodiment of the invention;

FIG. 3a illustrates an assistant scenario according to an embodiment of the invention;

FIG. 3b is a flow diagram illustrating an application of conversant aspects and interfacing, including contexts, tasks, specificity and enhancement, according to an embodiment of the invention;

FIG. 3c is a flow diagram illustrating a further application of conversant aspects and interfacing to local/remote real or virtual machines, according to an embodiment of the invenion;

FIG. 4a is a flow diagram illustrating a command creator according to an embodiment of the invention;

FIG. 4b is a block diagram illustrating an I/O analyzer according to an embodiment of the invention;

FIG. 4c is a flow diagram illustrating a distributed command creator according to an embodiment of the invention;

FIG. 5a is a block diagram illustrating a command structure according to an embodiment of the invention;

FIG. 5b illustrates a command group according to an embodiment of the invention;

FIG. 6a is a flow diagram illustrating a command executor according to an embodiment of the invention;

FIG. 6b is a flow diagram illustrating a further command executor according to an embodiment of the invention;

FIG. 7a is a block diagram illustrating an input engine according to an embodiment of the invention;

FIG. 7b is a block diagram illustrating a command engine according to an embodiment of the invention;

FIG. 7c is a block diagram illustrating an application support engine according to an embodiment of the invention;

FIG. 7d is a block diagram illustrating a designation engine according to an embodiment of the invention;

FIG. 7e is a block diagram illustrating an enhancement engine according to an embodiment of the invention;

FIG. 8a is a block diagram illustrating a user engine according to an embodiment of the invention;

FIG. 8b is a block diagram illustrating a use engine according to an embodiment of the invention;

FIG. 8c is a block diagram illustrating a security engine according to an embodiment of the invention;

FIG. 8d is a block diagram illustrating a reliability engine according to an embodiment of the invention;

FIG. 8e is a block diagram illustrating a conversance engine according to an embodiment of the invention;

FIG. 8f is a block diagram illustrating a history engine according to an embodiment of the invention; and

FIG. 8g is a block diagram illustrating an information retriever according to an embodiment of the invention;

### DETAILED DESCRIPTION

In providing for interfacing one or more users or groups of users with one or more machines or groups of machines, aspects of the invention enable a user experience of intuitively and flexibly expressing user objectives that are anticipated, followed, facilitated and/or guided by the interface. Aspects provide for speech and/or non-speech interaction, varying environments/approaches, use of one or more conventionally or specially configured machines, command-set creation, implementation and/or conversion, among others. Aspects also enable augmentation/replacement of one or more host (“underlying”) interface/operability elements with one or more conversant “command” interfaces and/or operabilities for enabling one or more users or machines to concurrently, collaboratively or separately communicate or otherwise handle “information” (i.e. program code, controls and/or data), among other aspects.

The following discussion will reference an exemplary “OE voice-interface” or “OEVI” example through which various aspects of the invention might be better understood. The OEVI initially focused on testing interfacing techniques with even popular off-the-shelf PC software. The software included, for convenience, a PC-based email program, operating system and speech tools (Microsoft Outlook Express™ or “OE”, MS Windows® and Dragon Systems NaturallySpeaking or “NS” Professional, respectively). Alteration of conventional program operation, new machine/tool characteristics and user impact were iteratively made and studied, and further aspects can be implemented as well. (Note that the term “or,” as used herein, is generally intended to mean “and/or” unless otherwise indicated. “Combinations” will also be specifically noted where terminology is foreseen as rendering the ability to separate or combine unclear.)

OEVI and other interfacing aspects are, however, capable of rendering particular applications, machines, platforms, speech tools/engines, included underlying interfaces or operations and other factors mere combinable implementation options. Underlying interfacing elements can, for example, include a graphical user interface (“GUI”) or more sophisticated elements (e.g. 3-D audio/visual, animation, shared/remote access, and so on). User-control devices can include existing/future processes or devices (e.g. display, pointer, keyboard, tactile, biometrics, and so on), and graphic or virtual/augmented reality or other environments supportable. Interfacable devices and/or processes or “machines” can include set-top boxes, palmtops, personal digital assistants (“)PDAs”), personal information managers (“PIMs”), media production/presentation, smart appliances/phones, e-commerce, applets, servlets, add-ins, or objects, among substantially any others.

Processed speech or non-speech elements can also be utilized directly or via conversion, adaptation, translation, compilation, encryption/decryption, synchronization, and so on. One or more forms of indirect interfacing, such as via recording/playback, transmission, and the like, is (or are) also supportable, as are existing or new machines consistent with the teachings herein.

The OEVI implementation also illustrates limitations of prior elements, such as those given above, as well as aspects to which such elements proved at least less desirable, if not incompatible. Therefore, where helpful, aspects are discussed in terms of the OEVI, implementations “consistent with the OEVI” or “OEVI-like” (but not necessarily fully implementable), and more advanced implementations for which the use of more capable elements is suggested by evaluations conducted thus far. (Such indications, as with section titles or other labels, are provided herein to facilitate discussion and should not be construed as limiting.)

Interfacing System Embodiments

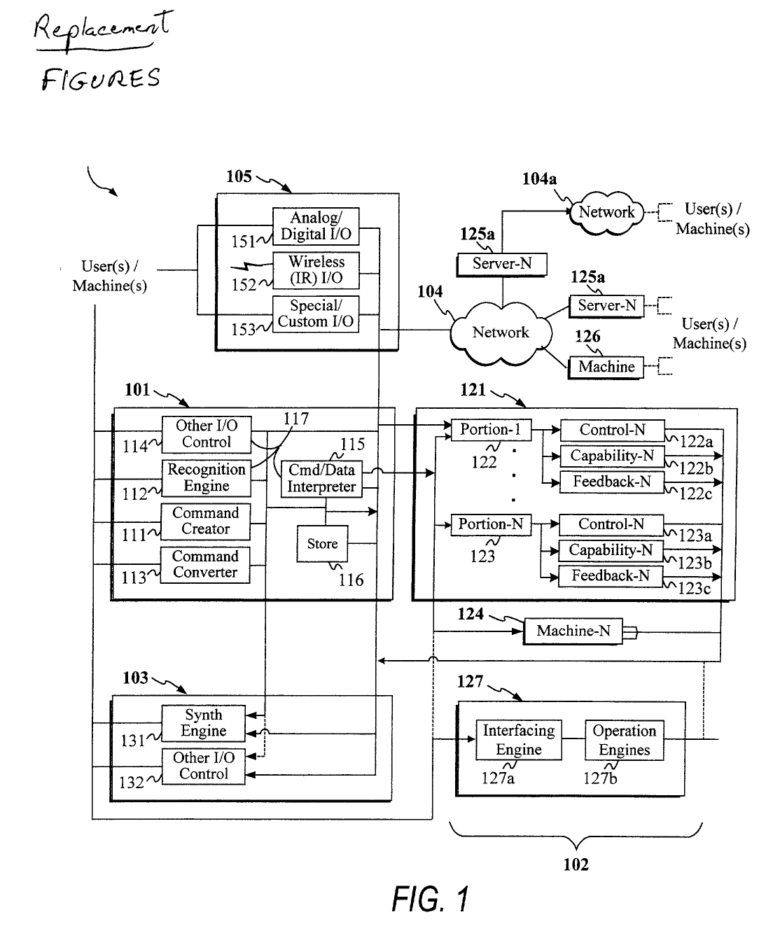

Referring now to FIG. 1, an interfacing system 100 is illustrated that is capable of creating, configuring, executing, converting or otherwise “handling” conversant interfacing commands, approaches, operations and environments in accordance with an embodiment of the invention. System 100 comprises at least intermittently communicatingly couplable elements including conversant interface processor 101 (hereinafter “interface processor”), machines 102, output processor 103 and additional I/O devices 105. (It will be appreciated that one or more of the elements depicted in FIG. 1 or the remaining figures can also be implemented in a more separated or integrated manner, or even removed or rendered inoperable in certain cases, as is useful in accordance with a particular application.)

Exemplary directional signal arrows within FIG. 1 indicate how, in an implementation consistent with the OEVI, user input can be processed by interface processor 101 to produce operational controls useful in operating one or more of machines 102. Interface processor 101 or machine 102 output can further be processed by output processor 103 to present one or more local or remote users with one or more of audio, visual, tactile or other multimedia feedback. (Signal arrows provided within the remaining figures should also be considered exemplary, unless otherwise specifically noted.)

Machines 121 and 124 can, for example, include GUI-based underlying or “host” PC programs, each including windows (e.g. 122, 123) having various levels of window segments that can be operated via user input and provide feedback, such as was already described. However, portions of other wired or wirelessly coupled machines (e.g. 124, 127 or via servers 125-126) can also be operated in a direct, indirect or independent (e.g. “coordinated”, “linked” or separate) manner. Interface processor 101 can also provide not-input command portions (e.g. below “enhancements”) to one or more machines for guiding/advancing user interaction, providing feedback, modifying machine operation, etc. Machines 102, output processor 103 or controls 105 can also originate “input” (e.g. via manual/remote actuation, feedback, and so on), effectuate handling aspects or be operated as a result of such handling. Handling can further be effectuated concurrently (e.g. via concurrent instantiation, interfacing element initiation, directed single source control, etc.), among other examples, only some of which might be specifically noted herein. (The term “portion” is used herein to refer to a denoted element in whole or part.)

1. Element Examples

Interface processor 101 provides for receiving input from one or more users, machines or other accessible input sources, for creating, converting or translating commands (including “conversant” commands), or for causing such commands to operate one or more machines.

Interface processor 101 comprises conversance-enabled elements including (conversant) command creator 111, recognition engine 112, command converter 113, I/O control 114, command/data interpreter 115 (hereinafter “command interpreter”), and storage 116.

Command creator 111 processes received user, machine, host or conversant user/machine interface information and modifies one or more existing command portions, creates new command portions, or combinations thereof, the resulting command portions being implementable by command interpreter 115 or other interfacing elements (e.g. engine 127a).

Resulting command elements can include conversant as well as conventional or other command types, as for example, discussed below. Recognition engine 112 provides for translating received information into a form (e.g. words or other expressions, representations, controls such as program code, or data) suitable for use by command interpreter 115 or other system 100 elements, and can comprise a conventional or more advanced speech engine. Typically, recognition engine 112 receives and converts user input (e.g. digitized user speech) into a useable “recognized” form (e.g. words, controls, program code or data), and communicates the resulting recognized information to command interpreter 115. Recognition engine 112 can also communicate recognized information to other elements, including but not limited to other interpreters, such as engine 127a. (A more advanced recognition engine also enables processing of non-speech gestures or other “continuous” or event input, such as with the below discussed command interpreter 115.) Command converter 113 provides for receiving and converting/translating information, including conversant information, into forms suitable for operating, providing data or otherwise communicating with one or more machines, interfacing elements, speech engines, etc. Command converter 113 is capable of providing conversion of received input for accommodating different environments, platforms, approaches, users, and so on (e.g. via translation, user preferences, device accommodation, local/remote vocabulary/speech file retrieval, conversion, synchronization, incorporation, security, and so on) as, for example, discussed below.

Command converter 113 enables not real-time “porting” of user, command, machine or other information, as well as runtime conversion or translation (e.g. as a real-time command, spoken language, other expression/event, dialect, formal, colloquial or other identifiably varying usage, inter-machine, special user/machine, or other automatic or user-determinable interpretation support). Such capability can be used, for example, to enable participant-user identification, gesturing (e.g. speech, movement, event) parameter retrieval or multiple user control, dictation, documenting, etc., such as in the below-discussed conversation documenting or multi-user control examples. As with other elements, more centralized or distributed local or remote translation/conversion is also enabled.

I/O controller 114 provides for conducting interfacing among one or more I/O devices or machines, including but not limited to conversant or non-conversant devices/machines, mouse, keyboard, front panel controls, remote control, so-called “smart device”, phone/fax, musical instrument, etc. I/O controller 114 typically communicates resulting processed output to other interface processor 101 elements for creation, conversion or interpretation. I/O controller 114 may further provide for downloading/uploading information (e.g. via “mobile code”, such as Java applets, ActiveX controls, file downloads, and so on), communicating control information or more locally installing such information. (Communicating or initiating use of program code or data can be conducted in an otherwise conventional manner.) Of the remaining interface processor 101 elements, command interpreter 115 provides for determining and effectuating routing and utilization of information from command creator 111, recognition engine 112, command converter 113, storage 116 or other system 100 elements. Command interpreter 115 typically receives processed user/machine input, including conversant input (e.g. conversant speech, other physical gestures, biometrics, events or some combination), and corresponding, supplementary or “enhanced” operational commands or data, interprets such information or portions thereof as needed, and directs interpreted results to one or more appropriate machines. Finally, storage 116 (e.g. RAM/ROM, cache, disk, and the like) more temporarily or persistently stores current or prior commands, data or other information received from or supplied to the other elements.

Machines 102 can include one or more local/remote devices or processes that are directly or indirectly operable (via) or participate in handling by communicating information (typically via other interface processor 101 elements) with interface processor 101 or other system 100 elements. Machines 102 need not provide similar functionality or communicate information in the same manner, and can utilize speech, converted speech or non-speech information, so long as respective interface-control or communications mechanisms are producible, ascertainable or otherwise operable in accordance with the teachings herein.

One or more of machines 102 might also include any or all of interface processor 101 elements (e.g. interfacing engine 127a of machine 127) or be coupleable to one or more centralized/distributed such elements; machine operation can also be “coordinated” such that one or more functionalities of separately operating machines appear to a user to operate (using received input) as an integrated system, or are otherwise utilized in a coordinated manner in conjunction with one another (e.g. providing a composite user presentation, other processing, and so on).

Machines 102 can also each comprise one or more still further machines at various levels, such as GUI program window segments, feature sets, question/answer “frames”, sub-devices/processes, systems, components, downloadables, among others. (Conventional or non-conventional mechanisms within machines 102 that provide machine operabilities or enhancements thereof are summarily represented by operation engine 127b of machine 127.) Output produced during machine operation can further be received/ processed by output processor 103, I/O devices 105 or other suitable elements for presentation to a user, other machines or interface processor 101 elements. Machine output can also be provided directly by a machine (e.g. as with controlled audio components, a mobile phone or PDA); however, such output—as with input—might also be modified, re-directed, additionally directed, interpreted, otherwise utilized or some combination.

Operational elements 122a through 122c and 123a through 123c of machine 121 summarily depict elements of one or more of machines 102, the ongoing or intermittent operability of which can be facilitated by system 100. Controls 1-N 122a and 123a correspond with “active” or “current” machine portion functionality (e.g. a window segment at which a user is currently pointing, a telephone or palmtop question-answer frame that is currently presented, and so on). Capabilities-N 122b and 123b are a superset of controls that also includes other not presented, not current or otherwise not conventionally available machine portions/operabilities I that can nevertheless be physically, electronically, programmatically or otherwise accessed, such as other presented or not presented window portions, portions of other programs, other modes or functions or data of the same or other local/remote machines that might be initiated, other menu portions or tools, etc. Feedback 122c and 123c correspond with prior machine feedback, or feedback not ordinarily produced but that a machine is nevertheless capable of presenting or appearing to present (e.g. using the same or another accessible machine or machine portion).

Any one or more of the control, capability or feedback elements of machines 102, having received suitable control information or data from command interpreter 115 or other system 100 elements, might cause an operability or feedback machine-response. These or other operations/feedback can be utilized as might be currently appropriate (e.g. via actual local operation or communication, such as already noted). (In addition to providing an overall conversant user experience, such composite operation can also be used to modify or enhance machine operation in order to provide—to a user—more consistent or other “expectable” responses from non-conversant machines. More specific examples will also be considered or will otherwise become apparent.) Output processor 103 typically provides for presenting received system 100 output to a user. Synthesis engine 131 can comprise one or more conventional speech (or other control/media) synthesis engines for presenting information received from command interpreter 115. However, more capable “active” speech synthesis engines can also be used for processing information received from or presenting information to other interface processor 101 elements, machines 102, remote sources (e.g. via network 104) or I/O controls 105. I/O control 132 can similarly comprise conventional or non-conventional elements for presenting output to a user or other element in accordance with a particular application. (In the OEVI, for example, the NS speech engine and Windows BIOS output functions are utilized via the NS interpreter using command, copy buffer data, buffered or otherwise stored program code or data, and via OE and Windows function calls, respectively. However, other suitable local/remote elements can also be utilized for more efficient use of various data types, sources or destinations, to further support a conversant or other user experience, or otherwise in accordance with a particular application.) Network 104 can comprise one or more suitable networks, such as a wired or wirelessly coupled local area network (“LAN”), wide area network (“WAN”), the Internet, a telephone, cable, cellular, satellite, home or independent smart appliance network, vehicle interconnections, proprietary control connections, centralized, distributed or re-configurable networks, and so on. (It will be appreciated that more than one single or multi-level, static, reconfigurable or other interconnected network is also supportable.)

Server 125 is summarily depicted to indicate one or more suitable devices configurable, for example, in a so-called client-server or peer-to-peer type or other operation, and can include an Internet service provider or “ISP” functionality, server/firewall, corporate/home server or any other suitable server or associated operability. Server 125 can also provide or facilitate system 100 element operabilities or include any suitable elements for re-communicating/passing data or otherwise negotiating network, device, user or elemental security or other information that might be utilized (e.g. firewalls, keys, certificates, synchronization, code/data hosting, forwarding or other handling, etc.).

Server 125 can also be configured to store, communicate, synchronize or otherwise utilize user speech files, other gesturing/events, vocabularies, rules, commands, preferences, files, history or other controls or media. Thus, for example, a user can be identified, such as discussed below; the user's voice print, other biometric information, interface elements, data, programs, settings or other information can further be communicated (temporarily or persistently) from his not present machine, one or more centralized or “global” servers or another I/O device, converted as needed, and then utilized alone or in conjunction with information of one or more other users/machines (e.g. for enabling/documenting interviews, audio/video conferencing control, workgroup participation, interactive demonstration, analysis, and so on.). Server 125 might also initiate, conduct or merely facilitate such operations, or some combination. Where appropriate, symbolic, control or speech translation, formatting, etc. can also be conducted by local or remote command converters/ translators, other elements or some combination.

I/O controls 105 of system 100 summarily depict elements for inputting or outputting to/from a variety of system 100 accessible conversant or non-conversant source or destination machines (e.g. machines 102). I/O controls 105 can include analog/digital I/O 151, IR/RF I/O 152 or other control/data I/O 153 in accordance with a particular application (e.g. communicating with a voice input/output enabled or not enabled machine in conjunction with a speech or other corresponding information initiating source).

It will be appreciated that system 100 provides for extensible implementation variations supporting varying applications. As with the OEVI, for example, system 100 can operate in a manner sufficiently consistent with conventional practices (e.g. superimposed over such practices) to facilitate integration with existing host machines. I/O control 114 can, for example, receive, process and communicate a conventional keyboard or mouse gesture (or other control input). Command creator 111 can receive output from I/O control 114, recognition engine 115 or command interpreter 115 and can store resulting new or modified commands in storage 116. Recognition engine 112 can perform real-time processing of received speech input or convert input commands for storage or output to command interpreter 115, machines 102, output processor 103 or I/O controls 105. Command interpreter 115 can further match received voice-commands from a user to predetermined machine controls for operating machines 102 or producing additional output or limited command enhancements, as with the OEVI, among other examples.

2. Further Examples

Difficulties exist in the particular NS, OE and Windows based OEVI implementation, however, as to limited interfacing and user control capabilities, the limited availability of user/machine information to the interfacing system, limited command/data recognition and recognition accuracy, and so on. For example, the predetermined conversant command-set of the OEVI provides a workable conversant environment that is superimposed over GUI-based PC program portions; nevertheless, the abilities to differentiate user controls and dictation and to provide an efficient and convincingly conversant user interface are limited.

System 100, however, also enables more capable implementations. For example, using more advanced recognition, interpretation or other elements, non-speech input or machine information can be stored or processed by command interpreter 115 in conjunction with other I/O, operational, “history,” speech/non-speech input or other information, or further in accordance with knowledge base metrics, rules or artificial intelligence to more accurately predict, determine or respond to user intent/objectives. User interface/machine use tendencies can, for example, be monitored, analyzed and corresponding information stored on an ongoing or end-of-session other basis in storage 116 or one or more other local/remote storage media; interpreter 115 or other system 100 elements can then retrieve/receive all or portions of such “history” or analyzed history information at interface startup or thereafter, as applicable to current interfacing (e.g. where a machine portion is operable, more specifically accessed or will likely be accessed, at one or more timed intervals, upon some event(s), and so on).

Prior word and grammar based speech-only recognition unreliability can also be avoided via such speech or combined-information history processing, or further, by conducting a differentiating analysis on various “contextual” or other bases (see, for example, below). A more advanced command-interpreter 115 can, for example, determine commands versus dictations or combinations using weighting factors, rules or metrics such as user habit (e.g. situational), other recent or more backward extending input, preferences, apparent objectives, inflection, current underlying interface attributes (e.g. a pointer/curser or operation having been, being or expected to be located within a given platform, program, window, field, frame or position), and so on.

It will further become apparent that non-speech element interpretation can also be utilized in accordance with non-speech expressive or event element attributes including, for example, mouse/pen, biometrics/actuators, various other media, operations or controls, such as gesturing type inflection (e.g. speed, pressure, location, direction), history, and so on. Command enhancements are also enabled that provide for or limit feedback, facilitate user progress, control machine operation, and so on. The system 100 implementation, for example, enables these or other enhancements to similarly benefit from analyzing such information, providing more comprehensive inter-element communication, better anticipating user interaction or other advances in accordance with the teachings herein.

Processing System Embodiments

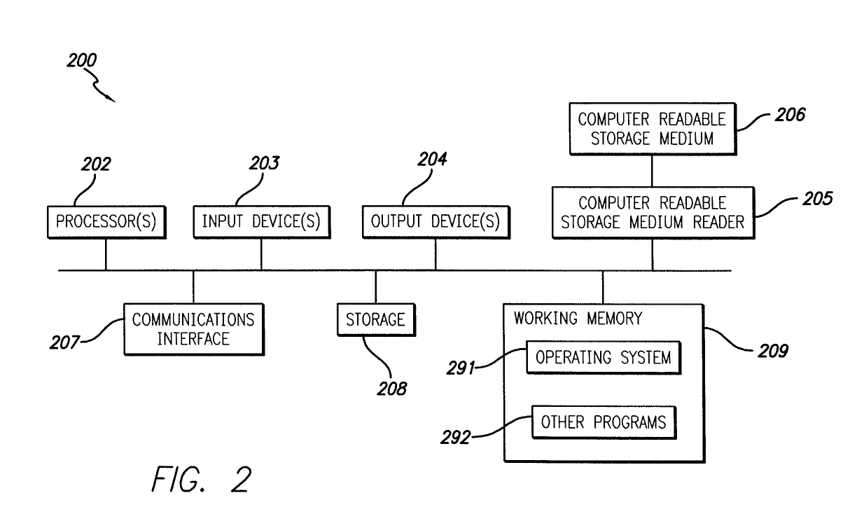

FIG. 2 illustrates an exemplary computing system 200, such as a PC (or other suitable “processing” system), that can comprise one or more of the elements shown in FIG. 1. While other application-specific device/process alternatives might be utilized, such as those already noted, it will be presumed for clarity sake that system 100 elements (FIG. 1) are implemented by one or more processing systems consistent therewith, unless otherwise indicated.

As shown, computer system 200 comprises elements coupled via communication channels (e.g. bus 201) including one or more general or special purpose processors 202, such as a Pentium® or Power PC®, digital signal processor (“DSP”), or other processing. System 200 elements also include one or more input devices 203 (such as a mouse, keyboard, joystick, microphone, remote control unit, tactile, biometric or other sensors, and so on), and one or more output devices 204, such as a suitable display, joystick feedback components, speakers, biometric or other actuators, and so on, in accordance with a particular application.

System 200 elements also include a computer readable storage media reader 205 coupled to a computer readable storage medium 206, such as a storage/memory device or hard or removable storage/memory media; examples are further indicated separately as storage device 208 and memory 209, which can include hard disk variants, floppy/compact disk variants, digital versatile disk (“DVD”) variants, smart cards, read only memory, random access memory, cache memory or others, in accordance with a particular application (e.g. see storage 116 of FIG. 1). One or more suitable communication devices 207 can also be included, such as a modem, DSL, infrared, etc. for providing inter-device communication directly or via suitable private or public networks, such as the Internet (e.g. see I/O control 105 of FIG. 1). Working memory 209 is further indicated as including an operating system (“OS”) 291 and other programs 292, such as application programs, mobile code, data, or other information for implementing system 100 elements, which might be stored or loaded therein during use.

System 200 element implementations can include hardware, software, firmware or a suitable combination. When implemented in software (e.g. as an application program, object, downloadable, servlet, and so on, in whole or part), a system 200 element can be communicated transitionally or more persistently from local or remote storage to memory for execution, or another suitable mechanism can be utilized, and elements can be implemented in compiled, simulated, interpretive or other suitable forms. Input, intermediate or resulting data or functional elements can further reside more transitionally or more persistently in a storage media or memory, (e.g. storage device 208 or memory 209) in accordance with a particular application.

Portions of system 100 (FIG. 1) can also be implemented as one or more low-level processes linkable to or forming part of a system 200 or other suitable operating system (“OS”) or OS-like process. Such an implementation, as with conventional PC controllers, might thus benefit from reducible delays and system-wide availability, among other benefits. These or other benefits will be more readily apparent with regard to I/O controls 114 and 132 (which can form portions of a conventional BIOS or more advanced I/O controls, such as those given above), as well as with recognition engine 112, synthesis engine 131 and control portions of I/O devices 105, which tend to perform largely repetitive tasks that can also require more substantial system resources. (Any OS or programming languages capable of operating in accordance with the teachings herein can be utilized.

Certain speech command structures, verbiage and other aspects enabled by input/output processors and other element embodiments disclosed herein can also be provided in a manner that enables a high degree of broad or even global applicability; these can also be suitably implemented at a lower hardware/software layer. Note, however, that aspects of such elements can also be more closely linked to a particular application type or machine, or might benefit from the use of mobile code, among other considerations; a more distributed or loosely coupled correspondence of such elements with OS processes might thus be more desirable in such cases.

Conversant Aspects Embodiments

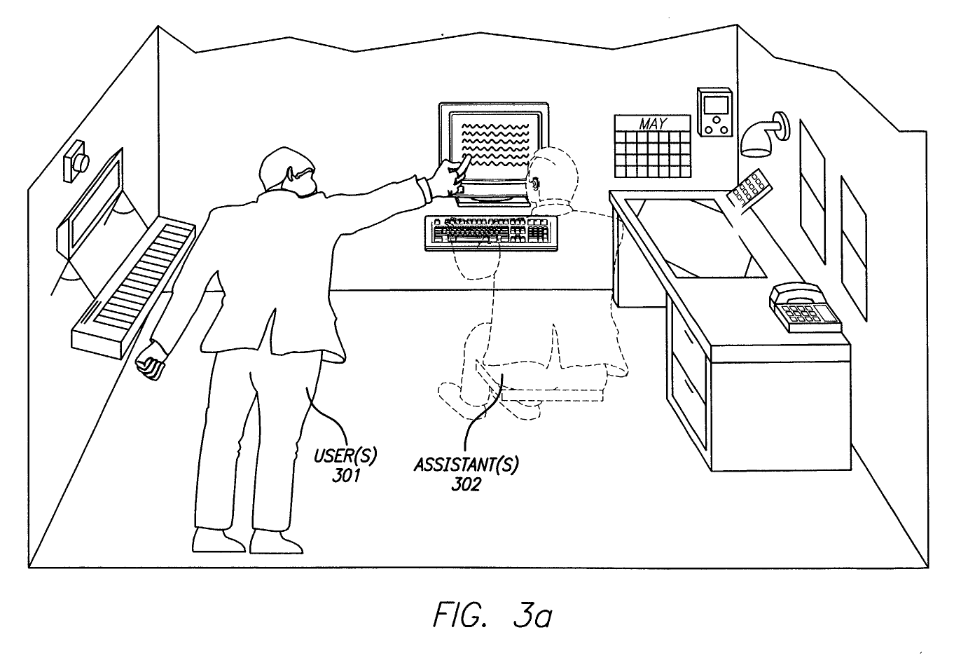

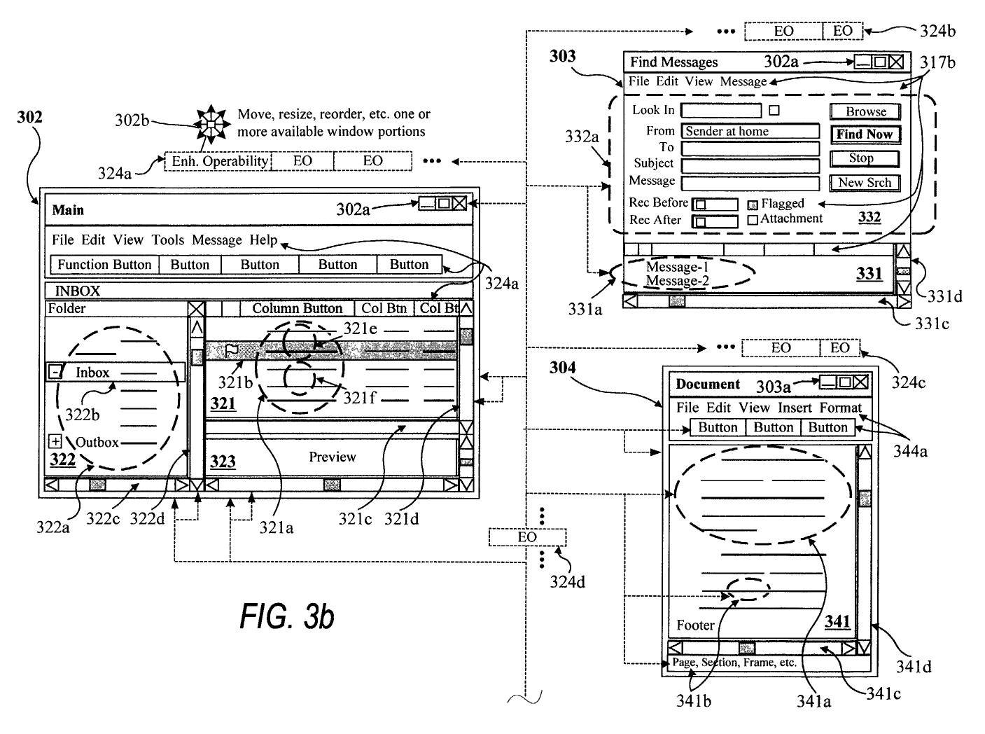

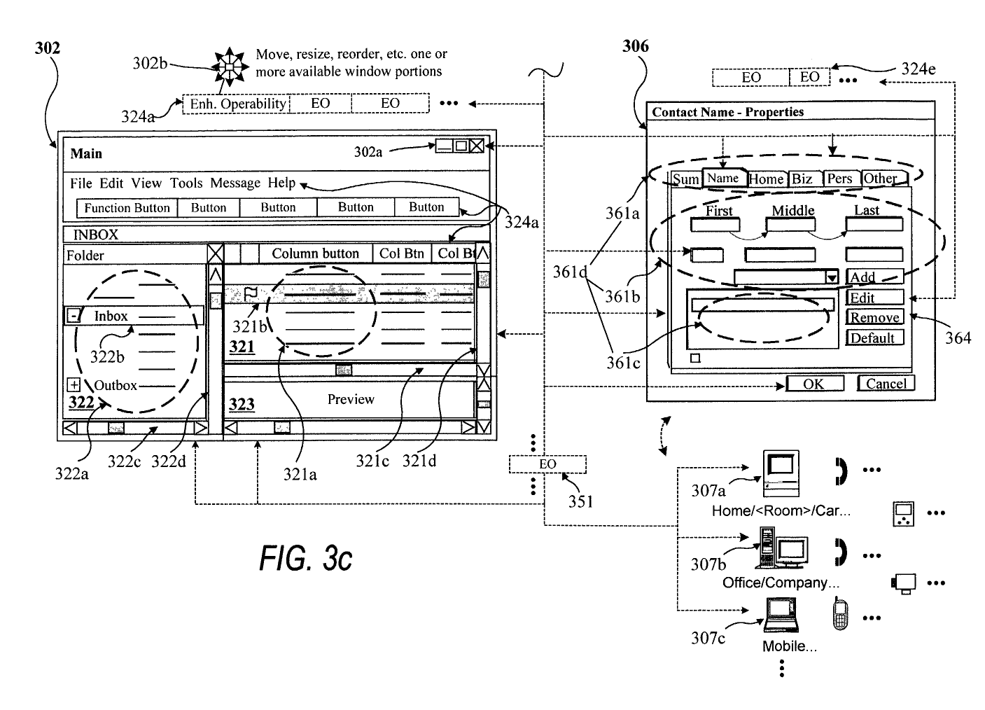

Continuing with FIGS. 3a through 3c with reference to FIG. 1, command creator 111, executor 117, and other interface system 100 elements are capable of forming, executing or otherwise handling commands that are generally conversant or “conversation-like”. That is, the commands can facilitate fluid ongoing command and inter-command recitation for accomplishing variably integrated user objectives relating to differing devices or processes. Variably recitable subjects, objects, actions, users, machines, or other targets of objectives or “designations” can, for example, be facilitated within one or more intuitively recitable commands at varying levels of specificity. “Continuing” of command portions is also enabled for maintaining an already established designation or establishing a new one, continuing objectives toward a goal or cueing prior determined objectives, and so on. Guided or otherwise facilitated ongoing, intermittent, transitional or new user(s) objectives can also be provided within one or more commands, among other combinable examples.

A resulting conversant command set or group does not, however, require a free-form spoken-conversation approach, but can also provide other verbal or non-verbal gesturing/events or approaches (e.g. question-answer, “lecturer-audience,” “manager-assistant,” supported, conversation, others or combinations thereof). Such approaches can further be implemented as automatically (e.g. programmatically) adaptable, user-selectable or some combination, in accordance with user, devices, contexts, events, gestures, portions thereof, and so on.

Conversant-interfacing has proven particularly effective where user-commands are created and utilized in accordance with one or more of conversant context, task and goal aspects, an assistant-based “scenario” aspect and a further conversational factors aspect. (Designations, specificities or other below mentioned aspects capable of facilitating a conversant interface will also be separately discussed.) Such conversant aspects or portions thereof can be overlayed over a conventional interface and handling elements, such as with the OEVI, used in conjunction or replaceably with especially more-conversant interface/handling elements, or some combination. While others might be utilized, the foregoing aspects will be presumed to be included for the remainder of the discussion (unless otherwise indicated) so that a better understanding of interfacing and other aspects of the invention might be more clearly conveyed.

The following discussion, with reference to FIGS. 3a through 3c, broadly summarizes and then presents examples of each of the aforementioned OEVI-like conversant aspects both alone and in combination.

In summary, a “scenario” can be broadly viewed as a paradigm or perspective that can be imposed, presented or explained to a user (in conjunction with a correspondingly operable system) to facilitate conversant command use, handling (or “processing”) or guiding of user expectation. “Conversant context” includes use-directed circumstances within which a user objective is to be accomplished by initiating commands or for establishing or modifying the impact thereof on user progress through successive user objectives. “Tasks” and “goals” include objectives that a user might want to effectuate or results that a user might want to produce. Tasks or goals can also be viewed as abstracted or conversantly “distilled” machine uses or purposes. “Conversant factors” include refinements applicable to commands, machines, approaches, environments, and so on for increasing interface intuitiveness or conversant user experience; e.g. manipulating one or more command or underlying interface elements to render commands more intuitive, guiding, or otherwise more conversantly “recitable” via speech, other gesturing, events and so on, or some combination. (A task can also include achieving a goal in a particular instance; therefore, the term “tasks” as used herein includes goals, unless otherwise indicated. Conversance-enabled commands can facilitate control, feedback, data input, manipulation and so on, or combinations thereof; therefore, the term “command” will hereinafter include one or more thereof, unless otherwise indicated.)

1. Scenario Examples

Consider, for example, the OEVI-like assistant scenario embodiment of FIG. 3a in which a user can move about while instructing an “assistant” or using various controllers himself; as desirable, the user can also virtually place one hand on his assistant's shoulder and point (virtually or actually) by or while reciting a corresponding objective. The assistant can comply with simpler recited user objectives; the assistant can also switch, distribute among or link machines or commands, imply specificities/designations, perform current/later command enhancement, and so on, thus enabling minimal user recitation to produce even complex, multiple local/remote machine effectuated objectives. An assistant can also guide an inattentive or physically, emotionally or technologically challenged user, for example, by receiving and resolving partial recitations, providing suggestive feedback, advancing user progress, preparing for further objectives, and so on.

(OEVI assistants “apparently” assist a user by executing a scenario, receiving conversant commands—the ongoing recitation of which is increasingly self-reinforcing—and providing machine control results that correspond to explicitly/impliedly recited “specificities” and predetermined user expectation based enhancements. Further accuracy and more convincingly conversant interfacing can also be provided via user preferences, user/system use observation and responsiveness modification (or “runtime prediction”), more conversant underlying machine or machines enhancement, or other more extensive or runtime objective facilitation refinement; see, for example, utilization of history information above.)

An OEVI-like assistant facilitates “modifiably specifiable” designation of one or more command portion targets that can include actions and targets of actions. A user can “tell his assistant(s) what to do,” providing just enough specificity for the assistant to act at all (e.g. in “default,” preferred or ways implied from an ongoing use or objectives), or can provide alternative, greater or lesser specificity. An assistant can also operate responsively to similarly posed user references, reference modifiers, details or other specificities regarding the user, others, applications, machines, actions, and so on.

An OEVI-like or more advanced assistant can further (typically similarly) respond to physical, verbal, biometric, I/O device or other machine identification, or other inflexion or attribute-based referencing, including but not limited to user/use identification or security, questions/unsure commands, separately recited “continued” commands, prior established references or cued prior expressed objectives. An assistant can also resolve partial or otherwise unresolvable commands by “asking for specificities,” providing for “further instruction,” and so on (e.g. by pausing, presenting options, linking separate or separately recited input, dividing combined input, responding to determinable cues, or other suitable methods), among other combinable examples.

While a more tangible (e.g. displayed or otherwise more perceivably or pervasively presented) assistant might also be used, a less tangible, hereinafter “intangible” (e.g. not displayed) one appears more suitable for particularly a broadly applicable conversant interface. Apparently, an intangible assistant is subliminally re-identifiable by a user with respect to its use, person or even existence, as might best facilitate user objectives or communication. (For example, a user can more consciously provide explicit specificities or more ignoringly recite a basic objective or fewer specificities and thus rely on more implicit ones.) An intangible assistant is also usable in a consistent manner despite differing processing, compatibility, available media presentation real estate, throughput or other machine, user or other variations.

An assistant might also be discretely implemented, or further using various more interactive processing, with or without artificial intelligence. However, improvement over prior interfacing was achieved in the OEVI even with only informing users of the assistant scenario and providing command-based predetermined responses consistently therewith; a discrete assistant implementation was not “required,” as might be presumed. (Other unitary or combinable scenarios might also be used in accordance with a particular implementation.)

2. Conversant Context examples

Turning to the FIG. 3b through 3c examples, consider further such conversant or “conversational” contexts as OEVI-like presentation type, situational or location correspondence. OEVI “presentation-based” context embodiments, for example, enable a user to recite similar commands despite differing applications, machines, and so on each time the user focuses on conversantly similar or otherwise similarly used/operated presentation element types.

Conversant interfacing enables extensive use of individual or combined variably specifiable references or “designations” for referring to one or more presented or not presented users, others, actions, things, and so on. Presentation-based, location, situational or other contexts can be used to provide more objective bases according to which designation techniques can be used to create, execute or otherwise handle more intuitive and guided conversant command recitation or visa versa. (For example, specificities can be added/modified based on a defined context, already-created specificities can be used to add/modify contexts, or both as in the OEVI.)

An OEVI-like “grouping” presentation context, for example, includes presented or not presented elements or element types that can be perceived as part of a whole (e.g. via user guiding or selection), such that objectives relating to one or more “grouped” elements can be similarly recited/handled in conversantly similar circumstances. A “grouping” can, for example, include lists or other similarly perceivable user manipulated elements (e.g. new emails 321 a, email folders 322a, found email types 331a, related fields/ options 332a, 361b, document elements 341 a-b), combinations (e.g. 361d of FIG. 3c), and so on.

A grouping can also include separately presented control/data elements that are predicted or observed (e.g. at runtime) to be mentally organizable, similarly referable or otherwise usable by a user as a group or portions of that group (e.g. 321c-e, 321b and 321f, 302-4 and 306, patent claim portions with or without graphic, textural or other references/modifications thereto, clauses, notes, annotation types/sources or combinations; multimedia portions, control types, machines or machine types 306, 307a-c where or through which information might be located or which might be operated, and so on). See also Designations below. (While referencing a group as a whole is useful, the ability to similarly perceive/reference one or more group elements of the same or even differing groupings is found to facilitate generic applicability, flexibility and intuitiveness.)

An OEVI-like “extended grouping” context further includes one or more groupable items associateable by a user (and an OEVI-like conversance-enabled interface) with the group designations and a corresponding toolset. Examples include: email folders, emails and tools; file folders, files and tools; available windows, a target window and window controls for that window; home theater or multimedia production/presentation device sets, operational modes and controls; form segments, fields and tools; instruments/orchestrations, instrumentations/effects or other attributes, and controls; home, office, car or user referenceable smart devices, like specifics and controls; other machines, presentations/modes and controls, and so on. (For example, FIG. 3b extended groupings include: folders 322a, emails 321a, controls 324a-b and related windowing of 302b and 321-2; window portions 302-304, 321-323 and 331-332, an included designated portion, such as message 321b or messages 321e, and windowing tools summarily depicted as 302b; 361a-b or 307a-c, 361b or 307 portions and 364 or 307 controls, among others.)

Note that a conversant overlap of presentation structures and groupable elements within such structures is facilitated. In the windowing-based OEVI, for example, a folder/email and windows/window context overlapping enables windowing to be similarly referenced as window-related (e.g. “Maximize <type/name>window”) or as email-related (e.g. Display, open or “Closefolders window”), as might be applicable to a current user objective. (A conversant overlap, via presentation or non-presentation and exploitation/modification of user perception, is also enabled for real or virtual, local or remote machine portions, e.g. 301-306 and 307a-c, such that the user need not reference or otherwise utilize such portions differently.) Such presentation-based contexts are useful, for example, where a user is more likely to attempt to effectuate multiple objectives in the same or a similar manner (despite any underlying interface differences/distinctions), or where a user can be guided to do so (e.g. by scenario, facilitated recitation, underlying interface modifications, and so on). For example, contexts can be defined according to more generalized or specific predictions as to underlying interface element use or use in conjunction with other elements; a scenario can further be established, context-consistent recitation structures can be consistently populated, unique specificities can be accommodated, distilled references can be created and enhancements can be added as needed (e.g. machine enhancement operabilities or operability initiators (“EOs”) 324a through 324c and 324e, or machine-group or globally applicable EOs 324d).

“Intermittent” or “transitional” contexts can also be similarly created by determining where a user might recite more or less related objectives (typically utilizing not-current machines/data), determining whether the objectives are intermittent, transitional or both, and providing explicit/implicit specificities accordingly. Enhancements can further be created/executed to facilitate responsive operation (e.g. for “intermittently” effectuating, from within messages 321, folder 322b or word processor 304 operation and returning to messages 321, “transitioning” to message finder 303 or facilitating form page/element use 361, and so on.), thereby avoiding move, find criteria entry, other operations or underlying interface peculiarities. See below examples. (This and other conversant context utilization can also be similarly received, identified and resolved during execution for greater execution efficiency, accuracy, and so on; see below examples.)

“Sub-contexts” can also be similarly determined and accommodated by adding or modifying existing commands. For example, commands can be created/executed in accordance with a discovered user tendency of using a greater number of explicit details in reciting commands “after pausing” than in “rattling off” ongoing context commands. Commands can also be handled in accordance with discovered user attempts to use prior context command portions at least immediately (if not longer) following a transition to a new machine, particularly one having a closely related or subordinate actual or perceived purpose. Suitable commands corresponding thereto can thus be formed or otherwise handled according to applicable conversant aspects, such as with conversant contexts. (Supportable sub-contexts can also include more closely related contexts or “contexts within context types,” such that objectives corresponding to sub-contexts can be even more similarly recited than for similar context types, among other examples.)

In many cases (during creation), context/sub-context accommodating commands might already exist due to prior application of context or other conversant aspects, and sub-context might provide more of a creation (or other handling) check to assure coverage of expectable commands according to context or other conversant aspects as well. In other cases, application of sub-context enables contextual or other conversance holes to be identified and filled as needed. In the OEVI, command permutations are provided for accommodating ongoing, transitional and sub-contexts (e.g. see the FIG. [symbol] partial command chart); as noted above, these can also be detected and accommodated at runtime via suitable analysis (e.g. of history information) and initiating of corresponding operations.

Tying command recitation or handling to more generally applicable conversant context (or sub-contexts) is found to facilitate, for a user, flexible semantic continuity and intuitive recitation, and implementationally more accurate and efficient command handling. For example, users tend to intuitively utilize increasingly consistent recitations, enabling fewer commands to be provided and awkward recitation avoided. Users also tend to recite commands more confidently where conventional conflicts between control and data handling and other recognition inaccuracies can be avoided; common user mis-recitations can also be better identified and thus trapped or otherwise handled, and unnecessarily user recited machine operation steps can be identified and corresponding enhancements implemented, among other useful results. (Conversance enables handling that can not only determine, accommodate and assist, but can also modify or otherwise “guide” user perspective or expectation.)

In the case of groupings, for example, presentation contexts enable a user to similarly explicitly recite objectives that can include nearly any presented (or many not presented) conjunct or even disjunct grouping elements (e.g. via linking, special or specially distilled designation, enhancement, and so on), which contexts can be extended to similar recitation of non-grouped elements, unique specificities of control/data elements, and so on that can also be designated. A user can also implicitly/explicitly recite a “current” element, which a conversant interface can: resolve as a reference in conjunction with other command elements, a current context or user objective; implement; and further enhance as might be useful (e.g. restoring or advancing a curser/pointer position, manipulating data/controls, providing more conversant feedback, and so on).

Contexts (as with other conversant aspects) also provide metrics or rules according to which command portions can be created, executed or otherwise handled. For example, commands can be coordinatingly created within identified/distilled similar (sub) contexts or between different (sub) contexts, particularly those that are predetermined or observed at runtime to be used in conjunction with one another. Execution and other handling of a received command can also be facilitated, for example, by: resolving any explicit/implicit specificities; resolving user objectives (e.g. according to the resolved specificities); causing consistent or supportive interface responses thereto; or anticipating, facilitating or guiding further user objectives (e.g. via an assistant, conversant factors, context similarities/differences, command elements, and so on) in accordance with a current context, sub-context or context/sub-context transition.

While it might at first appear that presentation-contexts unduly tie conversant interfacing to existing interfacing (e.g. underlying GUIs), findings indicate otherwise. Conversant groupings, for example, apply with regard to just about any application, machine, person, action or thing either actually, or more often, by a user mentally “organizing” a presentation in a manner that can be anticipated, provided for, guided/reinforced, interpreted or otherwise handled. As noted, use-based contexts can diverge substantially from particularly machine-dictated elements or other constraints of existing underlying interfaces and have often been found to do just that.

A user is also found to largely subliminally use even differing coexisting contexts as needed, e.g. utilizing data search fields differently than also presented (resulting) data lists, despite the confusion or inexactitude that might at first be expected to exist given prior (e.g. PC program) description or use; e.g. as with presentation contexts 33 la and 332a of FIG. 3b. Underlying interfaces also provide familiar elements/operations, the modification of which can further be used to guide a user with regard to other, even unrelated or otherwise unavailable machine utilization; e.g. other programs, using a PC, a cellular phone or stereo similarly, or further in conjunction with one another, and so on. (Note that creation is affected since automatic, modifiable automatic or explicit user-directed “switching” between coexisting contexts may well need to be identified and accommodated by adding/modifying commands or enhancements to facilitate switching among coexisting as well as other contexts. In many cases, identifying a default entry point to the coexisting context combination and enabling “exiting” commands that are shared by the combination is sufficient; in other cases, location or other context based commands/permutations might also be used to provide case-specific entry/exit.) Other context bases or combinations are also supportable. For example, OEVI-like “transitional” (situational type) contexts/sub-contexts provide a common basis for command/data handling with operabilities that are graphically supported only via often unseen menu elements; input/operation history or other aspects can also be utilized in a more capable implementation. A detectable situation can again be handled in a similar manner by invoking a corresponding situation-handling command, or further, an enhancement tailored for the particular situation.

OEVI-like location-supporting sub-contexts further provide for operabilities that are applicable to user, subject, object, tool or machine localizations, such as home, office or other distinctions, or ongoing data entry within a series of presented data fields (e.g. fields 361a-b of FIG. 3e) by receiving an explicit/implicit start-location indicating specificity and initiating field-switching enhancements corresponding to further current command portions or successive commands. A location or location-type can also be analyzed during creation or other handling to determine whether commands or data-entry might predominate or be used exclusively to enable interpretation to be conducted according to likely or exclusive input type, and so on. Operability disfunctions of a particular machine can also be similarly avoided, for example, by determining whether a current location is an end of a paragraph, the beginning or end of a field in smaller-stretched windows, and so on, and applying corresponding enhancements in such cases.

(Note that the term “distilling” is used herein to refer to analyzing varying elements and determining therefrom genericized conversant-aspect based elements or element references. Contrastingly, “abstraction” refers to attaching a representation that can be-and often is-recognizable only by a particular machine or programmer. The designation “messages” is, for example, provided in the OEVI as a distillation of emails, faxes, voice mail, and so on according to context and conversant factor analysis to provide an alternative “user default” target designation where greater specificity is not needed, and to avoid not-anticipated such defaults. That is, determined user tendency or assistant or other conversant aspect based guiding can be used to increase the likelihood that a distillation will occur to a user rather than some other recitation, whether or not the distillation or other recitation is presented.)

3. Task/Goal examples

It is also found that user recitation can be more conversantly viewed/anticipated as expressing one or more of separate or ongoing user objectives that might or might not correspond with controls, functional divisions, data, and so on generally provided by a particular machine. OEVI tasks, for example, typically include performing one or more actions or permutations thereof with respect to one or more users, others or things, as expressed from the perspective of a command-reciting user reciting tasks or goals. Unlike traditional GUI, for example, an action typically precedes and is recited with objects of the action (in the same command; it can, however, precede or follow an object or objects can be separately designated, but in accordance with conversant aspects. For example, the OEVI renders disjunct elements selectable and capable of manipulation in a more conversant manner as continued (or “linked”) commands; see Designations and Specificities below.

Tasks can further be viewed as including one or more of an “ongoing sequence” (largely uninterrupted) of similar ongoing tasks, intermittent tasks (that temporarily interrupt, supplement or link a flow of similar/dissimilar tasks, such as corresponding to transitional contexts), or new tasks. Tasks can further be described in relative terms as expressing, for example, simpler (“simple”) tasks/ objectives or more “complex” ones (e.g. as relating to relatively few/many specificities, operations, explicit-implicit specificity associations/conversions, and so on).

Consistent with the OEVI and emailing, for example, “simple ongoing tasks” might include flagging one or more displayed or not displayed emails/folders, deleting them, assigning them user priority organizations, other characteristics, otherwise moving through an email list, or other objectives. “Related ongoing tasks” might include having an assistant read back emails, headers, locations or other supporting/descriptive information (via graphics, speech, etc.). “Related intermittent tasks” might include: finding emails to/from someone, on a particular subject, sent/received within a time period, having some priority range or some combination; responding by fax or phone; scheduling; alerting a secretary or others; taking notes; distributing information, etc. “Lesser-related intermittent” or “new-application” tasks might include reviewing/modifying a flowchart, program code, a presentation, or other information—perhaps relating to an email or copyable information therein. “More complex tasks” might include alerting others as to scheduling, manipulating a presentation with or without “opening” it, sending one or more specifiable phone, mail or email responses -perhaps according to a sender, source, and so on.

(The OEVI implementation, being subject to existing tools, is particularly limited with regard to guiding/facilitating lesser-related tasks; however, it makes extensive use of implicitly known/anticipated information. The OEVI provides for such interfacing as responding to a command by determining and utilizing relevant current task information in a successive command. For example, reciting “Find more messages” causes the interface to determine that sender information is needed, find the information, initiate the OE find option, enter the information and initiate a search. “Call sender” or recipient, “Call <X> at home”, and so on further cause the OEVI to lookup a corresponding target (e.g. phone number of the sender/recipient) using a corresponding machine (e.g. one or more local or remote personal, group or public address books) and implement a resulting resolved objective (e.g. place a call or display correspondence information.)

However, more subtle inferences based on runtime determinable user intent/objectives that might even conflict with predetermined courses of action are not supported in the particular OEVI embodiment; for example, use of particular address books or responses in particular circumstances might be more efficiently/effectively determined and implemented at runtime. (See, for example, “history” above.) A partial list of OEVI commands is given in FIG. [symbol] .)

While expected that tasks vary considerably with different applications, machines, and so on, the nature of tasks and the manner in which a user might communicate them are instead typically found to be more similarly related or relatable (particularly where a user/handling are suitably guided by other conversant aspects). Tasks can, for example, be related according to more generic “purposes” (e.g. program uses from a reciting user's perspective). They can further be related without losing the character of a current application or potential user goals, for example, by determining distilled expressions of such tasks or task elements that are more generally applicable and forming/handling commands accordingly. Given such characteristics and via application of appropriate structure, commands or other conversant interface aspects, user-task availability (within one or more commands) is not restricted to conventional functional divisions and limitations, and is instead enabled to move (conversantly) intuitively and efficiently with a user's “train of thought”.

For example, conversant commands enable a PC user to perform operations “outside” a displayed pop-up window, window segment, program or PC, switch machines, use them in conjunction with one another, work with different users, user groups, moderated groups, and so on. PCs and different, even unrelated machine portions can also utilize a similar “language” or similar/convertible implementation (that can further be extensible as might be applicable).

A different handling decision nevertheless exists as to whether enabling the user to use differing expression itself creates ambiguity of command use or otherwise conflicts with conversant aspects; e.g. where one window portion includes and another window portion used in conjunction therewith does not include scrolling, and the difference, rather than facilitating recitation, might create confusion.) Again, the particular OEVI implementation utilized required such analysis and determination to be conducted entirely as part of command creation.

4. Conversational Factors Examples

Also consider utilization of OEVI-like conversational factors. Conversational factors enable intra or inter command structure/content to be created in a manner that facilitates user progress. Such factors include, for example, smooth verbal, physical or other command portion recitation/enunciation, and “rhythmic flow” (i.e. establishing or propagating an expectable ongoing, transitional or new perceived meter, pacing or other command/command element flow). A useful user recitation analogy might, in retrospect, be a music sight reader using immediate or ongoing musical rhythm, meter or phrasing in a predictable manner as a guide as to “what to play” next; as a result, continued sight reading becomes an increasingly simpler and more automatic “user default”.

(Rhythmic flow is described as “perceived” in accordance with the findings that rhythm/flow need not be absolute. OEVI verbiage was, for example, determined such that a user will tend to mentally combine an applicable descriptor with its associated target according to the same or compatible perceived meters (e.g. “Find messages”, “Find flagged messages”, “Find messages with attachments”, and so on). Changes such as differences in the number of explicit specificities, sufficiently distinct enunciation or difficulty of enunciation -which often arise due to non-conversant underlying interfaces (e.g. “Flag next”, “Mark next unread”) can, however, cause a user to pause and think or mis-recite a command, thereby causing a break in flow.

Such problems can nevertheless be avoided, for example, (during creation) by identifying such potential rhythmic breaks and modifying, replacing or adding to such elements (e.g. “Flag next”, “Read next”, “Didn't read next 3”-pronounced as “red” and “reed” respectively, and so on), which are more similarly perceived. Similar “consistent” changes for greater numbers of specificities for all or some commands likely used in conjunction with one another (e.g. within a common context or other set, group, and so on) can also prove useful, such as are discussed next. (Non-speech or further non-verbal expression can also be similarly determined and provided for in accordance with conversant aspects.)

Conversational factors also include imposing “balance” (which attempts to assure that tasks supportive and complimentary to one task are also available and operable), and imposing “consistency”, which attempts to assure that a task supported in one instance is similarly supported and (at least apparently) similarly operable in other expectable instances, among other examples. (Thus, conversational factors can be used in creating recitable commands or to causing actual/apparent underlying machine operation, often via recitation additions, or enhancements.)

As with other conversant aspects, conversational factors are found to be co-supportive, such that balance and consistency are achievable, for example, using the aforementioned context, tasks/goals, linking, enhancements, feedback or command/data input; a combining of factors has further been observed as tending to provide further improvement.) In the OEVI, for example, the above-noted “Find more <optional specificity> messages <optional specificities>” command is also available in co-supportive forms of “continued commands” within the OE Find window, enabling consistent and rhythmically flowing continuation of finding particular messages (e.g. “Find more flagged messages”. Abbreviated co-supported forms are also provided as supportive of potential changing flow (and also in support of a changing context in which “more” might no longer apply, and in providing only needed information to an assistant). Within the Find window, for example, it is also sufficient to recite “Flagged messages”; “All folders” or messages; “Messages in <X>folder”, “To sender”, “Regarding <X>”, and so on. (Multiple or more inclusive explicit or implied specificities or conjunctives, such as a leading “And . . . ,” can also be used in such cases to provide combined or more refined/complex referencing variations, in accordance with adding to versus modifying currently established conditions/objectives.)

It should be noted that, while a user perspective can be guided, there are often limitations, and particularly so with regard to primarily predetermined predictions, such as with the OEVI. Conversational factors, like the above conversant aspects, thus also provide weight-assignable or otherwise applicable conversant metrics or rules that are useful in command creation, execution and other handling. Such metrics, rules or user interaction can also be used to determine where particularly predetermined variability, which is otherwise useful, might actually cause a user to over-think rather than responding “automatically” as otherwise guided.

For example, a (user perspective-based) conversant analysis might reveal that a word or phrase that is functionally desirable in one instance might be conversantly undesirable or less desirable (or require an alternative) because it is not readily articulable, contradicts rhythmic flow or causes user confusion in other instances. An analysis might also reveal that initially functionally desirable feedback is conversantly less desirable over time because it becomes distracting, but that the same or a more subtle variant is nevertheless ultimately conversantly desirable because removing it later is even more distracting, e.g. suggesting to a user that a malfunction has occurred. (For similar reasons, mousing type commands are also provided or existing commands can be retained in certain instances in order to meet non-conversant interfacing expectations as well (e.g. “Check flagged” [button]; “Select flagged”, “Click find”, and the like). These can also be supplemented with other, more conversant or conversant-like commands, such as “Find that” or “Flag these” (“these” or “those” typically differing from “that” or “this” in the OEVI by explicitly indicating a grouping of more than one element).

Further difficulties also remain in providing a conversant command creator and other systems of at least accommodating if not utilizing aspects of conventionally non-conversant machines, speech programs, approaches, programming tools, input devices, and so on that might be utilized or operated, and to which a user might well have become accustomed. Newer machines consistent with the teachings herein enable many such problems to be avoided.

5. Examples of Conversant Aspect Based Commands

Certainly the above or other conversant aspects are combinable in various ways to produce differing commands or command sets. However, the following resulting OEVI recitable command or “language portion” examples (in conjunction with other teachings herein) should provide a basis for implementing other conversance-enabled embodiments as well.

Turning again to FIG. 3b, assume that a user has recited a command to launch OE (e.g. “Run email”, “Receive email”, and so on); unlike “Send an email . . . ”, which also brings up a new-email form, further fills, facilitates addressing or even sends a new-email, the OE window is in this case displayed and set to point to some extended grouping element (e.g. email 321b in Inbox 322b). (Note that an OEVI “Receive email” command also checks an email server and downloads any new messages. It was also decided for the OEVI that, given limited control information, re-instantiation of new program instances should be avoided as often not available and otherwise causing an inconsistent interface response; thus, an already running target program is rendered “current” as needed, while a not running one is first instantiated.)

The OEVI assistant scenario imposes largely explicative commands that “tell the assistant to perform a task” implying not otherwise stated specificities. Thus, for example, a user can tell his assistant to handle listed messages (e.g. “Read these next 3”; “Flag last 3”, “Delete last 3“). Rhythmic flow is also implemented in accordance user tendency to mentally combine certain recitation permutations (e.g. “these next”) or multiple beats (e.g. “Delete), which are also applicable to movements, biometrics or other recitations, and so on. Added enhancements further adjust pointing, commands, data, and so on, or provide feedback, so that a user can confidently expect particular results and can quickly rattle off ongoing use-objectives (see below).

Window portion or other controls are also treated as a corresponding group context such that a user can similarly tell his assistant, for example, to “Scroll up”, “Scroll left 3”, etc. within a scrollable underlying interface portion (e.g. window segment, virtual/augmented reality scene, frame/frame options, etc., as might be applicable).

The OEVI further similarly implements recitable specificities as to other grouping, extended grouping or other contexts. Thus, a user can also tell his assistant, for example, to “Scrollfolders . . . ”, causing the interface to execute a corresponding ongoing or intermittent context (by switching to folders if needed, scrolling the folder list and returning to one or more elements if needed—in this example—to the same email 321b); consistent “Scroll messages” or “Scroll emails” (using or not using distillation) are also provided in accordance with conversant factors. A user can also similarly effectuate operabilities with regard to other presented elements (e.g. within a current window, virtual/augmented reality scene, frame, and so on (e.g. “Scroll left 3”) or a sufficiently specified current or not current machine portion (e.g. “Scroll <program/ window name or type>. . . ”).

Grouping and extended grouping contexts facilitate not only reciting objectives relating to a “current” or “new target,” but also using targets in conjunction with one another (e.g. moving/copying items between or among containers, such as folders or graphic groups; affecting items within even not-current containers; affecting container portions intermittently, transitionally or automatically.) A user can, for example, “Delete next n folders”, open one or more folders, modify the names of folders, and so on intermittently, or create new folders as a new goal (using invoked OE features). A more advanced implementation would, however, also enable creation to be effectuated semi-intermittently, for example, by returning to a starting or other pre-command condition once the creation has been completed in, accordance with more information or other runtime determinations.

(Note that NS and other recognition engines require explicit word matching, with options being specified within a command list. In such cases, particularly user-modifiable designations (e.g. email folder, contact, current message, file folder merge attributes, names, titles, and so on) will need to be entered and integrated with commands during creation, execution, conversion or other handling (e.g. by polling machine information, downloading or other suitable techniques). For example, NS can be provided with the entirety of “Move next 3 to Business folder” by updating a “folder type” command-list within a programmed command that includes “Move . . . ” with Business and other folder designations. Depending on the particular implementation, such modification (or attaching, such as in the below Command examples) can be conducted using local or remote information during creation, at the startup of runtime, responsively to an otherwise recognized command, and so on, or some combination.

While more difficult to satisfy conversant factors, more extensive specificities can also be similarly created, recited or otherwise handled. Note, however, that not all objectives can or should be so neatly provided in light of other conversant aspects that might be used. For example, “Goto page 3” sufficiently tells an assistant (as, for example, shown in FIG. 3b) what to do, since only word processor 116 has pages, but might not be sufficient in other multiple-machine circumstances. Continuity and other conversant factors would therefore suggest an addition/replacement, such as: “Go” or “Goto” (and the like) up/down, backward/forward, page, section, footnotes etc. “in <program or window name”; “<program or window name>go . . . ”; and so on. (As noted, conversant aspects attempt—other factors being equal—to exclude recitations that create a user expectancy in one instance that will be confusingly responded to in one or more other instances.)

As an example of “transitional/new” contexts, the OEVI provides “Find more . . . messages . . .” command permutations. Such commands typically switch to and remain with another machine. For example, “Find more messages” looks up a sender address of a current message (e.g. message 321b) as implicitly the “sender”, switches to window 303, inputs the address in “From” and initiates a find 317b. Flagged, confidential or other explicit specificities (which, as with parsing for “confidential” indicators, need not correspond with underlying tools) similarly cause the assistant to further check a window 303 box, fill in the subject or another field, and so on as is suitable, in order to permit further providing user feedback. (It will be appreciated that controls can also be provided without underlying interface manipulation, with other manipulation or some combination, as might be conversantly more useful.) Within window 303, OEVI assistant implied specificity and conversant factors again enable abbreviated commands such as “Flagged messages”, “Flagged messages with attachments”, “Confidential flagged messages” or other alternatives or combinations. However, initial user pre-disposition (see conversant factors above) also resulted in the inclusion of “Find <specificity>” and “Find more <specificity>” type commands, even though “find” can be implied and found messages literally replace earlier ones, such that “more” is literally incorrect.

OEVI intermittent versus transitional contexts were typically determined as follows. Both typically occur at machine operation (e.g. window portion-to-window portion) transitions; these can be identified via command-creating user interaction, programmatically invoking features and monitoring resulting machine responses (e.g. for windowing events), prior knowledge, conversant interface communication with a machine configured for providing such information, and so on. If a result completes a determined goal and does not require a presented portion that replaces a current one, then an intermittent context has typically been identified. If, instead, the goal does not complete a goal or such replacement occurs and it is infeasible or undesirable to avoid such replacement, then a transitional context has typically been identified. (Other instances might also be desirably implemented, or some combination.)

Intermittent command enhancements were then added to return to the current presented portion, provide any suitable feedback and user pointer adjustment and so on, while transitional command enhancements instead provided for suitable controls, data retrieval/modification, pointing, and so on, relating to a destination portion; in both cases, enhancements were also typically effectuated responsively to explicit/implicit command specificities. (Again, command execution or other handling can merely “follow” the specificities, as in the OEVI, or predict and facilitate continuing progress using current/prior session history-based prediction, other suitable mechanisms or some combination.)

(It will be appreciated that various methods used in other programming can also otherwise be used to identify transitions, events, start/end points or other conditions or combinations thereof for identifying user progress (e.g. when goal completion will be determined as occurring), machine or other tracking, to conduct machine communication, to initiate corresponding responsive operations, for more effective automatic “assistant response” modification, and so on. It will also become apparent that more advanced use of cues with non-conversant conversant underlying interfaces might well include applying cues to otherwise implemented presentations; thus, one or more prior commands or corresponding cues might be intermittent, transitional or both.)

As an example of form contexts, the OEVI transitional “Add new contact” might be recited, causing the interface to invoke window 306 (FIG. 3c), switch to the “Name” window portion, highlight and select “First”. (“Modify <home/office>address, or “Modify <X's>. . .”, etc. Thereafter, in accordance with a location context, a name or other “form sequence” can be recited with or without recitation of controls. For example, enhancements can automatically advance responsively to the separately spoken “John” “S.” and “Smith,” or in a more advanced implementation, “John S. Smith” can, for example, further be parsed for name versus letter or individual word recitations (e.g. for “John Simon Smith”). A user can also reference fields directly in abbreviated form or with greater specificity by reciting, for example, “First name” “John”, “Middle initial S.” or “Middle name “Sam”, “Last name” “Smith”, among other examples. (In the OEVI, “initial” and “name” respectively provide for entering capital letter plus period, or a name in conjunction with NS, which is literal and ignores such distinctions.) Note, however, that mere recitation of “First”, “Last” and “Middle” were determined to be confusing and contrary to rhythmic flow as compared with other recitations that might also be used (being single words), and were excluded from the particular OEVI implementation.

It should additionally be noted that, despite inherent advantages of multiple-perspective conversance (e.g. using the above conversant aspects), not all such aspects can necessarily be complied with in every instance. The above-noted weight assignable aspects, rules, command-creation user interaction or other suitable criteria modifying parameters might therefore be utilized in accordance with particular embodiments. A degree of end user command creation/modification can also be utilized, such as was already noted. For example, while providing automatic messaging (e.g. “Email <X> that I am busy”, “Reply that I'm busy”, and so on) is a useful improvement, it can extend or even diverge from certain conversational factors, such as rhythmic flow. This is particularly true where more complex messages or delivery time/mode are explicitly recited. Such commands thus tended to be better provided in a user-customizable manner in which a user can modify predetermined general content, explicit/implicit specificities, and so on (e.g. via one or more generalized or time/event triggered options lists where user silence, misstatement or other confusion indicators are detected, more conventional user preference input, macros, add-ins, and so on). (A user might also be alerted to “dangerously” extensive or conversance-debilitating changes or other support might also be provided where command modification is enabled.) Note that adding machines or features in an intuitively useable manner is also facilitated, since existing or enhanced features can be implemented even ad hoc, so long as prior commands or conversant additions/modifications thereto can be determined to conversantly link initiation of corresponding new operabilities or any suitable user feedback might be determined and integrated therewith. (Again, causing a user to “guess” whether an objective is proceeding or has been accomplished, or to otherwise proceed less intuitively can interrupt rhythmic flow. In the OEVI, such interruptions are avoided if conversantly feasible; if not sufficiently feasible, such interruptions are least accommodated via sub-context implementation, providing command permutations, and so on, for example, as was already noted.)

Having established at least a broad basis for better understanding conversance, conversant interfacing and conversant aspect embodiments and variation thereof, we now turn to a more detailed discussion of interfacing system element and command examples.

Command Creator

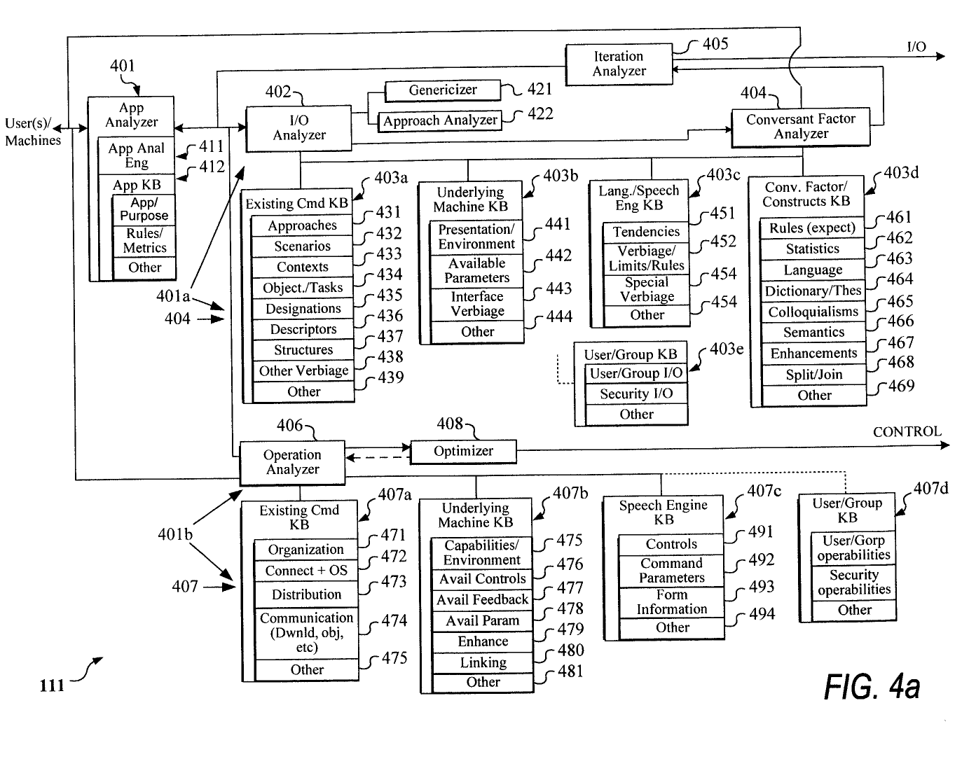

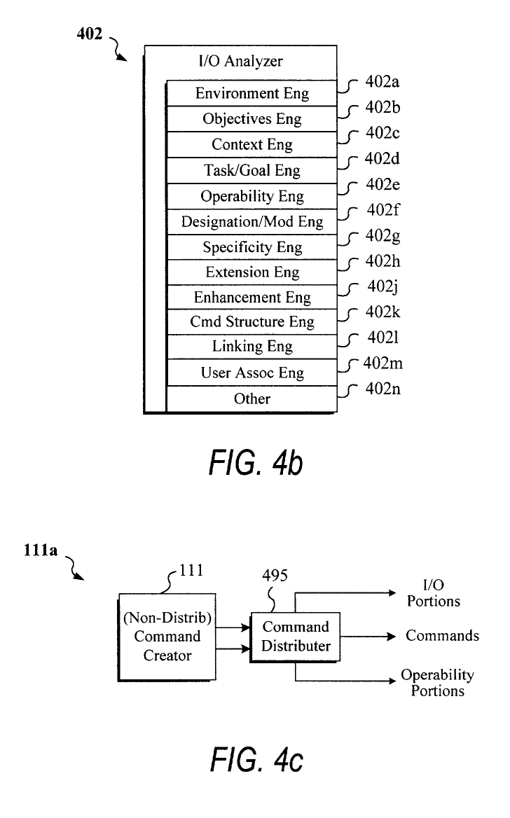

The FIG. 4a flow diagram illustrates a conversant command creator 111 according to an embodiment of the invention. In this example, command creator 111 is implemented as conversance-enabled analyzers operating in conjunction with user/machine directed knowledge bases including the above-noted conversant aspects. Command creator 111 includes application analyzer 401, conversant user-interface analyzer 401a and operability analyzer 401b, each of which is capable of determining command aspects in a separate or combined, and typically iterative manner. Application analyzer 401 further includes application-analysis engine 411 and application knowledge base 412. User-interface analyzer 401 a further includes conversant I/O analyzer 402, I/O knowledge base 403, conversational factor analyzer 404, iteration analyzer 405, genericizer 421 and approach analyzer 422. Operability analyzer 401b further includes operation analyzer 406, operation knowledge base 407 and optimizer 408.

Broadly stated, application analyzer 401 receives and processes user or machine input corresponding to operational characteristics and underlying interfaces of one or more target machines to produce use-oriented machine classifications. Interface analyzer 401 a processes the use-oriented machine classifications in conjunction with further target machine or user information (e.g. preference, language, machine-specific or machine-use specific criteria and the like) to produce conversant recitable command elements or to couple/modify existing recitable command elements for use with the target machine(s). Operability analyzer 401b processes the use information and further machine/user information to provide machine operabilities or to verify machine controls, capabilities or feedback of the target machine for operating the target machine in accordance with receipt of the recitable command elements.

Rules, metrics or other operational parameters or user information can similarly be received and stored within a corresponding knowledge base element -as included in the present example. Rules, metrics, other operational parameters, user or machine information can also be stored in a corresponding analyzer or engine, knowledge bases, other suitable local/remote storage mediums or a suitable combination in accordance with a particular implementation (for use in creation, or further in conjunction with execution or other local/remote handling).

Alternatively or in conjunction with the above operation, command creator 111 analyzers/engines or knowledge bases are also capable of receiving target machine/user information more directly at various stages of processing. If, for example, conversance-enabled interfacing is more broadly adopted, then more conversantly applicable machine, user, group, other information or indicators of such information can also be received from a corresponding machine, storage or information re-communicator to extend an existing conversant command set for operating targeted or other machines. Local/remote language element porting, synchronization, security or other updating can also be similarly conducted in conjunction with command creator 111 or other handling elements, among other examples.

Note that certain commands portions can also be generally applicable (e.g. see above). It is presumed, however, that some machine operation of a particular or “targeted” machine will be capable of providing more specialized operabilities for which more specialized command portions might be created.

1. Application Analyzer example

Application analyzer 401 more specifically provides for receiving and analyzing user or machine input corresponding to one or more target machines and determining therefrom one or more applications and purposes attributable to the target machine(s). An application indicates, from an user's perspective, one or more types of uses that a machine or more than one machine (more typically, a “composite” machine or machine group if more than one) might serve. Purposes indicate user objectives that might be achieved within such applications and from which recitable objectives, such as conversant tasks or specificities, might be derived. For example, a machine (e.g. an email program) might serve one or more than one application (e.g. emailing, calendaring, calling, and so on); a spreadsheet program might serve applications relating to the kinds of uses for which the program is configured (e.g. personal or business accounting, presentation, database, and so on), as might a smart home controller (e.g. particular home system types/portions, shopping, cooking, and so on), among other examples. One application might also be served by more than one machine (e.g. an internet client plus plugins; server capabilities plus servlet(s); entertainment receiver “modes” and respective audio, video, source-service or other components; a production console plus available sources, destinations, a/v gear, effects and the like, or other features of the same/different machines, and so on) Broader purposes might include (in the email example) disposing of existing emails, receiving and disposing of newly received emails, or creating new ones. More specific purposes or “sub-purposes” for creating a new email might include providing addressing, subject, attachment, priority, other email attributes (e.g. priority) or a message body, and so on.

(An advantage enabled by conversant interfacing is in providing common interfacing elements and causing the use of others to be commonly or otherwise intuitively perceived by a user in accomplishing differing user objectives that might be effectuated using substantially any machine(s). Conversant interfacing is, therefore, more usefully provideable if a base of uses is extended to new machine uses, or further, with specifiable/context assignable levels of new machine uses. Thus, despite some subjectivity in specific categorization, application/purpose and other determinations quickly become objective classifications according to an accumulated knowledge base thereof. Suitable rules/metrics can, therefore, be utilized that cause conversant aspects or command elements/structures, such as those provided herein, to be applied.)

Application analysis engine 411 receives machine information of a target machine and determines applicable application/purpose categories of corresponding thereto. Such determination can be conducted via user interaction or more automatically (e.g. according to category selection rules/metrics); however, given currently limited machine classifications, either or both should provide for extensibility at least at present. More conversant target machines (or storage/re-communication devices such as servers) might, for example, provide categorization information directly or might provide machine characteristics from which such categories might be more directly determined or verified, for example, according to a conversance standard. (For example, a raw or weighted comparison can be conducted with existing uses stored in application knowledge base 412 and a sufficiently close existing use or new one can be assigned. Communication of such information can further be conducted via downloading, polling or other suitable mechanisms or methods.

Similar comparisons were conducted with the OEVI. However, machine/user information and determinations were conducted via command-creating user input, target machine testing, otherwise available machine information (documentary, specifications, and so on) or some combination. (A spreadsheet or table-providing programs were used as wholly local knowledge bases and as command constructors/modifiers; determined commands were then converted to a form suitable for entry using NS programming tools. It will be appreciated, however, a conversance-enabled “wizard”, database, programming environment or other suitable creator user/machine interfacing or other command creation tools in accordance with the present invention might also be used (e.g. that provide for the discussed or other user input, command creation, storage or distribution, feedback, and so on).

2. User Interface Analyzer Example

User-interface analyzer 401 a provides for analyzing type and purpose information received from application analyzer 401 and other user/machine information to produce recitable (“front end”) user interface portions of a command or commands.

Broadly stated, I/O analyzer 402 receives application/purpose information from application analyzer 401 and analyzes such information in conjunction with further user/machine information to determines user objectives. I/O analyzer 402 further analyzes and forms, from the user objectives, verified target machine operabilities received from operation analyzer 406 and applicable user/target machine information, permutations of the objectives (e.g. alternative or more or less specific objectives). Finally, I/O analyzer determines potential conversant user interface or “front end” command elements from the objectives and permutations.

Conversant factor analyzer 404 analyzes the potential command elements and modifies the elements as needed to render the elements sufficiently conversantly recitable (generally or for the particular user or users); it further determines the applicability of existing command elements for use with the target machine and provides for modifying/linking such existing elements for use with the target machine(s). Iteration analyzer 405 provides for further iteration or output (e.g. storage) of the resulting command elements.

I/O analyzer 402 is configurable for determining objectives in several ways in accordance with the requirements of a particular implementation. In the OEVI, for example, target objectives were formed as those consistent with the application and purposes determined for a particular machine (see email example above); the target objectives were then compared with those supportable by the target machine operabilities (with or without enhancement), and a composite of supportable objectives were determined. Objectives can also be formed more directly from machine operabilities or underlying interface elements. For example, general underlying environment operations, such as windowing, mode switching and the like, can also be determined/verified via attempted machine actuation and result monitoring, user interaction, downloading/polling or other suitable mechanisms (although the results achieved thus far have been less reliable than with the OEVI). Resulting objectives can further be compared (in raw form or as further distilled by genericizer 421) with known objectives or portions thereof. Other mechanisms can also be used, or suitable rules/metrics can be applied as needed to assist or automate user interaction (e.g. see above).

I/O analyzer 402 also provides for determining contexts and tasks/goals. Tasks, in this sense, can be viewed as objectives for which the operability of one or more machines (with or without enhancement) to perform the objective has been verified and for which command or command element recitations are provided or to be provided, and goals can be viewed as one or more linkable tasks. (Tasks, for example, are represented in the OEVI as composites of often distilled command portions, and within a command group, as task permutations; objectives can but need not be so represented.)

As was also noted, objectives typically include at least one action and at least one object of that action, either or both of which can often be related to even vastly differing applications/ purposes. I/O analyzer 402 is, in this example, configured to compare the objectives (in raw form or as distilled by genericizer 421) to those stored in knowledge base 403 a.

If a correspondence or “executable task” exists (via target machine, other machines, enhancement operations or some combination), I/O analyzer 402 begins command formation; otherwise I/O analyzer 402 communicates such missing correspondences to the user, stores the missing correspondence (e.g. to attempt later commands with further machines or avoid repeated misses), or both. It then initiates formation of recitable commands corresponding to the executable tasks and available command elements stored in existing command knowledge base 403a (e.g. designations, modifiers or other verbiage), target machine information (e.g. labels or other presentation elements received from a machine) or user information where a correspondence between objectives and existing command elements pertaining to the machine cannot be established.

(I/O analyzer 402 may further provide for performing conversant analyses, such as according to one or more scenarios or contexts, or for receiving (from a user/machine) and causing such information to be stored (e.g. initially or upon an indication that further iteration is not required) in a similar manner as with other information. The above noted OEVI assistant scenario is, for example, applied via an existing knowledge base of particularly conversant metrics/rules and resulting command elements; however, other scenarios can also be implemented in a similar manner as with approaches, and resulting more specific information can be stored and “attached” in an otherwise conventional manner to commands or command sets, for example, via approaches 431 of knowledge base 403a. Contexts can also be similarly created and utilized (e.g. by comparing or selecting received/ stored presentation information, such as presentations 441, for providing presentation contexts. Other suitable mechanisms can also be utilized.)

Typically, more than one command element alternative will apply to a given task (e.g. different ways of saying or otherwise expressing the same thing), such as alternative forms (e.g. structures or orderings) or alternative expressions of a displayed title or stored verbiage. I/O analyzer 402 attempts to narrow such alternatives in accordance with more generally applicable corresponding verbiage (e.g. designations 435, descriptors 436, etc.) a current approach (via approach analyzer 422), corresponding existing command structures 437 or peculiarities of a currently utilized I/O execution engine (e.g. via speech engine KB 403c). I/O analyzer 402 may also provide for creating/modifying groups (also indicated by structures 437) which provide both for increased conversance and for creation (e.g. providing a basis for narrowing, conversant factor analysis, and so on), since particularly groups are situationally related and might well be recited in succession. For clarity, however, command groups and other structural/verbiage considerations especially related to speech or other gesturing will be considered in greater detail in the next section.

If no correspondences remain, a broader sampling of earlier correspondence can be attempted (or a further iteration conducted) or a user can be alerted (e.g. enabling modifications of the knowledge base); otherwise current alternatives are provided to conversant factor analyzer 404, which analyzes the alternatives according to conversant factors (e.g. see above). Conversant factor analyzer 404 then transfers one more remaining alternatives to iteration analyzer 405, which determines whether further iteration is needed and if so, transfers instructions to application analyzer 401, currently iterated results to I/O analyzer 402 or both (e.g. to initiate a modified creation/modification attempt or iterated processing of current results).

(A user can also be alerted and interaction facilitated or applicable rules/metrics relaxed where conversant factors cannot be applied. For example, use of the word “to” in referencing email was found to be confusing and not well recognized in view of sending an email “to” someone. An alphabetic referencing was also found problematic with regard to potential enunciation combinations, among other alternatives. A “1^{st}, 2^{nd}, . . . nth” basis may instead be added to the knowledge base and thereafter utilized generally for such referencing, as in the OEVI. While other such “order” based referencing might be used or some combination, they were found, for present purposes, less desirable. See Designations below.)

The above analyses may vary in accordance with a particular application and can, for example, include performing a mapping of stored correspondences (e.g. stored in knowledge base 403), using genericizer 421 to perform abstraction/distillation of the more application specific purposes or resulting objectives to form tasks/goals more generally applicable to more than one application, or utilizing other lookup or “artificial intelligence” methods with or without user interaction (e.g. see above).

Of the remaining user-interface analyzer 401 a elements, genericizer 421 determines, for a received current purpose, objective or command portion, applicable portion permutations corresponding to the purposes for the application type, such as one or more tasks or goals. (Genericizer 421 or one or more further such elements can also be used in conjunction with conversant factor analyzer 404 for abstraction/distillation of recitable verbiage or other gesturing/events.) Analysis can include mapping stored correspondences (e.g. in knowledge base 403), performing abstraction/distillation of the more application specific purposes to form action types more generally applicable to more than one application, or utilizing other lookup or “artificial intelligence” methods with or without user interaction. Approach analyzer 422 modifies command elements in accordance with one or more selected approaches (e.g. data/operation divisions, question-answer prompts, conversation response levels, and so on), which it returns to I/O analyzer 402.

Conversant factor analyzer 404 receives command element portions produced thus far and provides experiential processing refinement. Such refinement can include application of interface construction rules 461, statistics 462, formal language alternatives 463 (refinable via dictionary/thesaurus 464 or colloquialisms/ethnicities 465), semantic 466 (which, as will be appreciated, can apply to language, presentation or other recitable or not recitable command aspects, such as enhancements), enhancements or other automatic/programmatic operations 467, command splitting or joining 468 of command recitations (e.g. in accordance with goals, cues, language, user, machine or other considerations), user/machine relations and so on, or other aspects 469. The OEVI conversant factor analyzer 404, for example, applies conversant factors, such as those already noted.

Knowledge base 403 provides the following. Existing command KB 403a provides for selecting from or modifying command portions in accordance with aspects of existing command or command set/group portions or visa versa. Machine KB 403b provides for selecting/ modifying in accordance with interface characteristics of a utilized underlying interface. Language KB 403c provides for selecting/modifying in accordance with structure, verbiage, control or dictation elements imposed by a speech program or speech engine that might be utilized in conjunction with a current conversant interface (e.g. NS-type commands) or these or other particular known peculiarities of a speech or other gesture recognition or synthesis engine. (Other event/gesturing recognition peculiarities can also be similarly accommodated.) Constructs KB 403d provides for selecting/modifying in accordance with aspects of conversant interface construction, such as those already mentioned. A further user knowledge base 403e (or an operational knowledge base 407d) can also be added where integration of use/group specific information with commands is desirable or where such knowledge bases are also utilized during other handling (e.g. user/group based preferences, characteristics, security and the like); other knowledge bases might also be added.

Iteration analyzer 405 receives front-end command and other interfacing elements produced thus far and determines whether the interfacing elements sufficiently meet the utilized criteria or require further processing by one or more of interface analyzer 401 a elements. The particular criteria can include predetermined conversant interfacing metrics for measuring conversant aspect sufficiency, as well as indicators with regard to other interfacing considerations, such as available resources (e.g. speed, storage, or other resources), further approach, environment or machine constraints, and so on. Iteration analysis can also be conducted by programmatic or user determinable testing conducted by one or more local or remote users, e.g. via network 104 of FIG. 1. (OEVI iterations, for example, were tested by users.)

Note that I/O, operational or other “known” aspects need not be wholly contained within knowledge base elements, and external or remote information can also be used. For example, a user's existing interfacing information (e.g. grammar, vocabulary, speech files, preferences, data, and so on) or existing machine or speech engine information can be provided via mobile code, such as applets, loading or push/pull retrieval, among other polling/downloading alternatives (e.g. see, for example, above). Other iterative or non-iterative processing ordering or other alternatives might also be applicable to a particular implementation

FIG. 3b illustrates an I/O analyzer implementation in greater detail. As shown, I/O analyzer 402 includes environment engine 402a for determining presentation elements of one or more machines, and conversant element engines (e.g. objectives engine 402b for determining user objectives, context and task engines 402c through 402d for determining conversant contexts and tasks respectively) for determining conversant criteria according to which commands are to be formed. I/O analyzer 402a also includes operability engine 402e for determining applicable operabilities in conjunction with machine-capability analyzer 301b.

I/O analyzer further includes command construction elements for forming commands in accordance with the conversant criteria; the command construction elements of the present example include designation engine 402f, specificity engine 402g, extension engine 402h and enhancement engine 402j, and a command structure engine 402k for forming command structures. (Command elements and structures are described in greater detail below.) I/O analyzer further includes linking engine 402l for forming linked commands (e.g. for effectuating cueing, multiple task goals or other extended or distributed machine commands, and can include a user association engine 402m for establishing sources of user/machine information, or applying user/group preferences, security, I/O devices that might be utilized or other user-related command attributes. (Other user-interface related engines 402n can also be used.)

3. Operability Creation/Modification Example

Moving to the lower portion of FIG. 4a, machine-capability analyzer 401b provides for analyzing underlying machine characteristics, including controls, capabilities or feedback, determining whether one or more potential user-commands are implementable and, if so, determines code for implementing such user-commands. Analyzer 401b can also determine whether more than one control might be used (differing results thus far being determinable via user interaction) in accordance with user input, machine communication or knowledge base 307 rules, metrics or data (e.g. as with application or I/O analyzer).

(Note that while code generation has thus far been conducted by a programmer using the above-noted facilitators, any of the numerous existing or emerging/future manners of more or less “automatic” programming or programming assistance can be used, many of which are well known in the computer programming arts.)

Machine-capability analyzer 401b can also be used as a centralized machine interface to respond to requests for providing machine capability or interface information or to provide an indicator as to the a potential command is implementable (e.g. as shown). It can further be used to determine one or more machine controls of one or more machines or enhancements for effectuating commands.

As with front-end processing, machine-capability analysis is implementable in conjunction with user input, machine communication (e.g. machine manufacturer installed or downloadable information), knowledge base metrics, and so on. However, a more automatic mapping of known machine/enhancement capability combinations to user-commands can be conducted if sufficient capability information is provided or ascertainable from the machines themselves, and this can reduce requisite user-interaction, system complexity or processing. A currently available machine capability or enhancement can, for example, be pooled within knowledge base 407 and used as needed; a current non-availability of a capability or machine can further be deleted or otherwise indicated as inactive or “suspended”, and this can reduce storage requirements or a need to re-ascertain such information respectively. (Such OEVI back-end information was entered by a user-programmer.)

Operation KB 407 includes existing command KB 407a, underlying machine KB 407b and speech engine KB 407c. Existing command KB 407a and underlying machine KB 407b include elements for enabling communication and operability command execution with known or new machines. Existing command KB 407 includes more generally applicable and communication information, such as pervasive commands 471, e.g. OS commands, general functions (see examples below), common commands (such as PC save, load and edit commands), and so on. Also included are command/machine distribution information 472 (e.g. associated command/data structures, memory/storage locations, and so on), communication and command delivery protocols 473, and other information 474. Underlying machine KB 407b includes machine capabilities 475, available controls 476, available parameters 477, memory map information 478 (e.g. data/attribute or control layout of programs/devices), enhancement information 479 (e.g. desirable enhancements and implementation), and linking information 480 (e.g. for below discussed overlaying or other multi-machine capabilities). Other machine interfacing information 481 can also be utilized.

Speech engine KB 407c includes information pertaining to communicating with a particular speech recognition or synthesis engine, such as available control mechanisms 491 (e.g. information handling, synthesis speed/pitch, and so on), command parameters 492 (e.g. for other available controls or control variations), and other information 494. (Note that attributes of other event/gesture processing engine peculiarities can also be utilized, or one or more front or back end knowledge bases can also be utilized and other information can be utilized in accordance with a particular application.)

Optimizer 408 provides for analyzing machine operation alternatives, and for determining which alternative(s) is/are more efficient (e.g. where two or more available machines or command combinations might apply) and for optimizing an operation result. Command optimization can, for example, include performing one or more compilation phases using a suitable compiler. Corresponding front end and back end results can further be stored together (and this can facilitate command management) or separately (enabling re-use of front-end or back-end information as needed), in accordance with the requirements of a particular application. Note, however, that an interface-operation correspondence indicator (or intrinsic storage mechanism indication, such as a particular format) might be required where such command portions are stored separately.

It will be appreciated that one or more of command creator 111 elements can also comprise or correspond with a singular or multiple engines (e.g. analyzers) associated with one or more knowledge base elements. For example, I/O analyzer 402 might include one or more of a context, task, structure, designation, continuity or other engines/analyzers associated with the existing command KB 403a, or such engines/analyzers might also be separately implemented. Operation analyzer 403b might also include any one or more engines/analyzers corresponding to existing command knowledge base 407a elements, or such engines/analyzers might also be separately implemented. Communication might also be separately conducted or various configurations utilizing other command creator 111 elements might also be used in accordance with a particular embodiment.

One or more commands created in accordance with the above or another suitable system facilitate flexible singular, multiple or interactive utilization among one or more users, applications, environments, machines, and so on. Commands can be stored within one or more interfacing system 100 (FIG. 1) elements for use by such elements (e.g. as with machine 127) either alone or in conjunction with interfacing system 101. Commands can also be initiated for execution (directly, via local/remote transfer or temporary/persistent storage) by an operating system or other machine, or some combination, among other implementation alternatives.

Operability can further be provided as more globally applicable or with respect to more particular program(s), device(s), application(s), approach(s), environment(s) or types or portions thereof (e.g. implicit/explicit video conferencing audio, video or graphic tracking; adding, modifying or indicating multimedia presentation elements; creating, modifying or transferring email, fax or other documentation\communication; operating a home entertainment system, etc.) Such operability can also be applied to control, data entry, feedback or some combination, as might be suitably executed by one or more machines. The use of conversance also enables commands to apply similarly for operabilities that, in a conventional sense, would otherwise be considered data input or other data handling. For example, continued commands enable the selection of multiple disjunctly positioned data items (e.g. “Select first 3” “And select last 3 <item type>”).

FIG. 4c further indicates how, in addition to storing resultant command portions in one or more knowledge bases or some other storage medium (e.g. see FIG. 1), commands can also be distributed to other machines. Command distributor 495 provides not only for distributing complete commands to independently operable or otherwise remote systems, but also for distributing command portions. Thus, for example, recited commands might be interpreted locally and executed by a remote machine, interpreted remotely and executed locally (e.g. where a current machine lacks sufficient processing capability for interpretation) or interpreted and executed remotely. (As noted earlier, distribution might also be conducted in conjunction with a suitable command converter; this can avoid duplication of machine information where a separate knowledge base or other storage medium might be utilized for storing machine information.)

Command and Command Set/Group Embodiments Overview

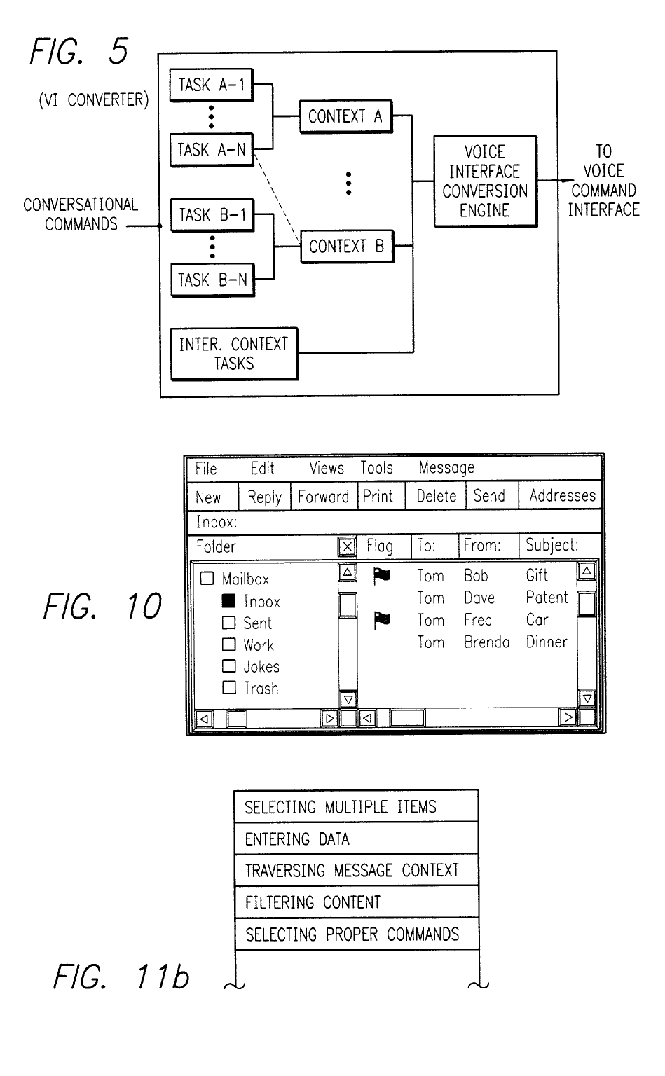

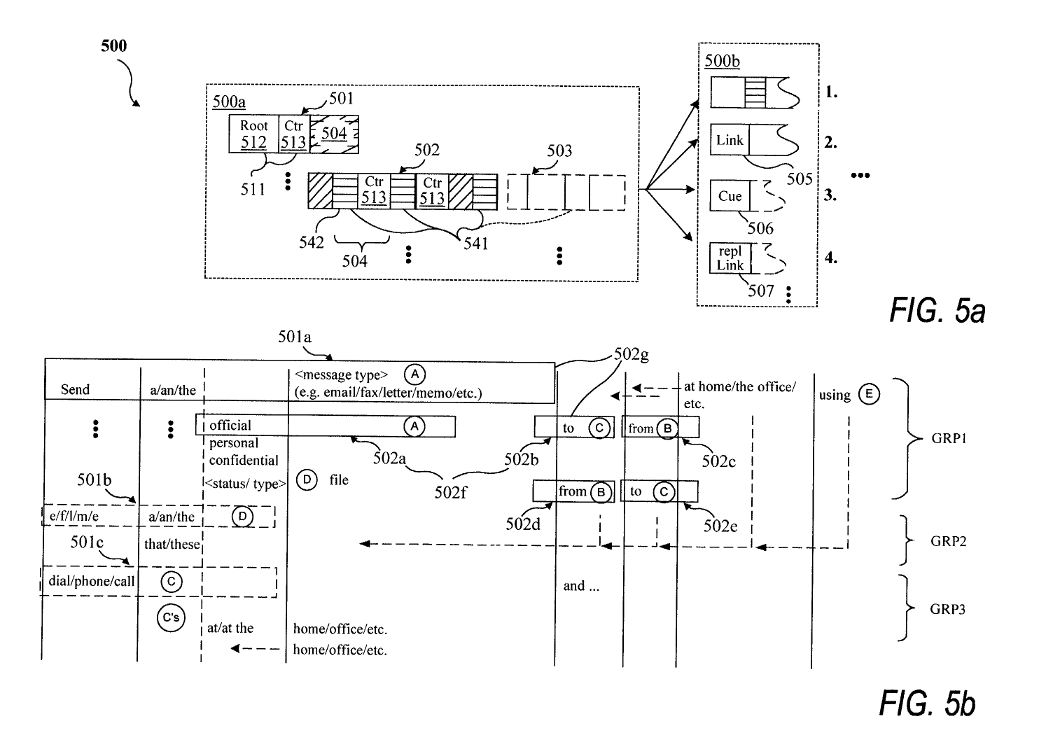

Turning to FIGS. 5a and 5b, conversant command elements and commands producible by a command creator such as creator 111 are most often significant both individually as well as in their relation to other elements, commands and (typically) sets of commands. Such relation can be established not only by applying the aforementioned conversant aspects or distillation, but also by suitably structuring and executing or otherwise handling commands or command portions (e.g. see also Executer embodiments below).

An OEVI-like language can, for example, be created or otherwise handled that includes commands formed as relating to at least one command group. An OEVI command group typically relates to a common overall purpose or task, purpose/task permutations or levels of permutations that can and often do transcend conventional limitations. A recitable command group can be created, executed or otherwise handled that enables a user to similarly recite objectives that the user might use in conjunction with one another, for similar purposes, in another context or sub-context, or according to other relationships that might be established. For example, handling email can—from a use/purpose perspective—be related to other correspondence handling, further to audio/video conferencing or other communication; creating email can be related to creating other correspondence, multimedia presentations or other “documents” (which can further include imputing, modifying or otherwise manipulating included data), and so on.

Commands can, for example, be similarly structured by user-interface analyzer 401 a of FIG. 4a (as a command “group”) in accordance with purposes/uses provided by application analyzer 401 or tasks/purpose permutations provided by I/O analyzer 402. User-interface analyzer 401a can further similarly populate such structure (or more than one typically alternative command group structure) such that purpose/task permutations are providable as explicitly or implicitly recitable command portions.

Additional coherence of a command group can still further be provided by conversant factor analyzer 404 application of conversant factors or through the use of suitable enhancements, such that the permutations are more easily recited, with conversant operabilities being facilitated such as was already discussed. Other command groups can also be similarly created or modification conducted, or the creation of new commands or portions thereof can be created in accordance with commands of even different command groups (e.g. by the above-noted comparing), such that a broader conversant coherence might result.

(In the OEVI, for example, command structures and portions are created in the manner given above, typically in conjunction with formation of command groups. Singularly applicable command portions or “unitary commands” are most often exceptions included for accommodating user predisposition to well-entrenched conventional commands/constructs, presented non-conversant elements of an underlying interface, command element substitutions or conversant conjunctives for transitioning between commands/command sets.)

Command groups can also be utilized during execution, conversion or other handling. In the OEVI, for example, predetermined commands not only provide intuitive, easily enunciated command permutations in reciting successive commands, but also using different OE windows or other programs for similar purposes (e.g. manipulating new or found emails and addressing them, manipulating file folders generally or word processing document portions, and the like). More advanced runtime processing can during execution or conversion can also facilitate a consistent user experience (with or without explicitly flagging correspondences during creation or thereafter) via the above noted monitoring or other suitable mechanisms. (Conversion can, for example, modify commands in accordance with language, dialect, cultural or other relationships more suitably affect command structure/verbiage, grouping or other applicable conversant relationships.)

1. Command Structure Examples

Beginning with FIG. 5a, a command group according to an embodiment of the invention typically comprises a recitable base command 501, zero or more recitable command extensions (or “extensions”) 502, one or more not-recited command enhancements 503, and one or more recitable specificities 504), which can be recited before, after or (more typically) within base commands 501 or extensions 502. Each specificity 504 can further include one or more designations 541 and zero or more modifiers 542. (Note that “replaceable” includes replacing a particular portion with one or more alternative or additional other portions, or excluding the particular portion altogether.)

A base command 501 typically comprises a root command 511 (including a root 512 and a connector or “ctr” 513) and a designation 541, but can more generally include a root 511, zero or more connectors 512 and one or more specificities 504. An extension 502, which is appendable to a root command, typically includes at least one designation 541 and at least one modifier 542, but can more generally include one or more specificities and zero or more connectors 512.

While not explicitly recited, execution of any enhancements and impliedly-recited portions (“implied portions”) can be and is typically effected by one or more of explicitly recited portions. Execution of implied portions can also be affected by a current context, coupled portions of prior commands, user/group identification, security or identifiable user “tendencies”, and so on. Tendencies can, for example, include ongoing tasks/goals, determined user trends or “current preferences”, cueable recitations or other current or prior session history-based information. (History, interface, operational, user, machine or other information from prior system 100 use in conjunction with a different command creator, executor or other element(s) can, for example, be received by a currently used element in one or more of the manners already discussed.)

Execution of enhancements can also be affected by impliedly recited portions. Thus, for example, various command portions or combinations thereof that are explicitly recited by a user can be executed or otherwise handled in different ways according to more generally or specifically applicable factors (e.g. explicitly recited portions, context, preferences, history, user/group, and so on); such factors are also definable/interpretable independently from an underlying interface (e.g. according to a current use/objectives of a user).

A successive command 500b can be formed, executed or otherwise handled for recitation in different manners that can utilize command portions within or otherwise related to one or more prior commands (e.g. command 500a). Creator 111 (FIG. 4a) or other command-handler types are, for example, configurable to respectively add or respond to optionally recitable “coupling indicators” of such command relationships that typically precede, but can also be integrated with or replace portions of a successive command. (See, for example, the above linking engine 4021 of FIG. 4b.)

A successive command can, for example, include the same or different ones of the afore-mentioned portions, as with example 1; while typically conversantly related to a prior command 501 a, such a successive command can be otherwise independently interpretable/executable or otherwise handled. Such a successive command can also be perceptually linked (though not explicitly interpretively linked) to other commands, which linking can be supported or otherwise guided by conversant aspects, such as in the above examples. (For example, successive claim dependencies can be added a patent claim chart, much like the above email modifications, successively using the command “Next [patent claim] depends on <N>” or “Next is <a or an>[independent] <method or apparatus>claim”. Note that the bracketed portions might be optionally recitable as more specific designations, such as after pausing or for causing operation to shift to claim charting from some other objective type, goal or presentation, such as was discussed with reference to FIG. 3c.)

A successive command can also include a “linking” indicator 505, which typically augments a later base command portion, for “continuing” one or more prior command portions, as in example 2 (e.g. “And . . . ”). A successive command can also include a “cue” indicator 506, which provides for initiating or extending an already-recited command task/goal, as in example 3 (e.g. “Cue rhythm section”), or a replacing linking indicator, as in example 4, which can replace an otherwise included command portion.

(It will be appreciated that suitable runtime processing, such as the examples already discussed, can also be used to monitor command portion recitation or command flags of recited commands such that a later command that continues toward a goal, cue or other couplable objective is executed in accordance with such command portions or flags.)

The above command portions or “elements” can also be implied as defaults or in accordance with a user preference unless modified by a corresponding user (e.g. by explicit recitation of the command element/preferences), another authorized user or an execution system (e.g. via predetermined criteria, or user “habit” or other runtime analysis). Command portions (during creation, interpretation or other handling) can also be associated with one or more users (e.g. as a further specificity) or one or more “other” specificities, or dictation/control can be utilized together or separately (e.g. “Bracket these last 3 words”).

Thus, for example, a single user execution system implementation can determine/utilize particular local or remote user information, or “track” and respond to different user objectives or elements (e.g. actions, targets or other specificities) thereof. A multi-user execution system implementation can further determine/utilize local or remote user/group information, “track” and respond to elements of one or more local/remote user recitations, or facilitate local or remote individual, workgroup or moderated workgroup interaction (e.g. by member, status or member-groupings).

For example, a dialogue can be dictated/controlled with automatic verification, reference lookup/presentation, annotation, and so on (e.g. producing the text

E.g. 1: “John: <John's dictation>

Jane: <Jane's dictation>)”

or a video conferencing session can be facilitated by automated camera movement, muting or other modification of control or other local/remote recitation, etc. in accordance with a reciting/target user or other specificity. User machines, non-recitation (hereinafter “silence”), not-recited elements or other aspects can also be similarly utilized.

2. Base Command

Turning to FIG. 5b, a OEVI base command (e.g. “Send an email”, “Fax a <correspondence>” or “Phone <name>”) typically corresponds with the simplest form of a task or objective (e.g. “Send an email”), which often includes an action as a root (e.g. “Send”), a connecting portion (e.g. a, an, the, that, these, and so on) and an object of that action as a designation (e.g. “email”). When corresponding to the simplest form of a task, the root command typically excludes modifiers (which typically provide a modifying attribute of a corresponding designation and can affect execution of a corresponding enhancement). A base command can, however, also include implied other command portions (e.g. specificities, extensions, and so on). For example, a particular base command might correspond with an often used command permutation, a command permutation in accordance with a user preference, security or other attributes, and so on. In such cases, a base command might provide a simpler way of reciting a more complex command, or serve other purposes in accordance with a particular application.

Base commands are also typically substantially complete (or can be readily completed as needed), in that information typically needed for execution is either explicitly given or implicitly ascertainable by a suitable executor. For example, an OEVI-like executor can receive base command 501a and determine therefrom a return address/addressee, action, subject/object and typically associated machine as corresponding to the implicitly specified user, the explicitly stated “send” action and “correspondence type”, and a default PC or other current email, fax, word processor or other machine respectively.

In terms of further handling (e.g. execution/conversion), root commands enable unreliable and inefficient conventional word-for-word input parsing, to be avoided. Instead, root command applicability can be used as a lookup reference, for example, to determine whether a root might apply at all or (e.g. via weighting) whether a command is more or less likely as compared with other commands, data entry or some combination. Such further utilization of root commands can also be extended hierarchically or otherwise to a base command or other command elements.

3. Extensions

Extensions (e.g. extension 502) are typically coupled to a root command and can provide additional explicit task (e.g. permutations of a base command), and enable improved underlying machine operability or facilitate continuity, simplification, expectancy or other interface utilization (e.g. via greater specificity). A user, for example, typically adds an extension to a base command during recitation for defining alternative tasks corresponding to the same, or further, other base-commands (e.g. “to [person] C”, to C “at work”, “to C1 and C2 at the Z office”, “using WordPerfect” or “using [MS] Word”, “email D to B”, and so on). Extensions or alternative base commands can also be used to provide “reversible” commands, the user perception of which is of freely mixing command recitation of command verbiage (e.g. “send D to B using OE” versus “OE send D to B”, “make the 4^{th} [displayed] column Z” versus “make Z the 4^{th} column”, “email the X files to A using [my] <machine-name>“versus “<machine-name> . . . send the X files to A”, and so on). (Note that such a system of commands is adaptable to the above-noted placeholder, mapped or other suitable applications of distinguishable command elements to corresponding commands.)

Extensions can also be used to extend a base command recitation and can provide a more explicit statement of the base command. For example, the base command “Find more messages”, while meeting conversant factors on its own, is found to be rhythmically inconsistent with “Find more messages to sender”; the re-stating extension of [send more messages] “from sender”, which is implicit to or “presumed by” the base command, is therefore also provided. (In such a case, rhythmic flow also provides a command creation metric determining the impact of command length.)

Extensions can, however be distinguished from other command element types. For example, extensions are typically more directly related to particular contexts or tasks and can affect multiple task modifications, e.g. by explicitly setting multiple targets; various modifications are also relateable to one another in providing an overall modification. A designation (see below) is typically more generally applicable and reusable for even very different context/task types, can be implementationally distinct from others and thus far has been treated as corresponding to single target or target type. While such distinctions might be applicable to interface intuitiveness, they can also become important implementationally. For example, the above command element-to-command linking might be conducted at all or differently for extensions or extension types versus designations or designation types. Hierarchical command recognition or other “narrowing” of alternative “interpretations” of what has been input might well be conducted differently in accordance with extensions, designations or other suitable command elements or conversant aspects determinable in accordance therewith, among other considerations.

Extensions also tend to be perceptually different from other command portions. Due to limitations of current speech recognition, it is sometimes necessary to distinguish commands from dictation by omitting words from commands (e.g. pronouns). It is found, however, that interface intuitiveness can actually be improved by limiting (most often) such “incomplete recitation to base commands and limiting the number of base commands. (A user is found to actually use a conversant interface more intuitively where a more limited number of incomplete base commands is combinable with a greater number of “completely recitable” extensions. During execution, incompletely stated base-commands also provide a more implementationally and recitably consistent basis for distinguishing commands and data with or without extension. (A user can also apparently be guided in this manner toward reciting resulting “shorter” and more easily recited base-commands in succession.)

4. Enhancements

Enhancements 503 can provide peripheral capabilities that can further be related to other command portions. For example, an enhancement of “Send an email to C” might identify B as a current user, activate B's PC, PIM, etc. (e.g. if remotely initiated), run an email-handling program or applet (if various programs might be run), initiate a new email message, address the message, and prepare (e.g. via curser repositioning) for an email message subject. Thus, a next user command can simply enter the subject (with corresponding enhancements of advancing the curser to the email message body, providing for additional addressing, etc) or redirect operation to a less-often utilized successive capability.

User enhancement or other preferences can be ascertained automatically by programmatic tracking of ongoing runtime user input, via user entry or using other suitable mechanisms. (Where an enhancement is more complex, user entry of enhancement results should at least also be provided, in addition to any more specific enhancement operation parameters—e.g. moving backward within a list or typically selecting a “next” versus “current” relative designation; see Executor below).

5. Designations

Designations 203 provide for tool, subject or object identification to which a command/ data can be directed. They can be used to implicitly or explicitly identify one or more users, applications, machines, tools, subjects or objects -even manners of proceeding (via base, extension, enhancement, subsequent command elements, and so on) among other aspects.

The OEVI, for example, provides globally or machine-based explicit (e.g. a name), relative, anti-alias and other indirect, implicit or otherwise “inferred” designations, as well as systems of non-numeric grouped item identification, reference to machines/data by individual/group name or type (e.g. “word processor”), and other features (see below). For example, the OEVI is capable of not only enabling the recitation of, but also distinguishing among singular and plural verbiage forms, e.g. “that” versus “these”. (Singular-plural designation or other type differentiation is also used in the OEVI for distinguishing among command possibilities where machine operation parameters are not available, such as when executing a macro in response to a spoken command. It will be appreciated that they can also be used as part of a system for supporting even more simplified reference to “already designated” items”.)

In terms of a user, designations enable identifications to be used in a consistent manner despite varying contexts, applications, machines, etc.; specific designations (see below) can further be created -even supplemented (e.g. see above) in a manner that meets conversational factors (such as rhythmic flow) both alone and in conjunction with specificities that might also be used. A user further need not memorize/utilize differing commands in differing scenarios.

In terms of further handling, designations can also typically be ignored as a first step in recognition, thereby further narrowing the task of identifying potential input (thus providing for improved efficiency and accuracy). A command set or specific command is also rendered more accurately identifiable, for example, via weighting of a recognized designation (e.g. against an otherwise identified incompatible root, such as with the above singular-plural distinction.

It will also become apparent that the particular constructions and element selections (e.g. wording) created, in addition to later discussed user facilitation, also provide for facilitating a limited number of distinct commands, efficient resource utilization, complimentarily input commands and dictation, command-dictation differentiation and command interpretation. (Note that such elements are also discussed in greater detail with regard to executor operation, command execution and command wording, which might differ in accordance with a particular implementation).

6. Conversance

Commands 500 also demonstrate an example of the application of conversant interfacing. The OEVI presentation context for command-set 500 is generally transitional, e.g. expectable in conjunction with moving from a review of existing/new email messages, working within other programs, etc. to creating/addressing a new correspondence. More than one correspondence can, however, also be created in succession or further manipulated in a sequentially or otherwise.

The “transitional” nature, in this case, also relates to limitations of the Windows and OE GUIs in reliably presenting only current windows of currently operating programs. A conversant interface does not require conventional listing of all operational alternatives, and can more usefully utilize presentation resources (e.g. graphical real estate) to suggest “available commands” or provide more conversant guidance (e.g., indications of at least “related” applications or machines; see above.) It is further expected that presentation support will become less necessary, particularly if conversant interfacing becomes widely utilized.

Base command 501 is also compatible with conversational factors. It is, for example, found to be intuitive, easily enunciated, providing of rhythmic flow and consistently implementable (e.g. using enhancements, such as given above) alone, with the included extensions, and typically with other commands that might expectedly be used in conjunction therewith (or further commands provided to maintain conversance). Adding a detail/selection descriptor or “specificity” to subject “A”, for example, is found to be mentally combined with “A” to maintain the simple triplet—and more importantly—a cohesive rhythmic “feel” or “meter” of base command 501, permutations or in conjunction with other expectable command portions.

(In hindsight, a useful rhythmic flow analogy is that of creating music that another person will play; even varying rhythm provides the player with a determinable perceived road map as to what lies ahead. OEVI commands are, for example, determined such that command elements rhythmically flow to others or data that will likely be used in conjunction therewith; commands are also determined such that permutations will typically flow similarly or such that a user will tend to mentally adapt or even combine linkable details or alternatives. Consider, for example, the substantial perceived rhythmic consistency and flow of “send an email”, “send a fax”, “send a confidential email” and “send a letter” . . . “to my mom” . . . “cc my brother Lon”, or even “address that [or the last email] to my mom”.)

Information Executer embodiments

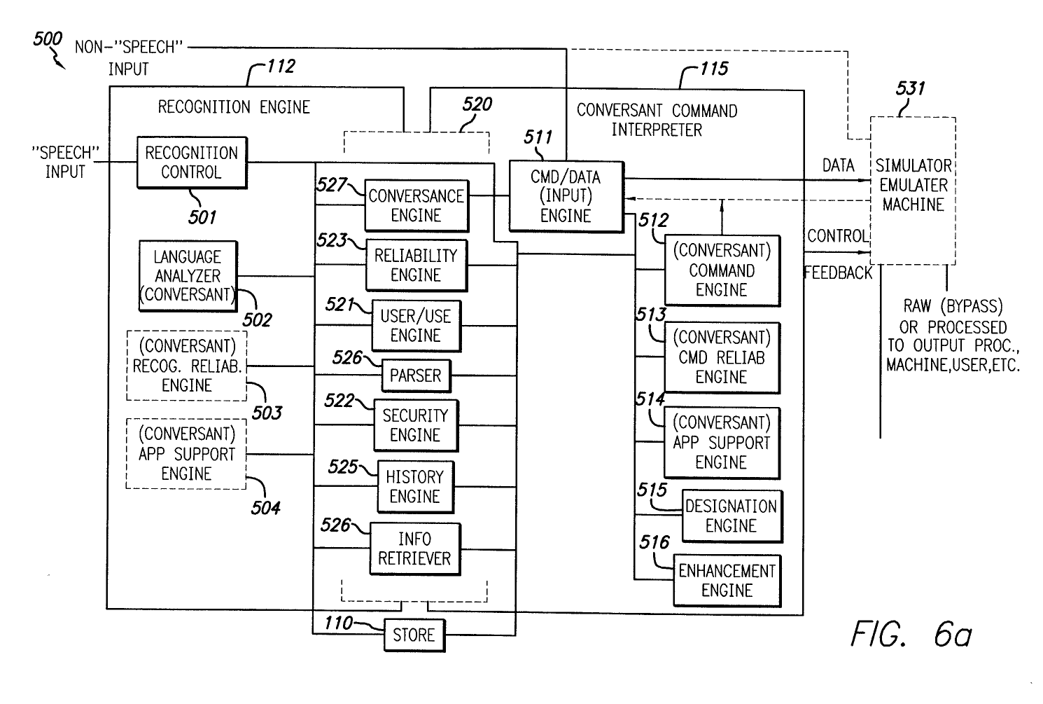

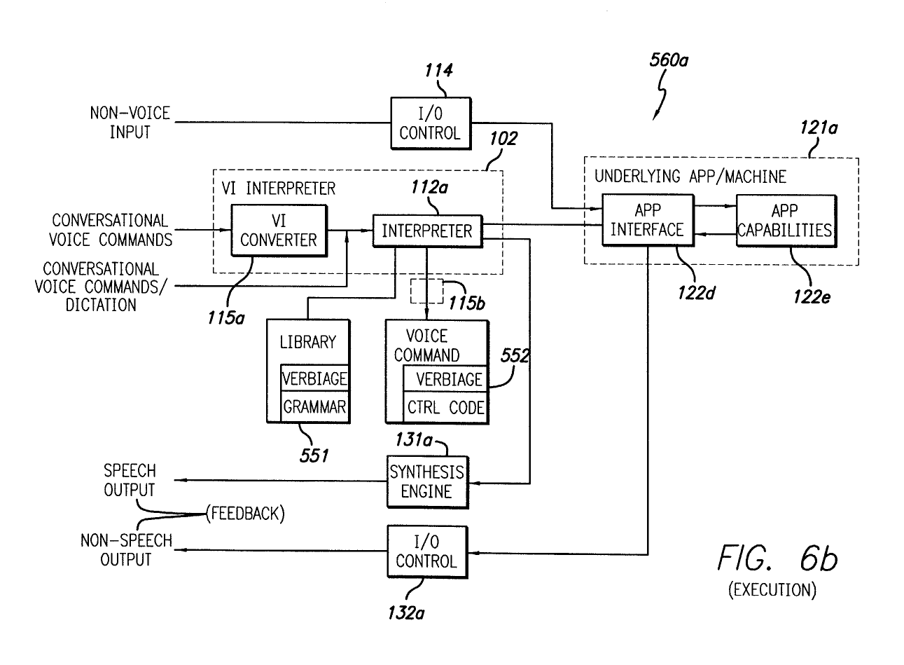

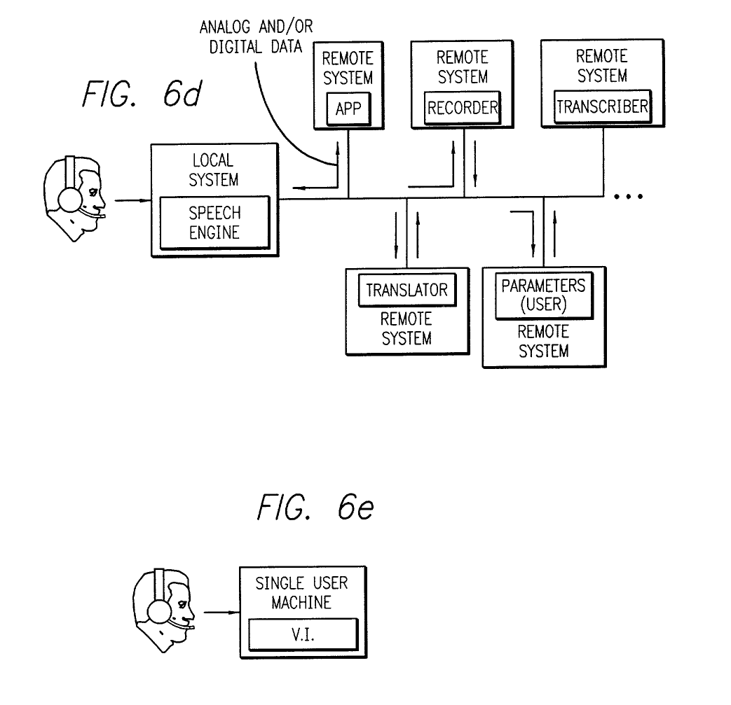

FIG. 6a illustrates a conversant command executer 600 that provides for initiating/ executing speech/non-speech based commands, data entry or feedback according to an embodiment of the invention. As depicted, recognition and command interpretation elements 112 and 115 are configurable such that they are capable of operating in an OEVI-like manner more consistent with prior (matched, non-conversant, individual-user and speech-only) implementations. FIG. 6b further illustrates how, following even prior recognition, a command interpreter can be implemented in a separate manner as a conversant “converter” prior to or following conventional command interpretation 115a or 115b, or in a more integrated manner, such as will be next discussed in greater detail. (Converter 115a, 115b can also include, for example, converter 113 (FIG. 1) or other system 100 elements. Thus, surprisingly improved accuracy and conversance can be achieved via an OEVI-like configuration (e.g. using overlaying), or further benefits can also be achieved via further reliability, conversance or other execution time processing.

Capabilities provided by careful command creation can also be “shared” or enhanced during execution; reduction of the limitations imposed by prior systems, such as those already discussed, can also be similarly shared or enhanced. Note, however, that further processing will likely require greater processing resources and be less compatible with prior command processing. (A pre-recognition engine processor, while not shown, can also be utilized for signal conditioning, input element exaggeration or other recognition enhancement; when input recording/playback is used, such processing can be provided after recording in order to enable the integrity of recorded information to be maintained.)

FIGS. 6a and 6b also illustrate how further improvements are also achievable via shared-resource utilization or integration of one or more executor 600 elements within a more advanced command interpreter 115 capable of also providing recognition reliability/application support, a more advanced interpreter or both. Systems 600 and 600a, for example, (with or without further superposition) enable the utilization of “hooks” to conventional or future interpreter processing (e.g. via function calls) or the interception of commands (e.g. in a similar manner as with a superimposed implementation). Systems 600 and 600a also enable (with or without further superposition) the adaptation of existing or future interpreters for more integrated approaches that might be utilized. Thus, the present executor example (as with other element examples discussed herein) enables various existing interpreters to be utilized with or without modification in accordance with a particular application.

1. Executer Elements Overview

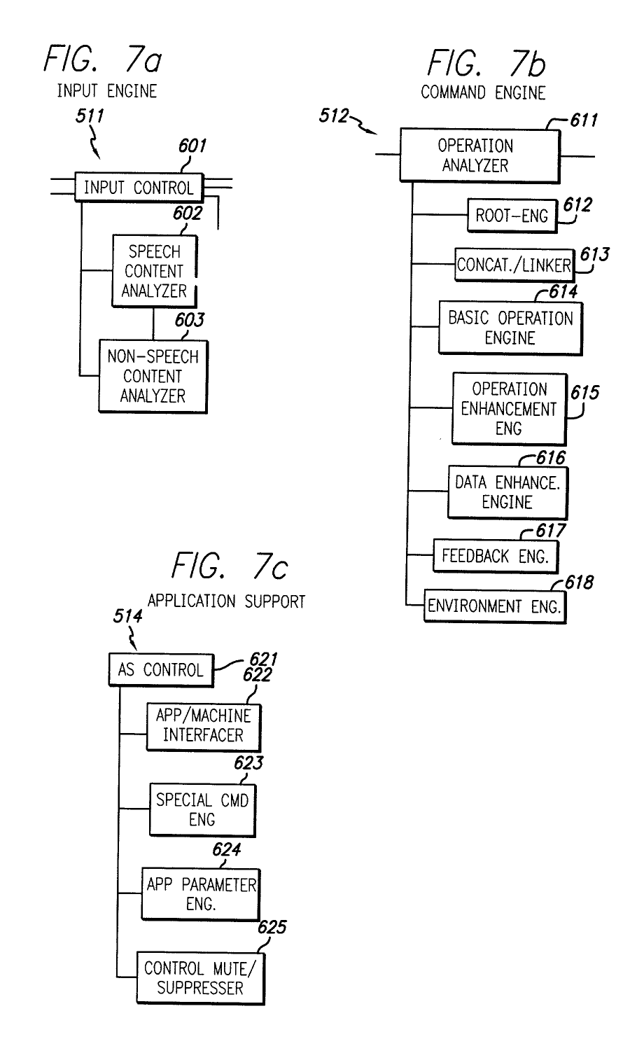

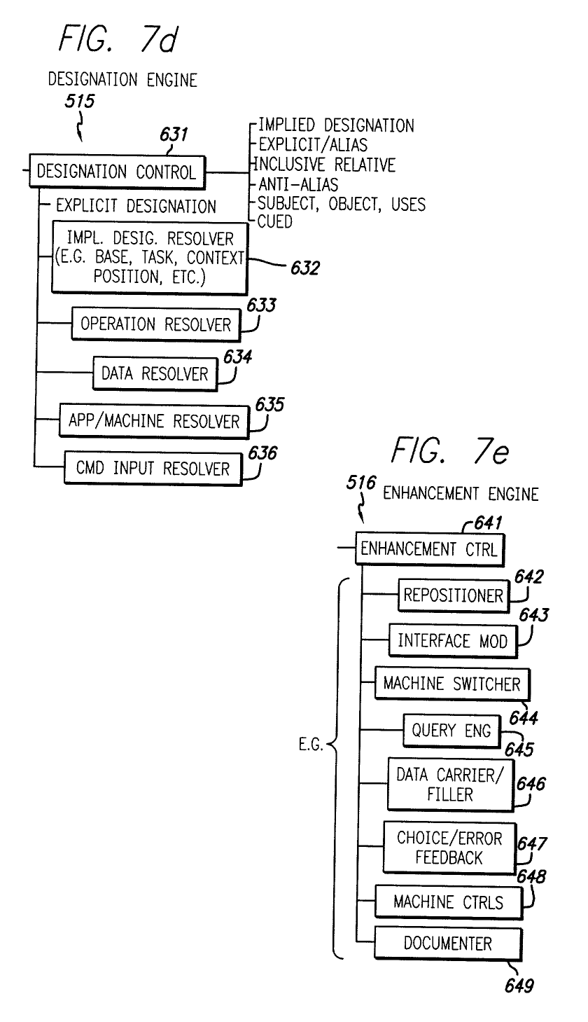

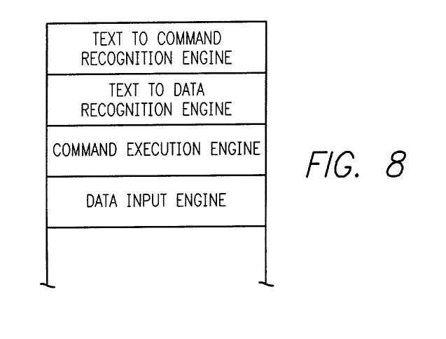

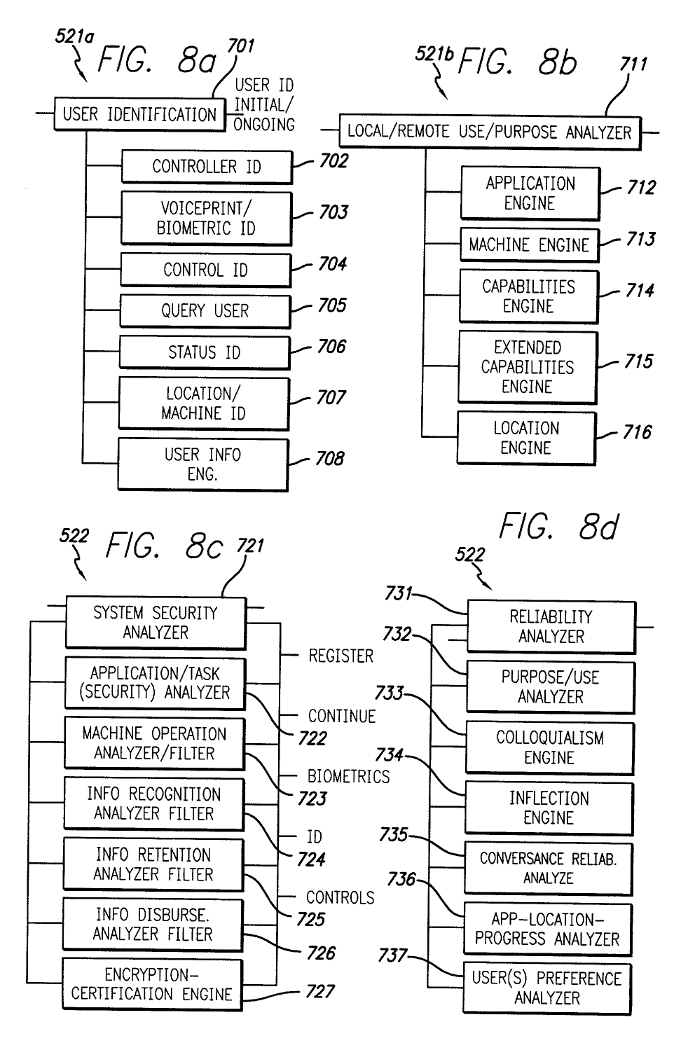

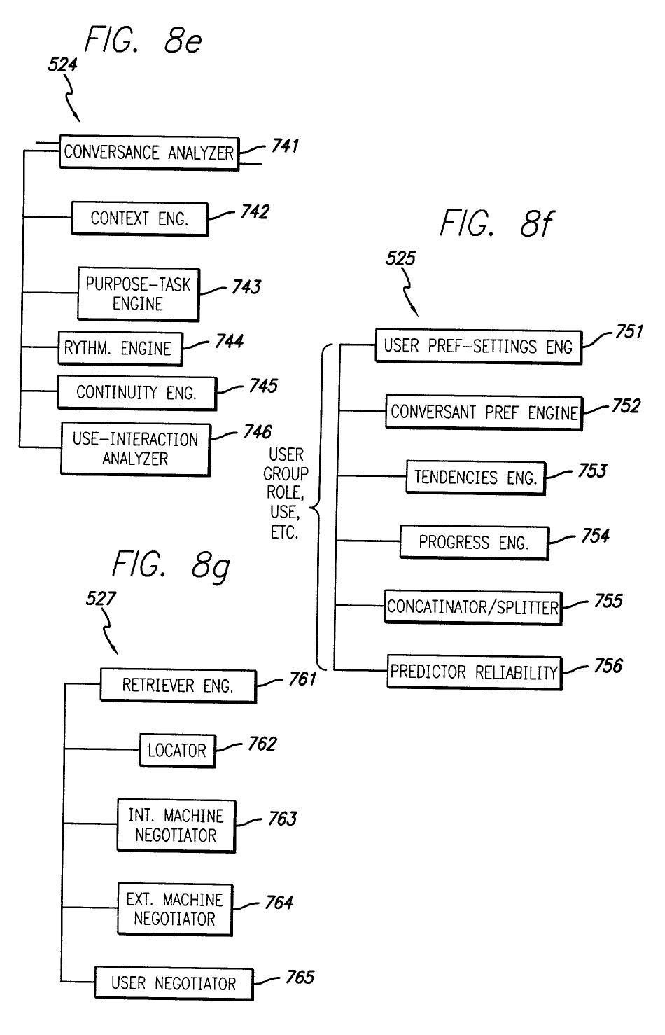

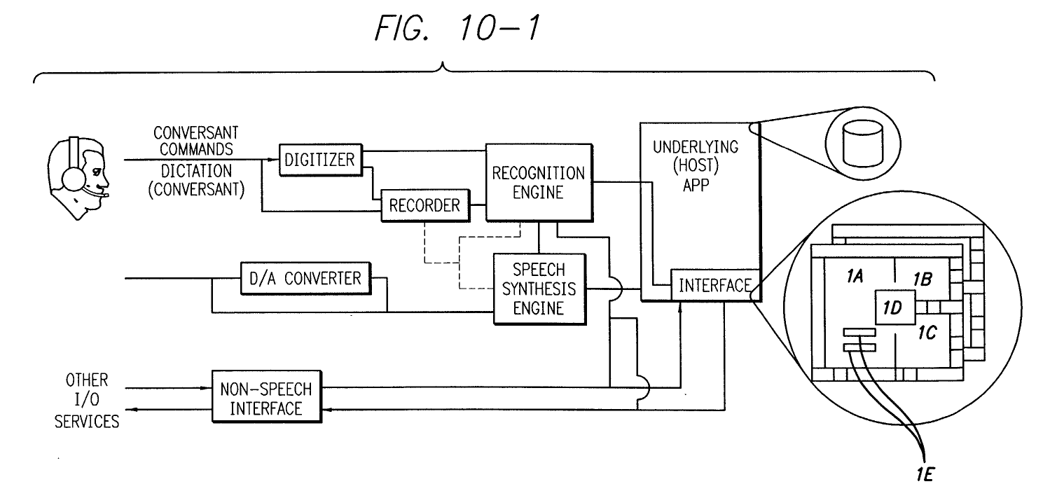

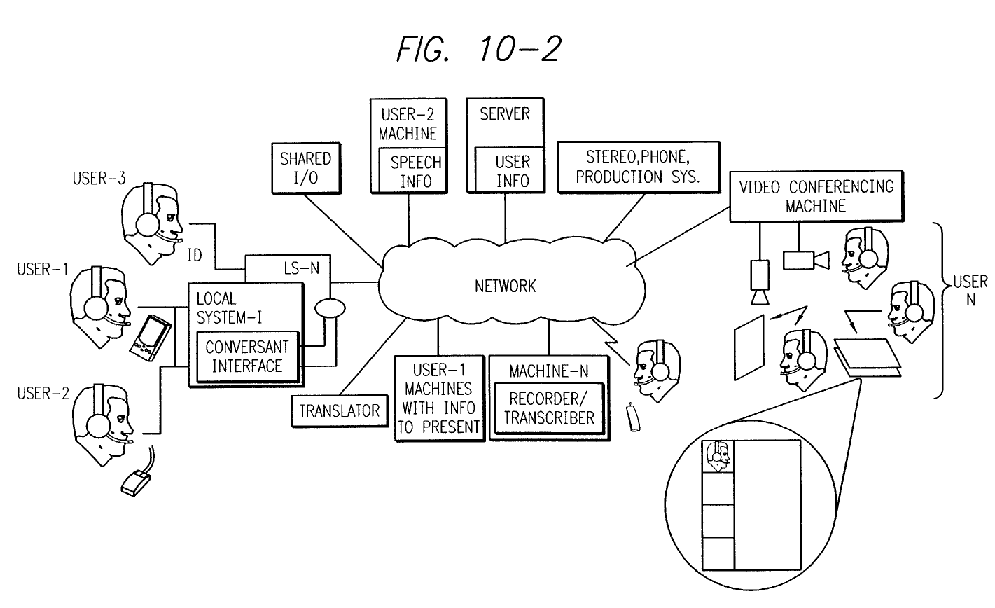

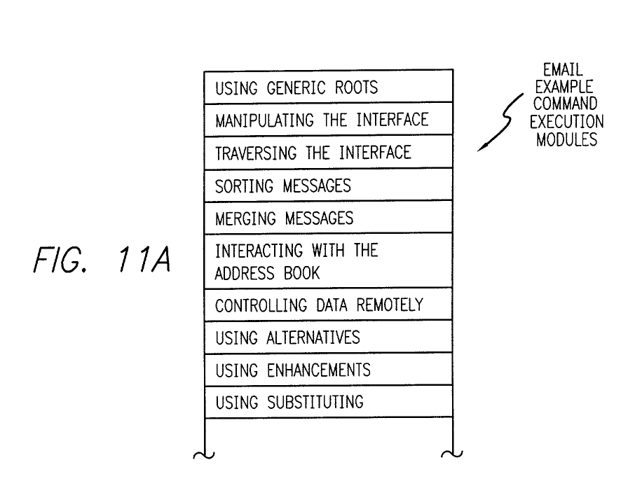

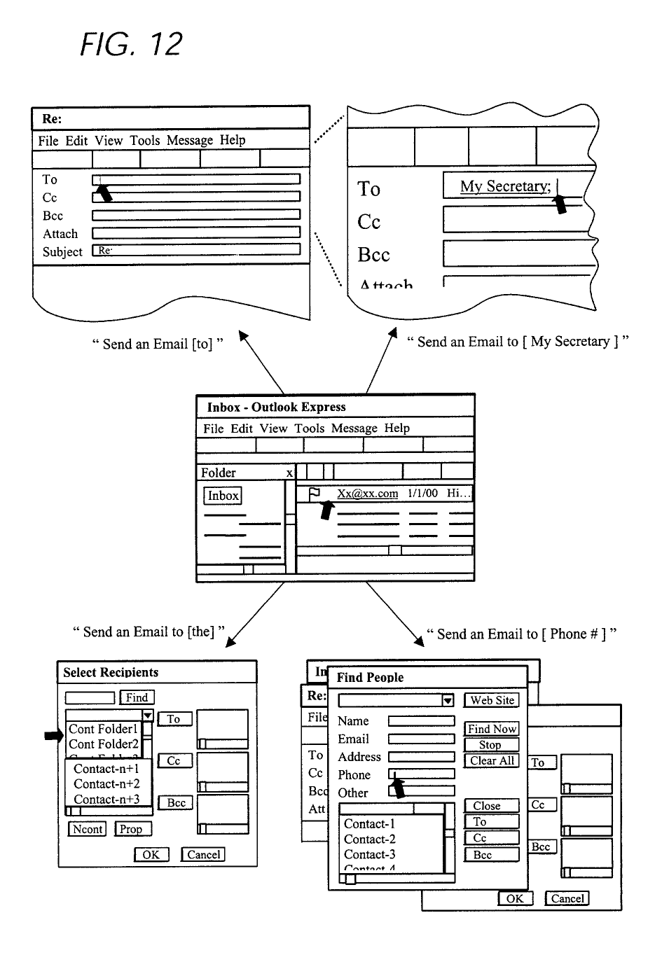

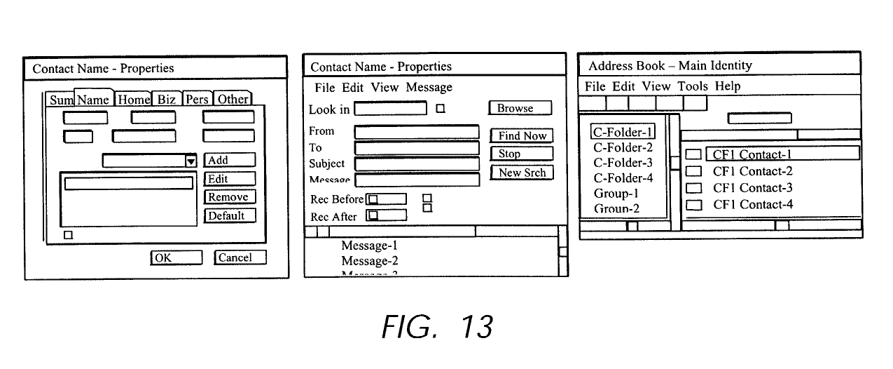

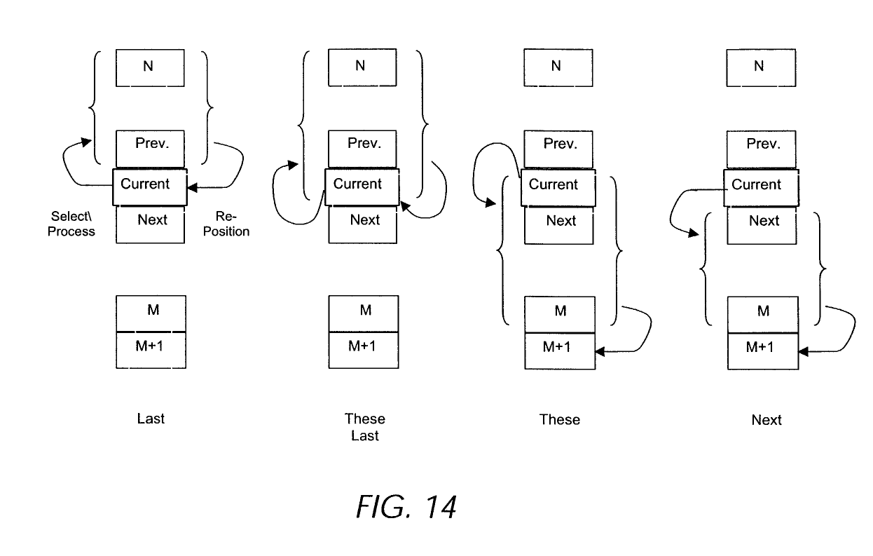

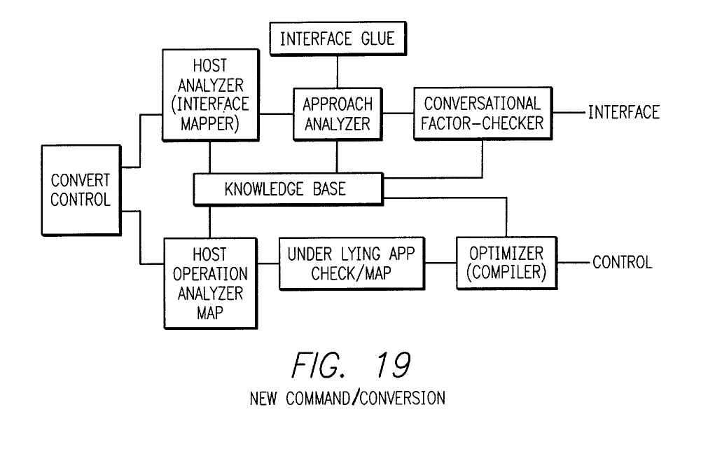

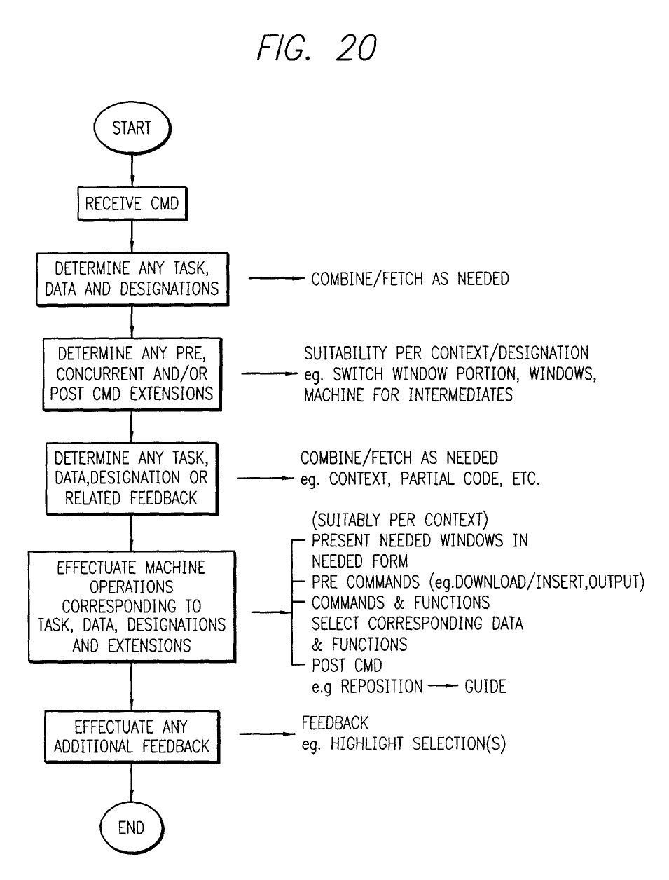

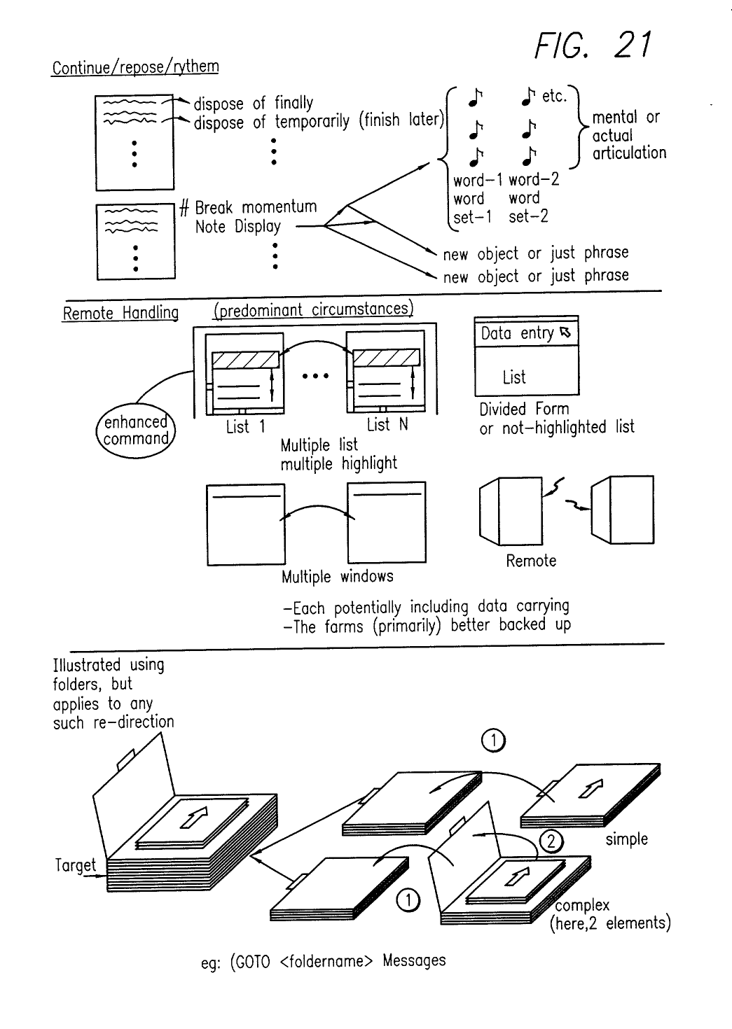

The following provides an overview of execution system 600 of FIG. 6a. Examples of elements that can be used to underlay execution system 600 element operabilities is also provided with references to FIGS. 7a through 7e and FIGS. 8a through 8g. (The examples further demonstrate that, while one-to-one elemental correspondence might be used, more distributed implementations can also be utilized.)

Within a more typical recognition engine 112 embodiment, recognition control 601 provides for analyzing speech input, determining therefrom “spoken” word or phrase input or input “recognition alternatives”, and transferring the (verified or yet unverified) results to command interpreter 115. Language analyzer 602 provides recognition control support for recognition control 601 including determining speech corresponding to received input in accordance with a predetermined vocabulary, grammar rules or further non-conversant or conversant analysis or refinement application-support aspects (e.g. see also FIG. 6b). Particularly recognition aspects of reliability or application/machine support can also be provided via elements 621-626 or within a suitably advanced recognition engine providing, for example, a conversant recognition reliability engine 603 or conversant application support engine 604.

(For clarity sake, elements corresponding to elements 611-626 -including conversant elements—will be separately discussed. A conventional elemental recognition engine implementation will also be presumed, such that at least one manner of achieving backward compatibility might be better demonstrated with regard to raw speech recognition, and better understood with regard to variable-input interpretation implementations.) Command/data engine 611 provides for receiving speech/non-speech input, differentiating commands and data and processing and outputting data, commands or both.

Command interpreter 115 operation is further supported by conversant command engine 612, which determines more specific command, data or feedback output in conjunction with reliability determination by reliability engine 622 (or 613), application/machine support engine 614 or portions of other of refinement and support elements 621-626. Designation engine 615 provides for explicit/implicit subject, object and specificity determination, and enhancement engine 616 provides for interface/machine operability, information utilization and user experience enhancement.

Of the reliability and application/machine support elements 621-626 (or “support engine” 620), user-use engine 621 provides for identification of one or more users, and for resolving application, machine or command element “utilization”. Security engine 622 provides for enabling determinable user access, filtering, storage/retrieval and operability with regard to various applications, machines, machine features, enhancements, etc. Reliability engine 622 similarly provides for further recognition or interpretation refinement, more suitably in accordance with conversant attributes such as those already discussed. Conversance engine 623 provides for receiving and analyzing speech and non-speech elements (e.g. input or non-finally processed input) in accordance with conversant aspects, and returning recognition, command-input differentiation and command interpretation refinement information. History engine 624 provides for analyzing history or current input alternatives in determining recognition/ interpretation in accordance with more likely user objectives or system efficiency. Information retriever 626 provides for communicating user, machine or other information for use in or as a result of recognition, interpretation or application facilitation. (Information retriever 626 is further capable of communication generally with other elements, and can comprise a shared resource for other elements of system 100 of FIG. 1).

FIGS. 7a-7d illustrate command interpreter 611 elements of command executer 600 (FIG. 6a), while FIGS. 8a-8g illustrate support engine 620 elements according to an embodiment of the invention. The depicted implementations utilize, within each of the command interpreter and support system elements, a “control” element (given first) plus one or more remaining analyzers/engines for providing supportive analyses or other operations, one or more of which might be utilized to receive, process and return information. Among other considerations, such an embodiment enables adaptability to various existing or more advanced speech engines, other control elements, analyzers/engines or other resources that might be utilized, and simplifies implementation, maintenance and updating. Other implementations might, however, also be utilized.

2. Command interpreter

Beginning with FIG. 7a, an exemplary command/data input engine 611 comprises input control 701, speech content analyzer 703 and non-speech content analyzer 704. Input engine 611 provides for initiating the remaining elements as needed for recognition reliability, command/ data differentiation and command selection/utilization, or a portion thereof. Speech content analyzer 702 provides for initiating speech or other expression input e.g. speech motion, audio, graphics/ video, etc.) determination, while non-speech content analyzer 703 provides for initiating reliability/operability determination with regard to mousing event or other largely static event input, both receiving, transferring and analyzing respective information as needed.

Recognition reliability analysis results can be returned to input control 701 (or raw input resolution can be further returned to recognition engine 112 in a suitably advanced embodiment) or further processed within command interpreter 115, while command-data differentiation processing can be conducted in accordance with the following.

(Event input can utilized to execute commands in a more accurate manner consistent with a current machine state, or further in determining user objectives; event input can be monitored in conjunction with conversant input via polling, machine state reporting or other suitable mechanisms. Note, however, that even mouse input can also be utilized conversantly—such as already noted in the above discussion. The following is thus also applicable to recognition reliability or other factors consistent therewith.)

FIG. 7b illustrates how an exemplary command engine 612 includes operation analyzer 711, root engine 712, linker 713, base operation engine 714, operation enhancement engine 715, data enhancement engine 716, feedback engine 717 and environment engine 718. operation analyzer 611 provides for receiving alternative-resolved input and utilizing other elements (e.g. reliability, history or conversance engines, etc.) for determining corresponding commands or command enhancements. Root engine 712 provides for determining an applicable root command in conjunction with received input. Linker 713 provides for determining whether later (typically successive) input forms a part of a command/data input already received and causing a linked command to be invoked accordingly (e.g. enabling “send an email to X” and “send an email”—breath—“to X” to provide similar results). 20 Of the remaining command engine 712 elements, basic operation engine 714 provides for resolving input (e.g. in conjunction with designation engine below) and causing a corresponding basic operation (with any extensions) to be executed. Enhancement engines 715-717 similarly provides for determining and causing to be executed any operational, data or feedback processing enhancements corresponding to the basic operation and other applicable engine results respectively (e.g. the above-noted special commands, location or other context/sub-context, intermittent event input or other history, etc.). Environment engine 718 provides for assuring a determinable degree of interface continuity and appropriateness within a given environment or approach and for any “environment” specific processing (see above).

FIG. 7c illustrates how an exemplary application support engine 614 includes application support control 721, application-machine interfacer 722, special command engine 723, application parameter engine 724 and suppressor 725. Application support engine 614 provides for interoperation in accordance with a particular application (which can include one or more linked or interoperable machines, or machines themselves). Application support control 721 provides for inter or intra element initiation, instantiation or communication (e.g. operation, state or parameter passing).

Application-machine interfacer 722 provides for determining a communication mechanism appropriate to operating a particular current machine or machines (e.g. as stored or obtained via communication of such information). Special command engine 723 provides for determining unique-operability machine procedures that might be utilized (e.g. operating a display, switching programs, moving data, causing an otherwise unavailable operation to appear to be available, such as already discussed). Application parameter engine provides for establishing user, interaction or user-status parameters (e.g. officiator) on an application, machine, machine function or task basis; these are generally determinable via a user, storage 110 or information retriever 627 (for remotely stored such information), and corresponding security information is determinable via security engine 622 (FIG. 6a).

Finally, control suppressor 725 of application support engine 614 provides for suppressing operabilities, presentation of operabilities, data or other information in accordance with application, machine, user or security parameters. For example, camera/microphone localization or “private discussions” in video/phone conferencing, or not transmitting confidential information (e.g. via muting, substitution or disabling) to or via a cellular phone or other less “secure” machine, among others, might be suppressed or provided in accordance with such parameters (see below).

FIG. 7d illustrates how an exemplary designation engine 615 provides for receiving designations from (typically) command engine 612 (FIG. 7b) and determining therefrom or “resolving” (typically in accordance with application support engine 614 of FIG. 7b or one or more of engines 621a-525 of FIGS. 8a-8f) available references. As shown, various “designation modes” can be provided as pertaining to a particular user, application, machine, etc. or be provided on a more global basis, as with the OEVI. Designation control 731 provides an overall designation control mechanism as already more generally discussed. Explicit designation resolver 732 Implied designation resolver 633, operation resolver 734, data resolver 735 and application-machine resolver 726 more specifically provide for resolution of explicit, implied, tool, data and application/machine specific designations respectively.

Resolution of explicit designations, such as a name or alias, can include determining where the designation might be located (e.g. in a local or remote address book, mail merge, remote control, etc.) and resolving no corresponding references or selecting from more than one reference (e.g. by user selection, preference, priority or selection rule). An implied designation mode provides implied designations including inclusive relative position (e.g. relative to the start or end of a grouping or a current item, including or excluding a current item), location (e.g. a next or input-corresponding data field or other presentation element), an inputting user, or an anti-alias (i.e. a pseudonym that specifically relates a generic identifier to one or more particular persons/items, typical in relation to an inputting or other, such as “my mom”, “X's <item>”, etc.—see below).

The remaining resolvers typically provide, in addition to the resolution provided above, particularities with respect to operations, data or a given application, machine etc. For example, operation resolution can include identifying one or more particular machines, tools or modes of operation, particularly where more than 1 machine is used or specificities are input (thus, often utilizing app/machine resolver 735 as well). Data resolution can include identifying remote data (e.g. the above-noted operation outside a pop-up window, etc.), as well as specific rules as to data position (e.g. whether a following non-abutting word is a “next” or “current” word.) Application or machine resolution can include applying specific parameters with respect a programs within a particular application, a particular program or other machines, processes, etc., among other examples (which should become apparent to those skilled in the art).

Cued input resolver 636 provides for associating an later input as “cued” to an earlier one. For example, mixing music (or other applications) can require an extended setup, particularly where specified using voice commands; recognition and implementation of each one can further require an undesirably extended time period. Therefore, “cued” input resolver enables one or more prior “inputs” to be executed upon receipt of a “cue input” or more than one such cues to be given. A given later-input cue can include, for example, an interpretable gesture (e.g. voice command) that can be implemented upon interpreting, timed interval, implicit/ explicit time/event, etc. or —typically more suitably—upon a “cueing” event that need only be recognized as occurring (e.g. moving a slider, clicking a button, etc.), where faster responsiveness is more desirable, or some combination. (Examples of suitable control mechanisms are also provided with reference to security/control in FIG. 8a and correspondence determination examples are provided in FIG. 8b.)

FIG. 7e illustrates how an exemplary enhancement engine 616 includes for responding to an enhancement indicator (in addition to enhancement control 741 -see above), repositioner 742, interface modifier 743, machine switcher 644, query engine 745, data carrier-filler 646, chooser 747 and machine controller 748. Repositioner 742 provides for determining a typically pre or post command positioning of a presented or not presented designation indicator (e.g. curser/mouse pointer, present-next indicator, window/segment indicator, message response indicator, etc.) or a machine element (e.g. window/screen, window/screen segment, question-answer frame, conversation reference, etc.). Interface modifier 743 provides for adding/removing interface elements or causing the machine to otherwise operate in a non-standard manner (e.g. highlighting presentation elements, adding tools, altering window or other presentation sequencing, etc.); such modifications are providable, for example, via add-ins, applets, servlets, memory space modification, hooks, alternative hardware/object signaling -even macros, such as with the OEVI, among other more conventional or emerging mechanisms. Documenter 748 provides for adding documentation or other data supplementing (e.g. conjunction with command or data input, such as in identifying a current user, user edit, a confidentiality notice, implicit subject/object, etc.); data elements other than text can also be similarly provided (e.g. graphics, such as a photograph or chart, video, audio, animation, etc.).

3. Support Engine

It should become apparent that unlike conventional systems, the present executor example enables interfacing of not only one user with a particularly presented event-driven system, but also conversant interfacing, among potentially two or more users with two or more systems, and with regard to commands, data or both. Accordingly, the present example also provides for initial or ongoing user, use and security or other issues, in addition to reliability improvement or other capabilities.

Turning to FIG. 8a, an exemplary user engine 621 a comprises user identifier 801, which typically operates conjunction with security engine 622 and one or more of elements 802-808 to provide for identifying one or more users. Controller identifier 702 provides for identifying a user in accordance with a particular controller (e.g. a microphone or localizing combination of microphones). Currently, such identification is more likely applicable once a user-controller correspondence has been established, such as after identification by another user or the system, assuming such association can be established. (New devices might more suitably provide for initial and ongoing user/device identification, such as when activated -e.g. speaking into a microphone or moving a pointer; current devices can, however, also be utilized via polling of the device/device-connection, receiving an interrupt/connection indicator, localizing or other mechanisms.) Biometric identifier 803 further provides for initial or ongoing user identification in accordance with an ascertainable reliable user voiceprint or other biometric information (e.g. fingerprint, retina, handwriting, etc.). As will become apparent, ascertainable comparative information can be stored locally or communicated from a remote source, for example, according to stored user information location parameters or via one or more centralized remote information storage; comparative information might also be entered and verified prior to use, among other alternatives.

Control identifier 804 further provides for identification of a user in response to a particular user control, such as invoking a temporary or continuous actuator (e.g. one or more buttons/sliders providing midi, mere identification, control or other corresponding information). While less secure or automatic, such a mechanism is likely inexpensive and, as with the above mechanisms, avoids other non-conversant alternatives. User-query 805, for example, enables a user to indicate his name (or other identifier) prior to a first input to a less capable system, or each input to a more capable system, without prompting or with prompting (assuming a discontinuous user input is recognizable). It will be appreciated that such controls can further be more securely identifiable with a given user following initial identification via user(s) localization (e.g. position/movement vs. substitution), witnessing, direct/indirect attachment to a user's person (e.g. clothing, ring, headset, etc.), among other possibilities.

Once associated, each user can, for example, be identified for multi-user data entry (e.g. question-answer, workgroups, etc.) that can further provide automatic annotation or in a static or modifiable manner (e.g. application, local/remote machine, one or more user/system parameters, formatted, etc.). Control or flexible secure control, data entry or “reporting” or still further capabilities can also be provided to one or more local or remote users.

Of the remaining user engine 621 elements, status identifier 805 provides for associating an identified user, such as given above, with various status-determinable criteria. Upon receipt of a user indicator and attempted input, status identifier determines whether such input is allowable (e.g. in conjunction with security engine 622 of FIG. 6a) and returns a corresponding status indicator. Such “status” can include a single user status for accessing various system controls or information (e.g. security below). Status identifier 805 also provides for group-related status indicators, such as where one user is an officiator of a conference, an uninterruptible or conditionally interruptible participant, etc.). Machine-location identifier 807 provides for associating a user and a user-information storing machine (e.g. user preferences, speech files or other control parameters or other of user's remotely stored information. Finally, user information engine 808 provides for retrieve a default, application/machine or other set of user-information from storage or a “located” remote machine.

FIG. 8b illustrates how an exemplary use engine 616 includes use analyzer 811 (see controllers/analyzers above), application engine 812, machine engine 813, capabilities engine 814, extended capabilities engine 815 and location engine 816, each of which responds to a requesting element by providing use-related information or conducting one or more use related operations. Application engine 712 provides for determining application-related parameters in accordance with a current or next application (e.g. in an application-transitional context), such as defining user/application parameters to retrieve from a local or remote source or in executing commands relating to a particular application, and machine engine 813 similarly provides for determining machine-related parameters. Capabilities engine 814 provides for further determining enabled/disabled non-current operabilities or enabling or disabling them. Extended capabilities engine 815 further provides for determining/facilitating enhanced or combined-machine operabilities, as with application or machine engines 812, 813. Finally, location engine 816 provides for determining (e.g. via history, machine polling, etc.) a current or persistent pointer location (e.g. mousepointer, curser, etc.) in accordance with which commands can then be executed (see location generally, cued operation and other examples above).

FIG. 8c illustrates how an exemplary security engine 622 comprises system security analyzer 821, security input analyzer 822, operability analyzer 823, analyzer-filters including acquisition filter 824, retention filter 825 and disbursement filter 826, and encryption-certification engine 827. System security analyzer 821 provides for determining/implementing system level security, such as system or system portion access or secure access parameters that can further correspond to a user, system, machine or other parameters. Application-task analyzer 822 provides similarly for determining/implementing application or task level security, again enabling various criteria or parameters according to which such security can be further implemented.

Analyzer-filters 823-825 facilitate security more particularly related to the freedom provided by conversance or otherwise more “free-form” I/O. That is, rather than treating user/ machine input treated as generic, analyzer-filters 823-825 provide for determining received information content or content types and, upon determining such information (e.g. a particular designation, specificity, confidential data element, etc.) provide for correspondingly removing, modifying or replacing the input element(s). Such analysis/determining can, for example, be conducted via parsing input, stored or for-output information respectively, and comparing the information to a stored or otherwise ascertainable element set; such element or elements can be replaced, deleted or modified in accordance with corresponding elements or other processing (e.g. users, purposes, contexts, tasks, applications, machines, providing feedback, etc.) (Other suitable mechanisms can also be used.).

Analyzer-filters 823-825 can, for example, be used to remove a company, individual or product indicator, locator or parameter; confidential element; tool use; contextually significant information; etc. as spoken into a cell phone for storage or re-transmission (e.g. of biometric data, from remote conference members, to a generally accessible database or from a private one, to a remotely initiated correspondence addressed to a particular user, group or machine, etc.). A suitable feedback can also be provided to indicate such processing or provide a warning as to the receipt of such data.

Finally, encryption-certification engine 827 provides for encrypting/decrypting, authenticating, certifying determinable types of information as related to received parameters (e.g. from conversance, user, use or other engines) corresponding to one or more users, purposes, contexts, tasks, applications, machines, etc. For example, voice-print or other user-identification or other confidential information can be retrieved (if needed), decrypted, utilized and discarded, with further ongoing identification being provided as given above. The above discussed input, persistent data or output analysis/filtering or other security can also be conducted in accordance with user, source, destination or other authentication/certification or in conjunction with encrypting/decrypting. Other suitable security mechanisms can also be utilized.

FIG. 8d illustrates how an exemplary reliability engine 623 comprises reliability analyzer 831, purpose/use analyzer 832, colloquialism engine 833, inflexion engine 834, conversance reliability analyzer 835, application-location progress analyzer 836 and user(s) preference analyzer 837. Reliability analyzer provides for determining from received input, interpretation/ utilization possibilities corresponding thereto in conjunction with the remaining elements. Purpose/use analyzer 835, for example, provides for including commands or data consistent with (or excluding commands/data inconsistent with) a determined purpose or use (e.g. application, machine, etc.); note that such purpose or use might further determine a particular manner of operation (e.g. applying user parameters, vocabularies, etc.), or might merely narrow command recognition possibilities (as a command/data, particular command/data, etc.). Colloquialism engine 833 provides for determining a colloquialism or other typically vocabulary selection alternative consistent with other reliability metrics (e.g. charting, use of abbreviations, formal letters versus familiar, etc.). Inflexion engine 834 provides for determining, from an input inflexion (e.g. pitch, speed, direction, pressure, etc.), a corresponding more or less likely command/data; a raised voice might, for example, indicate a mistake by the system such that a correction machine might be invoked, or other correspondences might also be utilized (see above).

Of the remaining reliability engine elements, conversance reliability analyzer 835 provides for inclusion or exclusion of possible command/data differentiation or included command/data portion possibilities according to conversant aspects, such as those given above. Application-location progress analyzer 836 provides for determining, typically from input or history information, a likely successive location or other “progress”. For example, the OEVI provides enhancements that reposition a curser downward through a list; while such progress can be alterable via user selection, recognition of a user trend is thus also implementable, as is support (e.g. via enhancement) for determining and adopting other ongoing use trends. Finally, user preference analyzer 837 provides for enabling user modification of, retrieving or implementing user preferences (e.g. internally or via machine parameter modification). As was already discussed, a user's preferences relating to interfacing, applications, machines, etc. are retrievable locally or remotely and, one retrieved, can be utilized to modify interpretation metrics/utilization or operability accordingly (see also the information retriever example depicted in FIG. 8g below).

FIG. 8e illustrates how an exemplary conversance engine 624 includes conversance analyzer 841, context engine 842, purpose-task analyzer 843, rhythm engine 844, continuity engine 845 and use interaction analyzer 846. Conversance analyzer 7841 provides for conversant utilization (e.g. for greater reliability with lesser or non-conversantly structured commands) or further reliability in accordance as is achievable in accordance with conversant aspects. It will be appreciated, for example, that context, tasks, etc., can be identified and utilized as traditional or artificial intelligence metrics during execution even where a word or structure is otherwise unsupported. Accordingly, context engine 842 provides for determining a current or successive context, and purpose-task engine 843 provides for determining a current or successive purpose/task (or trend thereof). Continuity engine 845 determines a likelihood of a continuing conversance trend or likely consistent “next” command/data element, for example, corresponding to recent history. Use-interaction analyzer 846 provides for tailoring the above element results in accordance with a particular approach, environment, machine, etc. (e.g. providing for a response consistent with a telephone, OS, question-answer interface, etc.) Note that the use of reliability engine 623 of FIG. 8d has been presumed. In other cases, conversance engine 624 (or other command interpreter elements) can also operate in a more independent manner for determining the likelihood that input is a command or data or the likelihood of particular included elements; inclusion/exclusion or other input effectuating based on such determinations can also be conducted in a more separate or distributed manner in accordance with a particular application.

FIG. 8f illustrates how an exemplary history engine 625 comprises user preference settings engine 851, conversant preferences engine 852, tendencies engine 853, progress engine 754, concatinator-splitter 855 and predictor reliability engine 7856. Each such element provides for facilitating use of recent/trend or further-extending history information. User preference settings engine 851 provides for user-specific, or further, user determinable preferences for evaluating history information. Conversant preferences engine 852 provides for evaluating or modifying conversant aspects corresponding to one environment, application, machine, etc. differently than another or further with respect to one or more users (e.g. by individual or group personage, status, etc.). Tendencies engine 853 and progress engine similarly provide for evaluating or modifying tendency or progress parameters respectively and thereby affecting response by the system to such factors (see above).

Concatinator 855 provides for determining (in accordance with conversance or other factors) whether a current input is to be completed or provides for completing a prior command (e.g. cueing, an unintended break in a command, a further corresponding input, a later specificity, etc.). Concatinator 855 also provides for splitting input into component input for different machines or machine operabilities. For example, “Send an email” might display a blank email, at which point “to X”, “re . . . ” “attach . . . ”, etc. can all be used to redirect control. More subtle uses, such as facilitating manipulation of objects in a graphics program (perhaps differently, but using one command), editing music, conferencing, etc. are also similarly supportable by joining likely, inferred or explicit—yet separate—input. Numerous examples will become apparent to those skilled in the art in view of the teachings herein.

Predictor reliability engine 856 provides for determining the accuracy at which predictions are or have been made. Thus, a determination can be made whether to rely on a current prediction or enable re-input or user selection, or otherwise NOT rely on a prediction; parameters can also be adjusted accordingly, or predictive efforts can be limited or forestalled (again, automatically or with user interaction).

Finally, FIG. 8g illustrates how an exemplary information communicator 627—the remaining support engine element of the present embodiment—includes communication engine 861, locator 862, intra-machine negotiator 863, inter-machine negotiator 864 and user negotiator 865, each of which facilitates local or remote communication of information. Communication engine 861 provides for communication information within a host machine or included machines, or with external machines. Locator 862 provides for identifying such machines (e.g. an external or “remote” user machine containing retrievable user speech or other information automatically upon user identification or otherwise). Intra-machine negotiator 863 provides for interfacing with a host machine or included machines, while extra-machine negotiator provides for interfacing with remote machines and user negotiator 864 provides for interfacing with a user (e.g. supplying such information to communication engine 865 in accordance with a location or other machine/element identifier returned by locator 862 to communication engine 861).

It will be appreciated that the utilization of one or more of command executor elements will likely depend on more particular implementation considerations; most can further be utilized for more reliable, generally functional or application, machine, conversance or other factors in conjunction with recognition, differentiation, command/data portion or user/use identification, security or some combination. As with other system 100 elements, uses, integrations, resultant command sets or other variations will also become apparent to those skilled in the art in view of the teachings herein.

A process by which voice-command elements can be derived, actual voice-commands can be created and a voice-interface can be constructed according to the invention is given by the following broad iterative method. It should be noted that the exemplary OE voice-interface and other interfacing and tool improvement efforts represent ongoing development projects. As such, particularly the initial OE voice-commands were derived largely by iterative trial, error and correction (the most significant of which are noted below). Commands and modifications incorporated at each stage of development are, however, increasingly based on observed user-approach, speech pattern and voice-command trends. While iterative with regard to the various steps, a sequential ordering of steps has been imposed so that aspects of the invention might be better understood. Headings and sub-headings have also been added for greater clarity and should not be construed as limitations of the present invention.

Iterative Method As Applied to Tasks and Contexts

Analysis and Element Determination

1. Determining the nature of the application and tasks that a user of the application might want to accomplish;

2. Determining how such tasks relate to the capabilities/feedback of the application, application alternatives and/or generic capabilities

3. Determining basic tasks and task permutations;

Command Construction

4. Constructing command structures and verbiage for basic tasks and task permutations in accordance with context, continuity, rhythm and other conversational factors; and

Interface Refinement

5. Analyzing the potential command forms to determine their compatibility with other commands having converging similar contexts and, if needed, adding alternative commands.

1. Determine the Nature of the Application and Tasks That a User of the Application Might Want to Accomplish;

Purpose Distillation

First, an abstraction or “distillation” of the nature (or “purposes”) of an application type is preferably conducted—at least at first—in as separated a manner as possible from a particular implementation. Initially, results can be used to facilitate identification of associated tasks. Later, results can also be used in determining other aspects of command/interface creation and refinement, and in augmenting, subduing and even transcending underlying application/interface elements as might be desirable.

For example, a more conventional “implementational” review might depict OE as a PC-based email computer program having a traditional GUI interface that includes thousands of commands divided into more than fifteen window and window-element based functionalities, the main or “Outlook” window being a starting point for accessing other functionalities. Functionalities might be further viewed in terms of the specific menu items, buttons and data entry fields that are selectable within a currently active window or window-element for modifying pre-selected email elements.

However, the nature or purpose for which OE and similar application implementations are directed can instead be viewed as generally handling a form of communication and, more specifically, email. Emailing can also be further abstracted as serving three primary purposes: (1) disposing of newly received email messages; (2) disposing of existing email messages; and (3) creating new email messages.

Further purpose-distillations might also be conducted (e.g. depending on the application) in order to define more specific aspects, and/or to aid in determining further basic functionalities and confirming those already identified. For example, “disposing of newly received or existing email” can be further abstracted as viewing, highlighting and acting on received messages (e.g. move, delete, reply, etc.); “creating new messages” can be further abstracted as initiating them, adding to them, addressing them and sending them.

Note that the above distillations and distillation results, while useful in creating the OE voice-interface, are merely examples. Further distillations might be conducted in accordance with these and/or other factors, and other results might also prove useful. Also, initial purpose-distillation generally need not be continued beyond the point at which “the basic types of things for which an application type might be used” becomes clear. Care should be exercised with regard to finer levels of detail, as they tend to suggest particular implementational constructs. (Considerations with regard to implementation are more preferably considered, at least initially, as part of a separate analysis.)

Task Distillation

Potential user tasks can also be considered for each identified purpose. Tasks, as noted earlier, relate to a user's expectation as to what he/she might want to accomplish, and thus might match or differ from identified purposes (particularly with regard to specificity). A useful perspective in determining tasks is that of a first time user of a machine; rather than being pre-disposed to particular controls or other implementation factors, such a user would more likely expect controls that are more consistent with producing desired results. Such expectations are both predictable and exploitable using the above and further methods. (E.g. Identified OE purposes might include disposing of newly received email messages; identified tasks might include replying to newly received email messages.)

While desirable, it is not necessary to identify every potential user task or to even list a particularly large number of tasks in order to benefit a resulting interface. Rather, interface efficiency gains can be achieved by simply developing a sufficient understanding of potential user tasks to aid in refining distillations and in later considering whether available capabilities do or can accommodate them (given a specific underlying application, interface and/or speech-tools). Additional tasks will also become evident in successive iterations.

Note that the methods disclosed herein are applicable not only to voice-enhancement of existing applications and voice-enablement of new applications, but also where underlying or speech-based features are added or modified. It is possible in each case that underlying application/interface elements might be incapable of operations that are sufficiently consistent with user tasks or other voice-interfacing aspects; if so and capabilities cannot be added using available tools, then a gap will exist with respect to affected tasks. This is unfortunate but not necessarily critical; such a gap might, for example, have lesser overall importance or be rendered less noticeable to a user. In this sense, initial distillation facilitates identification of tasks, which tend to facilitate an interface that is less affected by reflexively applied and often contrary conventional approaches or solutions.

2. Determining How Such Tasks Relate to the Capabilities/Feedback of the Application, Application Alternatives and/or Generic Capabilities

Elemental Distillation

Task identification is preferably followed by a further distillation of the underlying application capability and interface elements (if any). Such distillation serves several purposes, particularly in accordance with purpose-distillation and task identification results. Elemental-distillation provides for assessing the applicability of the underlying application/interface elements, as already noted. It also provides a more tangible comparative basis for identifying and correcting gaps or “holes” in a developing voice-interface and tasks defined thus far. It further provides a basis for evaluating aspects of the voice-interface, tasks and application that might be applied in a more generic manner, among other uses.

Elemental distillation broadly comprises reviewing the underlying application and interface elements to determine the capabilities they enable and how such capabilities can be used. Ongoing results are compared with identified purposes and tasks to further identify such aspects as task implementation possibilities, task holes, implementation alternatives, implementation holes and task/element relationships. For example, the OE Outlook window includes selectable message items, links to other window elements (e.g. a folder pane), sub-windows (e.g. columns manipulation), special-purpose windows (e.g. address book) and tools (e.g. a modifiable button bar). Tools include flagging messages (which might confirm an identified task or suggest a task hole), but do not include the capability of assigning an importance to particular email messages (which, if an identified task, might suggest looking elsewhere, seeking capability, interface and/or programming-tool alternatives or the existence of an elemental hole).

Relationships that might be discovered among identified purposes and tasks also tend to become more apparent by way of elemental distillation and comparison. For example, specific tools will in certain cases become identifiable as less consequential and largely replaceable or interchangeable. As will be discussed in greater detail, certain relationships will become identifiable as task permutations, while others will reveal conversational contexts (hereinafter simply “contexts”), and in still others, tasks might become identifiable as unique or application/ implementation specific. At this point, apparent relationships and their potential classifications are preferably merely noted. More dynamic conversational analyses (conducted later) will likely reveal additional characteristics and relationships that should also be considered before making a final characterization.

As with the other distillations, narrower and broader elemental views tend to not only identify new aspects, but also provide a basis for comparison. A narrow view tends to identify more specific capabilities (e.g. flagging or deleting messages) and/or interface elements (e.g. data/tool selection selections) which might suggest task aspects and/or capabilities for performing given tasks. Broader views tend to reveal consistencies and inconsistencies both separately and in accordance with iterations of other methods.

Elemental-distillation also aids in identifying aspects that do not work well or do not apply to conversational voice-interfacing. It was found, for example, that a first command that merely “accomplishes more” than a second command is not necessarily more efficient to use, and two commands that share verbiage can nevertheless provide vastly different degrees of efficiency (high efficiency being a particular advantage enabled by embodiments of the invention). For example, OE Outlook message-list can be sorted by column using menus or more specifically sorted by clicking on a message-list heading. However, more “capable” sorting by clicking on a heading is found to be an attractively expectable gesture that unfortunately produces non-intuitive and thus inefficient results in actual use (see below). It will also become apparent that using a “switch to find messages window” tool can be distracting and confusing; however, a “Find more messages” voice command—while similar in form and thus familiar—is actually more intuitive and thus more efficient to use (see below).

One explanation is that command and particularly voice-command efficiency is also related to a number of other factors. Such factors appear to include, for example, how readily a user might think of command, initiate a command, and achieve either or both alone or in conjunction with other commands.

Balance and Consistency

A particularly surprising discovery is that perhaps even more important than the specific verbiage used in communicative voice-commands are balance and consistency. While an ideal interface might provide an integration of voice-commands with other interface elements, similar benefits are not necessarily achieved by accommodating existing application/interface elements with targeted voice-commands. Rather, interface efficiency is found to be enhanced by causing the underlying application/interface to respond in accordance with voice-interface optimization, such as that disclosed herein; to the extent that this is not possible, a localized conflict is often preferable to a forced existing application/interface accommodation. In some cases, this might mean adding additional capability. For example, greater efficiency has been achieved in certain cases by assuring that capabilities relating to tasks supportive and complimentary to an included task are also included (i.e. balance); greater efficiency has also been achieved by assuring that a task supported in one instance is similarly supported in other applicable instances (i.e. consistency).

Using Overlayed Window-Switching

The following detailed OE voice-interface example should aid in forming a better understanding of the above aspects as well as implementational aspects of constructing a voice-interface and conventional interfacing and speech-tool limitations. For clarity, voice-commands are more generally noted rather than specifically stated; more specific voice-commands are instead discussed later in conjunction with voice-command construction. Those skilled in the art will also appreciate that, while the disclosed methods and apparatus have broad applicability, certain modifications might also be required in accordance with the requirements of a particular application, machine, underlying capabilities/interface, etc.

Conventionally viewed, the OE Find People window serves as a support function for a main” New Message window (as is often the case with GUI-based interfacing), enabling a user to enter search criteria, list corresponding contacts from an address book and then select listed contacts as addressees. A user is expected to know of such functional subdivisions and to utilize respective sub-window windows functions accordingly, returning to the main window as needed.

The above distillations and task identification iterations, however, suggested a class of addressing tasks including adding, reviewing and deleting existing or new addressees. Elemental-distillations further revealed that capabilities for implementing such tasks exist in some manner within the OE Find People, Select Recipients and New Message windows (even though such use might not be intended or readily apparent). For example, each enables all three commonly provided email addressee types (i.e. To, Cc, Bcc), but only the New Message window provides for hiding Bcc addressing; the New Message window also uniquely enables all of the above task types. The New Message and Select Recipients windows further enable selected addressee viewing and deleting (despite differently displayed GUI controls), while the Find People window does not.

An overlayed window-switching method is employed using NS tool activation of underlying GUI elements to enable relatively a highly balanced and consistent user experience among all three of the above windows. That is, recitation of appropriate “addressing” voice-commands cause the display of New Message window, Select Recipients window or a combination of the Select Recipients and Find People windows. Thereafter, common voice commands are provided for all three windows.

In the individually displayed cases, voice-commands are effectuated via activation of GUI interface controls contained within the respective window. In the combined case, however, the Select Recipients window is displayed and then the Find People window is displayed in an overlayed manner to expose Select Recipients controls, including the To, Cc and Bcc lists, list control buttons (which in this case serve as labels), and bottom most Cancel and OK buttons. (NS key equivalents are used to display the windows and NS mousing commands are used to “drag” the title bars to an appropriate position.) The cursor position is then set (in accordance with the issued voice-command permutation) to a designated field within the Find People window. Lookups and recipient additions are next implemented using Find People controls; however, user additions are also reflected in the corresponding Select Recipients list (i.e. an exploited multitasking aspect of Windows).

Deletions, which are not conventionally provided from within the Find People window, are accomplished by first shifting control to the Select Recipients window (e.g. using an escape key equivalent); once there, a list corresponding with the voice-command permutation is accessed (e.g. using a keyboard equivalent) and one or more corresponding listed items are deleted (e.g. using a delete key equivalent); control is then shifted back to the Find People window and the cursor is returned to an appropriate window location. (Those skilled in the art will appreciate that various OE/NS controls might be also used to accomplish similar results in an otherwise conventional manner.)

A user can also invoke various voice-commands to exit the Find People window. A user can “close” the window (e.g. as with conventional OE and NS controls) and return to the Select Recipients window. The user can also accept or reject addressing by apparently directly using the revealed Select Recipients “OK” and “Cancel” buttons. Implementationally, the Find People window is closed (e.g. using an escape key equivalent or “close”), and the respective Select Recipients OK or Cancel button is actuated; the user is then preferably returned to the message portion of the New Message window, and optionally, to either the last cursor position or a “marked” position. Alternatively, commands are also provided (here and in the Select Recipients window) for sending the current email message, which returns to the New Message window and selects “Send.” (Note that other options can also be provided in a similar manner).

Successive iterations and testing indicated user efficiency improvements with each of the above methods both individually and in combination. Despite an expected reinforcement effect, a relatively low user efficiency was achieved during early attempts to separately optimize each window according to its GUI-based elements. Rather, efficiency improved progressively by: (1) implementing communicative commands; (2) also implementing the above overlay; (3) also implementing similar voice-commands in all three windows; (4) further applying more generically consistent commands as given below; and (5) upon repeated use of greater numbers of the three windows.

Results 1 and 2 suggest that the effect of balancing superseded its apparent conflict with prior experience using GUI-based controls, while greater consistency heightened the effect (as given by results 3 through 5). Additionally, each of the task-based voice commands, existing-interface modifications, balancing and consistency appeared to actually guide voice-command expectations, making the commands more intuitive and thus more efficiently utilized. (Even the not-represented send command of the Find People and select recipients windows quickly became almost automatic.) In retrospect, an overall user experience was also apparently achieved of telling an assistant to address an email message, to add recipients and/or delete them (e.g. given a change of mind), and to accept or ignore the changes.

Those skilled in the art will appreciate that, while some voice-interface variation might result, the above aspects are each capable of facilitating very cohesive and intuitive communicative voice-interfaces. Voice-interfaces incorporating both speech and other elements (e.g. graphical, audio, etc.) can also be effectively constructed in a generally consistent manner using even the very limited capabilities of NS and other conventional speech-tools; the use of other, preferably more capable tools and/or more integrated voice-interface/underlying application development would further improve the achievable user experience and extend such results to other applications for which current tools are insufficient.

Elemental Sufficiency

The above methods might also suggest wholly new capabilities using underlying application/ interface elements. For example, purpose-analysis suggested the desirability of making an email message more apparent by altering the color with which it is represented. Elemental-diffusion revealed no such capability, but it did reveal a “watch conversation” tool within the Outlook window whose operation also includes changing the color of displayed message items. While the limited availability of the watch conversation capability might meet user expectations for its intended existing purpose, however, the new “color-highlighting” purpose was found to be desirable and expectable within the View Messages window as well.

Window-switching was therefore used to extend watch conversation availability. When initiated in the View Message window, control is shifted to the Outlook window and its watch conversation feature is invoked; control is then returned to the View Message window. (A user can also optionally exit the Preview window as an enhancement of the new watch conversation use (e.g. “Watch conversation and Close window), thereby experientially concluding previewing of successive messages).

Balancing, consistency and other methods disclosed herein should not, however, be used indescriminantly. On the one hand, such conventional practices as providing different subsets of features in different windows and the failure to consider (let alone detect and rectify) missing complimentary features, etc. are contrary to providing an efficient voice-interface. Failure to meet user expectation not only thwarts an attempted task, but the distraction also tends to cause a break in the conversational flow of voice-commands, thereby reducing user confidence and causing more thoughtful and less intuitive continued use of the voice-interface. Such distraction also reduces the ability of interface expectation, rhythm, interface element correspondence and other factors useful in guiding user speech. On the other hand, over-use of such methods (e.g. providing all features or tasks in all instances) can also result in a waste of often limited resources. The results of distillation, testing and/or other methods should therefore be closely scrutinized. (Flow, rhythm, context and other related factors are discussed in greater detail below.)

It turns out, for example, that the above watch conversation and a further “mark messages unread” feature are the only message-identifying features that are provided in the OE Outlook window but not the Preview window. Distillation and testing indicated that a user would not likely expect the ability to mark a message unread while reading it. (A user might, however, expect such ability to do so after reading the previewed message while, for example, switching to another message, initiating tasks outside previewing, etc.) The expectability of the watch conversation feature within the Preview window for its intended existing use was also found to be low. However, a user expectation well might arise where color-highlighting is provided or where the watch conversation is used for this purpose. Care should therefore be taken to assure that expected features and/or controls (e.g. scrollbar operation, movement, etc.) are provided subject to such methods and/or further testing.

It should also be noted that not all revealed balancing, consistency or capability problems can be clearly resolved. For example, while the above email addressing might be better provided by combining two or even all three of the above windows, both OE and NS currently fail to provide the capability to do so.

Distillation also suggested wholly new features that exceeded existing application, interface and/or speech-program capabilities. For example, purpose distillation indicated the desirability of a mechanism for labeling received messages according to a recipient's determination of their static or ongoing value. Elemental-diffusion later revealed that, while promising, the OE “priority” capability merely enables a sender to attach an urgency stamp to a new outgoing email message (i.e. alerting the recipient that the email is high, normal or low priority). The new feature might be added and the underlying capability implemented, for example, as with highlighting capabilities; feedback might further comprise a number, bar and/or varying colors to indicate default and/or recipient determined priorities. Unfortunately, such addition was preempted by the unavailability of tools sufficient for appropriately modifying the underlying application capabilities and interface.

A further particularly significant NS limitation affecting the conversational experience of a voice-interface is the requirement that all command wording must be predetermined. In some cases, this limitation was transcended (see below). However, it remains problematic with regard to aspects of editing and with other voice-commands affecting items that are typically randomly labeled or subject to less predefinable user modification (e.g. message/contact folder names, contacts, defaults, etc.). Solutions such as providing within commands variable-lists including likely items or adding alphanumeric prefixes to names (e.g. folder names) have proven successful in some cases. Ultimately, however, such solutions have certain disadvantages. For example, it remains possible that a user folder name might differ from those listed; longer lists can also impact performance. Current recognition problems with regard to spoken letters can also be “cured” by command specificity; however, user conformance requisites (e.g. by adding such prefixes to folder names) are contrary to the efficiency otherwise gained by having the machine conform to a user's task requisites. This is particularly unfortunate since integration of pre-determined and variable information within the same command can be implemented using parsing and/or other conventional methods.

Generic Diffusion

Efficiency can also be improved by further analyzing identified elements (e.g. tasks) for more generically applicable aspects and then refining identified tasks accordingly. This method can include further distilling existing purposes and/or tasks on a more generic basis (e.g. in accordance with other application implementations and/or application types). It can also include determining and exploiting purpose, task and/or functional commonalities on more generic bases, among other possibilities.

A more generic review and testing of earlier distillations and comparisons, for example, confirmed that conventional data and tool selection is rarely an efficiently used feature of voice-interfacing. Among the few exceptions are those that relate to the familiarity or nearly global application of such features. That is, an experienced conventional interface user might expect and attempt to select items or perform other such non-task functions if a more voice-interface oriented command is unknown or a disruption occurs; such conventional voice-commands are therefore preferably included at present. Another identified exception is where an underlying application/interface element prevents or renders other alternatives non-intuitive. Independent selection of multiple items (e.g. where such items are discontinuously positioned) was further identified as an appropriate task (see below).

As a further example, a conventional view would suggest that the following all provide unique emailing capabilities and each is therefore conventionally treated as such: highlighting new email messages, managing contacts, finding related existing messages, addressing, message inserts (e.g. attachments) and the like. It is found, however, that they can also be more generically viewed together as relating to handling groupings of things (which was eventually finally characterized as a conversational context).

In this generic sense, the particular tools and affected data items become merely replaceable “objects” of voice-commands which function in a similar manner as with even apparently different features of seemingly disparate applications. For example, in a given instance or context, highlighting one of many emails can be viewed in a similar manner as filling multiple spreadsheet cells, aligning graphical objects, synchronizing audio segments, etc. While seemingly contrived (and perhaps so), voice-commands formed in accordance with such commonalities are found to be more intuitive, more readily recalled and thus more effectively utilized.

A generic review also provides a mechanism for identifying existing elements that, while found inapplicable to efficient voice-interfacing in their present form or as currently used, might nevertheless be utilized in a new, more efficient manner. For example, displayed GUI labels and objects will likely impact user expectation. Similarly, while not yet in widespread use, existing speech-program verbiage and other constructs will likely affect user expectations; some are also likely well-matched for more accurate recognition by a corresponding speech recognition engine. However, many such elements can be modified with regard to how and/or when they are utilized. Using such methods, elements can be used in a more efficient manner consistent with tasks and/or other conversational aspects.

3. Determining Basic Tasks and Task Permutations;

While the discussion has thus far focused more on statically determinable interface aspects, voice-interfacing according to embodiments of the invention also enables speech to be utilized in a continuously variable, yet predictable and exploitable manner. That is, a user experience can be provided in which verbiage progresses smoothly, intuitively and thus more efficiently through voice-commands, voice-command combinations and even procedures involving multiple voice-command combinations. Among other advantages, a user can readily express varying tasks merely by altering the way in which a voice-command is verbalized.

A further analysis is therefore preferably conducted to better determine relationships among identified tasks. That is, relationships should be noted even where the functional steps invoked as a result of performing tasks (by reciting voice-commands) might include tools and/or data that is otherwise segmented by existing application capabilities or interface sub-divisions. A task that represents a basic form of a group of tasks affecting the same or very similar user objectives (“basic tasks”) should be identified separately from those that essentially add specificity or express alternatives (“task permutations”). More commonly desirable forms of a task should also be noted as “potential basic tasks”, and the verbiage used in describing various tasks during the analysis should be retained (e.g. for later comparison with any corresponding tool labels that might already be defined by other application embodiments, a design, an underlying interface, etc.).

Such a review and identification process not only facilitates creation of more efficient dynamically variable voice-commands, but also provides an intuitive way to organize and present voice-commands to a user, and for a user to memorize (if needed), recall and utilize voice-commands. (Such analyses should also be used as a mechanism to identify further tasks that can then be integrated via successive iterations.)

As an example, a user conventionally invokes GUI controls to enter the OE Find Messages window and, once inside, uses its unique form and message extraction capabilities essentially independently of other OE functions. Within the Find Messages window, a user enters extraction criteria (i.e. to, from, subject, message-text), selects message aspects (i.e. attachments, flagged, dates sent/received) and clicks on a find messages button to display messages that conform to the criteria and aspects.

A more dynamic conversationally-oriented analysis, however, revealed that while disjunct existing message review might be desirable, the need to find such messages might also arise during the course of flagging, previewing and otherwise handling particularly newly received messages. That is, an appropriate voice-command structure and verbiage can increase user efficiency by creating a continuity that extends the process of handling new messages to and within the process of finding existing ones (e.g. enabling a user to consider what he and someone else “already discussed”). Surprisingly, the resulting OE voice-interface appeared to raise an expectation that such features might exist. (In a similar manner, the otherwise non-OE features of using text-to-speech to scan or read back messages or message headers also were apparently rendered more intuitive and expectable.)

Several tasks were identified with regard to finding existing messages, such as flagged messages, messages with attachments, messages to and/or from different users, the date or time period within which messages were received, etc. Of these, finding messages from a named individual was hindered by the above noted inability of NS (in its current form) to include non-predetermined elements within voice commands; OE also failed to provide even raw capabilities for conducting efficient name-based lookups (although all elements of messages might be utilized in a newer conversational email application). Finding messages relating to an exchange between a designated sender and recipient was further prohibited by the Find Messages window. While such additional capabilities as finding prior exchanged messages would be desirable and could be implemented (e.g. by enabling a logical “or” to be applied among the criteria and aspects) OE and NS are again currently insufficient for such purposes. Interestingly, the most likely utilized remaining alternative of finding messages from the sender of a currently designated message, which was chosen as a basic task, was not provided. This difficulty was, however, overcome by a method referred to herein as “data carrying.”

Data Carrying

Data carrying broadly refers to locating, storing and then reusing data from one location as if entered in another location. For example, reciting a “Find more messages” voice-command from within the OE Outlook window causes messages from the sender of the current message to be listed in the Find messages window. Ideally, all aspects of messages would be available from within the Outlook window, perhaps via polling (as would similarly be provided for relevant aspects of other item groups in other circumstances). However, because email addresses are unavailable in the Outlook window, control is shifted to the Preview Messages window and the sender's email address is copied (using NS mouse commands for selection and a copy keyboard equivalent). Control is then shifted to the Find Messages window (by selecting a menu item), where the copied data is pasted into the “To” field, extraneous data not included within the raw email address is removed and the “Find” button is actuated. (The Find more messages command is also implemented in a similar manner from within Preview window, but without data carrying).

Permutations of the Find more messages commands are similarly implemented. In this case, speaking a command that also includes criteria and/or message aspects results in the same being either deposited or used in selecting available options within the Find Messages window. For example, flagged messages and/or messages with attachments permutations can be reflected by selecting these attribute options; messages to or from a recipient can further be reflected by copying and pasting of appropriate criteria into respective Find Messages fields. Assuming that modifications such as those given above are implemented, exchanges can also be reflected by copying sender and recipient data, and then pasting the data to the appropriate to and from (or modified) fields, and so on. (Similar carrying of data from the OE Preview window to the Find Messages window are also used from within the Find Messages window and the same and similar voice commands are provided.)

Using Non-Speech Elements

The Find more messages features also illustrates how non-speech elements can be used in conjunction with voice-commands to guide user speech, add continuity and advance user efforts. Experientially, a user working in the Outlook window and speaking such a command is non-disruptively switched to the Find Messages window. In one sense, such commands automatically provide data entry, selection and listing operations. In another sense, however, such commands also reveal the window, identify its component parts and demonstrate its use. This apparently also reinforces user confidence and suggests the use of similar commands to produce similar desirable results (e.g. in comparing prior messages to and from a correspondent on different subjects, flagged and not flagged, etc.).

Context

It should be noted that while conversational context is preferably ultimately determined in accordance with voice-command and voice-interface construction, indicators of context can also become apparent during the above iterations. For example, OE's Find Messages, Find People, Select Recipients, New Messages and Outlook windows provide different functionalities and employ different tools, display configurations, etc., and—from a conventional perspective—they are each quite unique, as is the conventional user experience of each one. However, a (somewhat purposeful) review of the tasks identified should reveal certain commonalities that are not readily attributable to basic tasks and task permutation distinctions. For example, all can be viewed as containing lists whose contents are desirably parsed and manipulated by a user; even the addressees, attachments and—to some degree—the subject and message contents can be construed as lists. Such lists can also be more generically viewed as groups of things for which related voice-command aspects at least might be desirable, abet with regard to somewhat different or differently referenced tools and/or data types. Such indications, however contrived at this point and subject to modification during command construction, should also be noted (as should other relationships that might become apparent).

4. Constructing Command Structures and Verbiage for Basic Tasks and Task Permutations in Accordance with Context, Continuity, Rhythm and Other Conversational Factors; and

Voice-commands can be formed at various stages of application analysis using the above and/or other methods to define tasks and/or other raw conversationally-oriented elements. Those produced in accordance with the above have, however, been found to provide especially high user efficiency using only a minimal number of voice-commands.

Voice-commands are formed such that tasks tending to be desirably effectuated within and between determined contexts can be effectuated with an expectable degree of variable experiential continuity. Such continuity is more preferably provided by selecting voice command structures enabling contextually related tasks to be verbalized in a consistent conversational manner, and selecting verbiage enabling continuous and rhythmically consistent or complimentary command recitation.

More specifically, it is found that structure, verbiage, rhythmic flow and other conversational aspects (or “factors”) of voice-commands can be used to facilitate voice-command intuitiveness and ease-of-use. Contextually rhythmically consistent verbiage is preferably selected as tending to suggest the same or even varying verbiage in related commands and contexts; inter-contextual continuity (e.g. continuous grammatical forms, flow, etc.) is also found to increase intuitiveness. Consistent structures—particularly within a context—further tend to render even apparently disparate tasks, functionalities and verbiage more intuitive. For example, a later command that is structured in a consistent manner with an earlier command will tend to be more intuitive even if the later functionality, task achieved, verbiage and/or other factors appear different. A consistent structure is also useful in exploiting the natural tendency of users to mentally and verbally group things together. Thus, even more complex voice—command variations (e.g. comprising many elements) can be provided in a more expectable manner while minimizing disruption of rhythm, flow and/or other conversational factors.

Sub-contexts are also found useful in further refining the conversational nature of voice-commands. For example, a more general context of handling groups of items (e.g. lists) can be viewed as including the sub-context of progressing through the group and the sub-context of disrupting such progress (e.g. by pausing, shifting contexts, etc.). As noted earlier, when disrupted, a user will often tend to rely more on other interface elements (e.g. displayed titles) and/or his experience (e.g. NS mouse commands). Thus, while a structurally and rhythmically consistent command might suffice for a given task as a user progresses through a list, also including a conventionally oriented voice-command is often desirable where he might pause. (A common structure populated with verbiage alternatives is typically provided in the OE voice-interface at other likely points of disruption, since specific user command choices from among likely command candidates are less clear at such points.) Command alternatives are also more likely desirable where more than one contextually and/or rhythmically consistent voice command might apply. For example, conducting criteria-based data extraction was identified as a distinct context; however working with (and particularly, within) a resulting listing of corresponding items tended to impose a grouped item context. A user might also tend to recite command elements in more than one order or it might be useful to guide a user into doing so (e.g. to suggest later tasks, commands, contexts, etc.). Certain commands are found to be “reversible”; that is, likely user recitations might include a subset of the same or similar verbiage (typically compounded tasks) in more than one order. Where this occurs, providing both variants can serve as an accommodation and/or a mechanism for transitioning between preceding and successive command characteristics (e.g. “Make the first and second columns <column-title 1> and <column-title2> “versus “Make <column-title 1> and <column-title2> the first and second columns”). Among other examples, sufficiently likely or attempted alternatives are also typically included among OE voice-interface commands.

Care should be exercised, however, not to create a new user expectation that is not fulfilled, addressed (e.g. using a synthesized comment) or resolved (e.g. by recognizing the command but taking no responsive action) in applicable instances. (More advanced tools might further provide for user-modifiable commands via defaults, modification, selection, artificial intelligence, etc. on a machine and/or per-user basis, thereby enabling such expectations to be better anticipated and thus more likely fulfilled.) Communicative factors also appear to be heightened and greater efficiency enabled by a less interactively conversational interface based on “telling an assistant what to do” (hereinafter “instructional conversation”). The OE voice-interface, for example, illustrates how such a system of commands can be used to create an unobtrusive yet more effective awareness that commands are being used to effectuate control, and in a particular way. It also demonstrates how such effectiveness can more efficiently achieved using (and despite) such factors as a PC, aging operating system, directed application, OE and NS. Among other advantages, a user will further tend to think and speak in a more predictably and guideably structured and verbalized manner as compared with other potential systems. Further capabilities provided by more capable machines, tools and other factors will likely enhance a user experience to an even greater extent for other forms of conversational interfacing, and even more so for instructional conversation.

Instructional conversation also provides a more uninterrupted, reinforceable and self-reinforcing environment than a more interactive variant. Consider, for example, a user progressing through a list of items using voice commands consistent with the conversational factors already noted. Using instructional conversation, speaking each voice-command effectively reinforces ongoing continuity, flow and rhythm, such that the user will tend to think of and speak even varying voice-commands more and more quickly. Successive tasks can also be supported in a more reliably anticipated manner, for example, by more accurately attuning capability/interface elements, machine characteristics, translation, further processing and/or other local, connectivity, transmission and/or remote factors. Such factors can further be more reliably provided with regard to pausing (see above), and efficiency can be further increased. Contextual balancing and consistency can also be effectuated more easily due to the reduced variability as compared with normal conversation (e.g. with less interruption and potential alternative command paths).

Root Commands and Command Enhancements

Voice-commands are preferably formed in accordance with the above analyses as comprising a root-command and an optional enhancement-portion. The root-command most often corresponds with a basic task, and most often discretely comprises at least one process and one or more designated objects of that process. A simple root-command might, for example, roughly correspond with two or more conventional commands, but with the process-task order reversed for facilitating better conversational flow (e.g. “Send email” versus “Select email” followed by “Click send”). Further voice-commands might correspond with conventional commands only with respect to speech-tool invocation of conventional controls (as with NS), corresponding results, or not at all (e.g. using other than conventional control invocation). Command enhancements most often correspond with permutations of the basic task; however, they can also include elements normally included within the basic command or a more definitive statement of the basic task, among other possibilities.

For example, the above discussed “Find more messages” command comprises a root command including a single process (i.e. find more), a single object (i.e. messages like the one currently designated) and a contextually presumed enhancement of “from the sender.” While no conventional command corresponds in this case, the generally imposed convention of data then process specification is reversed and integrated among other command elements. Enhancements within and following the root portion, for example can result in voice-commands such as: “Find more flagged messages”; “Find more messages from recipient”; “Find more flagged messages to recipient”; “Find more flagged messages with attachments” and “Find more messages from sender”. While the last of these merely reiterates root-command functionality, it was found to maintain consistency with permutations such as “to sender”, “from recipients” and “to recipients”. (Such commands can, for example, be populated with verbiage by: listing task permutations; aligning permutation verbiage possibilities in accordance with the command structure; and selecting those options or further variants that best comply with conversational factors and/or testing results.)

Voice-command verbiage can be derived from various sources, including the above analyses, underlying application/interface, functional/generic equivalents, etc. Since a user will tend to say what he otherwise senses, particularly key words of displayed labels are often utilized where appropriate to an identified task. Hidden items (e.g. menus) might also be prominent, though typically to a much lesser extent. Even when used, however, the grammatical form of the key word should be adjusted as needed in accordance with communicative factors (e.g. command rhythm, flow, pronunciation, etc.). The number, ordering, rhythm and mental/verbal grouping of words ultimately imposed should also be adjusted as needed to avoid likely conflicts with concurrent dictation, and to guide user expectation as to related commands; often, identified task verbiage will further indicate appropriate command verbiage, alternatives and/or augmentations.

Voice-Command Alternatives

Attention should also be given to contextual and implementational factors in forming voice-command alternatives. For example, while single word commands (e.g. “yes” or “no”) might be appropriate in one instance (e.g. a GUI dialogue box), structural and rhythmic considerations might suggest a more consistently structured and populated command—perhaps with a single word command serving as an alternative. (As a general matter, testing of unusual command forms typically indicates that more consistent command alternatives should also be included.) A particular wording might be used in different instances, any of which might impact user expectation, dictation conflicts (unless remedied by emerging speech-program improvements) and/or difficulty of pronunciation. Mental/verbal grouping is especially useful in this respect. That is, testing should be used—particularly where potential conflict, experience, pronunciation and/or other factors are prohibitive—to determine how users will tend to mentally and/or verbally group words together. Very often such grouping is apparently subconsciously adjusted as needed to resolve such factors in a manner that is revealed during testing and that can be guided by the use of appropriate structure, rhythm and other conversational factors.

For example, the above “Find more messages” basic command happens to represent a correspondence between an identified task and a menu item process plus the additional word “more” (or alternatively, “other”). Contrastingly, a “mark unread” menu item was found to be useful (in the form “mark next message read”) only as an alternative or fallback in the case of a distraction. A different message-handling wording of having “Read” one or more messages was instead found to be rhythmically compatible when progressing down a message list (along with a corresponding “Didn 't read” command portion). The OE voice-interface, however, actually uses the word “red” due to apparent NS speech engine confusion between having “read” a message and telling the text-to-speech engine to now “read” a message. (The use of homonyms and other such alternatives should also be considered in resolving other aspects of command formation.)

The following constructs have been found particularly useful with regard to the structure, verbiage and implementational characteristics of voice-commands. (For clarity, each of the following methods is titled and discussed according to continuing examples of how it can be used to designate local/remote interface constructs, data, tools, resources and/or other items.)

Designating Items

Designation of items, while rarely an independent task, is nevertheless an integral aspect of many tasks and constructs used to facilitate speech and guide user expectation with respect to structure, verbiage and subsequent command utilization. Existing speech-program mouse-type control was especially problematic in this regard, since alteration of often non-ideal but familiar verbiage might well conflict with or confuse user expectation. However, more efficient handling of designation can be implemented in a manner that incorporates prominent existing verbiage in different but non-confusing ways that are consistent with communicative factors.

Relatively-Positioned Items

Designation of “relatively-positioned items” can, for example, be utilized in a highly efficient manner in conjunction with items that can be viewed as being grouped or otherwise linked. The extent to which such methods are applicable in a given instance will depend on the manner and extent to which reference items are identifiable (as well as the impact on user expectation).

Inter-Item Designation

Inter-item designation, for example, can be used where a reference item can be distinguished as a user progresses through an identifiable group of items. In this case, items are preferably designated according to their position relative to a movable or transferable current item reference and voice-command verbiage is selected accordingly. That is, verbiage is included for designating the current item as well as one or more other relatively positioned items both alone and in conjunction with the current item. More preferably, verbiage is selected for designating at least adjacently positioned items including: (1) each of the preceding, current and following items, (2) each of more than one preceding and more than one following items, and (3) each of the current item plus one or more following items and (to a lesser extent) the current item plus one or more preceding items. Such verbiage more preferably references the current plus preceding and current plus following items of case (3) in a distinctively different way from cases (1)and(2).

Items are preferably indicated using ordinary verbiage adopted by an underlying speech-program where such verbiage is applicable. Using NS as an example, words such as “last” and “next” can be used in a consistent sense to indicate adjacently preceding and following items. While otherwise used within NS to apparently randomly used to indicate an already selected item and less conversationally desirable than other possibilities, the word “that” can provide familiarity; it is therefore used as a designation alternative for a current item. Finally, conversational consistency should be maintained for current item plus one or more adjacent preceding or following items; therefore, respective verbiage such as “these last” and “these” (or “these next”) can be used. (The term “these” can also be used to indicate other multiple item selections, such as those discussed below.)

Distinctive verbiage for combined designations is useful for several reasons, three of which are particularly relevant here. First, a distinctive designation avoids potential conflicts with other voice commands in other instances. Second, distinctive verbiage provides a clear indicator that more than one item has been selected. Thus, such designations can be more easily trapped when utilizing underlying capabilities that are intended to support only one item. Third, the unique designations provide a distinctive class of selected items. For example, the two word format given above or simply the word “these” can provide a clear indication of a current item and at least one preceding or following item. (Note that mental/verbal grouping is found to combine the above designations, such that an experience of rhythmic continuity and consistent structure is maintained despite varying one and two word combinations.)

Efficient communicative voice-commands employing inter-item designation can be formed in accordance with structures such as:

<process> <designation> <optional number of items>.

Thus, for example, flagging a single item in the OE Outlook window or Find Messages message-list can be designated using the commands “flag last”, “flag that” or “flag next”; handling multiple items can also be designated using consistent and rhythmically compatibly perceived commands, such as “flag last 3” or “flag next 3.” Finally, the current plus last and current plus next items can be designated using commands such as “flag these last 3”, “red these 3”, “didn't read these next 3”. Notice how mental and verbal grouping is utilized to maintain rhythmic consistency within and among the command sets (e.g. flag, red and didn't read; next, next-N and these next-N; etc.).

Feature-Based Designation

Relative designation can also be utilized where no reference item designation is reliably provided for effectuating an intended task. A “feature-based designation,” for example, can be used to designate one or more items with reference to a bounding or other distinguishable feature.

The OE voice-interface employs feature-based designation in instances such as with the Find People window (“FPw”), where a (highlighted) current item appears to exist but is actually reset following entry of an addressee. Two structures and new verbiage are utilized (in accordance with testing) to produce the above-discussed addition and deletion of addressees. More specifically, the structure

<process> <nth> <optional connector> <optional nth>,

is used for adding one or more addressees, wherein “nth” indicates a position relative to the beginning of a list, all items or the last item in a list, producing commands such as “To 1st”; “Cc 2nd and 3rd”; and “Bce 4th through last.” The structure

<process> <discrete or implied nth> <group designation>

is further used for deletion (or undoing) one or more addressees in such commands as “Delete To” (which implies the last addressee added to the To field of Find People). It is also used with permutations such as “Delete last To”, “Undo last 3 Cc” for greater consistency with other compatibly metered and/or worded voice-commands. (The second structure and verbiage also represent somewhat unique instances of intermittent-designation as discussed below.) Among other aspects of the above feature-based designation example is the use of “nth” terminology. Unlike alphanumerics, which might also be used, nth terminology clearly indicates a positional designation without requiring additional alphanumeric item labeling (which is typically absent in conventional GUI interfaces). Such verbiage also adds continuity and avoids conflict with the displayed title “To” (e.g. “To 2nd” and “Delete 2^{nd} Copy” versus “To 2” and “Delete 2 Copy”. It further provides an alternative to alphanumerics that is—in this case—more consistent with conversational factors. However, the overhead involved in conversion to and from numerical equivalents can be substantial. Therefore, it would be desirable to add conversion and processing tools (e.g. 4^{th} plus 1=5^{th}; <5^{th}; etc.) to avoid the considerable overhead of separately coded conversions.

Combinations

Reference-feature and reference-item methods can also be combined with each other as well as with other designation methods. Generally, available feature-references are more applicable to smaller number of elements (where the distraction of user counting is avoided), while available item-references are useful with larger numbers of items (e.g. assuming also that no item-numbering is provided). However, combining the two methods can be used to avoid commands such as “move to top” and “move to bottom”, which do not of themselves provide an item handling task. A reference-item can also serve as a reference-feature (even within conventional GUIs), thereby enabling not only singularly non-adjacent reference-feature selection (e.g. “1^{st}, 3^{rd} and 4^{th}”; “1^{st} and 3^{rd} through 5^{th}”; etc.), but also more consistent combined bi-directional designations (e.g. “2^{nd} before last”; 3^{rd} after next; etc.).

Directed Repositioning

Having established the above or other reliable designation bases, further efficiency can also be gained through the use of directed repositioning methods. Directed repositioning facilitates user progress by adjusting reference-item to an appropriate item, items or item aspect(s) following issuance of a command. Preferably, the newly-referenced item is an item that will likely be the object of a next command within the same context or an appropriate new context if such a next command is given.

The OE voice-interface, for example, conducts predictive repositioning and designates new messages within the OE Outlook window Message list as follows. It is presumed that a user will handle successive grouped items, and particularly new messages, from an apparent list-beginning toward a list-end (e.g. from top to bottom); however, a user might also return to a prior message, handle the same message(s) in more than one way or pause/disrupt message handling and perhaps return to it again later. Accordingly, with few exceptions, following handling of prior messages, the previous current message is again (automatically) designated as the new current message, and otherwise the message immediately following a last-handled message (i.e. furthest down a list) is designated as the new current message.

Exceptions to the above “automatic designations” include message deletion and opening. Where one or more messages is deleted, the deleted message(s) is/are automatically removed from the list by OE and the following message (which fills the position occupied by the last deleted message) is thus automatically designated without performing any additional steps. Note that in other cases where deleted item “marking” is employed, a message following a last marked message would preferably be designated, thereby retaining consistency). Where successive messages are opened for review, a user tends to reserve manipulation of the last message until after it is again closed (rather than manipulating it during review). Therefore, no further designation is automatically made by the interface and the opened message is designated upon closing. (Assuming that a user would modify such a message during review, the next message would preferably instead be designated.) Automatic/user designation alternatives would also be more preferably provided in any one or more of the above cases where more capable tools might be used.

The above predictive designation method is found to be particularly efficient. For example, a user is continually moved forward by not only the above communicative factors, but also an automatic (e.g. programmatic) advancement through successive grouped items. “Next” and “last” commands can further be used in succession to affect the same or a subset of designated items in more than one way. (E.g. a user can flag and watch a following series of 3 messages using “Flag last 3” plus “watch last 3” or “flag next 3” plus “watch last 3”.) A user can also use similar verbiage in succession, can return to where he “left off” (assuming this position is preserved), and is provided with an intuitive and consistent expectation as to which item is designated at any given time. Other potential repositioning, such as enabling a continuous series of “Next” commands, were less favored as failing to provide easy multiple data modifications and in “losing momentum” (apparently due to the monotony and increasing difficulty of speaking repeated designations).

It should be noted, however, that features beyond current NS capabilities were also considered desirable in this case as well. For example, while a user can “move” back and forth through a grouping or to the top or bottom, desirable automatic/user selectable changes in the direction of progression through a list cannot currently be provided in a sufficiently intuitive manner. The inability of NS to provide “locally global commands” (i.e. affecting only a programmer-designated application-program or program sub-part) also often results in considerable unnecesary and resource-wasting replication of voice-commands, among other examples.

Intermittent Context

The efficiency already demonstrated by the above structure, verbiage and other voice-command elements can also be further improved by such methods as external control, simple and complex paging and other intermittent-scenario (or “intermittent context”). Broadly stated, such methods enable a user performing tasks with respect to particular items, to affect remote controls, item references and/or item(s) handling; such effects can further be achieved in accordance with the above conversational factors, preferably by enabling direct reference to remote designations. Stated alternatively, a user working with a first “selection” of one or more items can also affect a different (foreign or “external”) selection of one or more items.

Additionally, while such methods enable various items to be treated as within a current context (i.e. such that other items are handled “intermittently” at any given time), the most commonly handled items are preferably also identifiable as a sort of “default” to which specialized alternative structure/verbiage can also be applied (e.g. thereby enabling even greater command efficiency in more common contexts). Opportunities for applying such methods are limited by conventional interfacing constructs, such as current window/tool segmentation; however, alternative constructs and interfaces will facilitate a wide variety of efficiency improvement opportunities. (Note that the terms “intermittent” or “intermittently” relate to a shift in user focus rather than a particular number of voice-commands that might be recited.) For clarity sake, let us consider a simple OE-based example of the Outlook Window, such that an existing interface is provided in which two control/data scenarios are more clearly presented with regard to similar data resources and within a single window. More specifically, the Outlook window not only displays message items, but is also capable of optionally displaying message folders or a contact list within an added pane. Assume that the message folder pane is displayed and ignore any GUI-construct based segmentation, considering the interface instead as a contiguous whole (e.g. as in a windowless multi-dimensional space that might alternatively, and perhaps more preferably, utilized).

External Control and Paging

“External control,” as used herein, provides for manipulating displayed or not-displayed controls associated with a foreign item intermittently while handling a current item or items. For example, while handling messages, a user might want to scroll up or down the folders list to reveal potentially applicable folders (e.g. in which to move a message). “Simple paging,” as used herein, further provides for affecting one or more foreign items intermittently while handling a current item or items. For example, a user might want to further open a folder that is displayed as a result of the above external control. “Complex paging,” as used herein, still further provides for designating and/or affecting one new item with reference to another new item while handling a current item or items. For example, a user affecting a message within one folder might want to similarly affect a further message in another folder. In other cases, complex paging might also be used as a type of conversational relative addressing, communicative linking, etc. among a variety of similar or dissimilar items, types, applications, etc.

The above association of such methods might again appear somewhat contrived—particularly since subsets of each can be utilized independently, and consistency might not be readily apparent. However, the consistency with which such capabilities are experienced is apparently as or more important a factor in rendering them intuitive as any particular results that might be achieved. That is, once a user is aware of one such capability within an appropriate interface, an expectation appears to arise that the others will also be provided within that same interface; further, a user who intuitively utilizes a basic command can also intuitively use permutations and the various intermittent-context methods.

For example, intermittent-context methods can be used in a consistent manner in such diverse OE instances as within the Find Messages, Find People or Address Book windows (e.g. to affect listed contacts/messages while entering extraction criteria or visa versa). They can also be used within the New Message window for adding and deleting addressees or attachments while dictating, for modifying message data while dictating, for modifying addressees and/or attachments, etc. They can further be used when Finding text (e.g. repositioning the cursor or selecting a different text selection without “leaving” a find-text window); to affect data within a different window or on a different machine altogether; etc. As with the above new designations and other methods disclosed herein, such methods are not limited to a particular window-element, interface type, machine or other such constraints.

Among other methods, intermittent-context can be effectuated by adding an implied or discrete new item reference to existing voice-command structures for designating new items and/or item groups. For example, intermittent-context methods are typically used in the OE voice-interface in conjunction with the above relative-positioning according to the structure

<process> <(local) designation> <optional number of items><(extended) designation>,

wherein the local designation is preferably the same as the above non-intermittent designation; and the extended designation is an item/group reference. An extended designation can, however, also be positioned elsewhere in accordance with communicative factors (as with permutations).

Verbiage is further preferably the same or similar to that used in non-intermittent voice-commands, subject to new voice-commands and communicative factors that might apply. Thus, the OE voice-interface typically references items within the Outlook window message list and folder list respectively using “messages” and “folders”. (Other groups are also identified by a simple descriptive name in accordance with communicative factors.)

Note that the contact, addressee and other primarily used groups can also be designated alternatively as “list” in applicable instances within the OE voice-interface (See command list). Apparently, such an alternative is useful where a longer series of voice-commands is invoked and—for various reasons—the user cannot immediately and intuitively recall a more specific current designation (potentially resulting in a break in the command flow). While more generic external references might also be provided, a user most often appears to mentally separate intermittent contexts and to better and more intuitively recall such references. Excluding generic external references also provides a consistent specificity where, for example, references to other underlying applications and/or other resident or remotely located resources (e.g. via wired/wireless connections to other machines).

Consistency can also be established in other ways. For example, both implied and discrete references are supported in nearly all cases (i.e. unless indicated otherwise during ongoing testing or in accordance with conversational factors). Thus, the extended-designation can also serve as a bridge. That is, reciting a voice-command within a target group that does or does not include the extended-designation will produce the same functionality; this not only avoids potential mistaken commands, but also enables one form to be used for all such designations regardless of the target. Directed repositioning for the same process or process type also preferably produces the same repositioning for corresponding intermittent and non-intermittent contexts, thereby providing a consistent expected resulting repositioning.

Examples of intermittent-context commands within the above Outlook window scenario include the following (presuming a user is working within the messages list). External control commands include “Scroll down 3 folders” (versus “scroll down 3,” as can be alternatively used while within the folders list), “move up 5 folders”, etc. Simple paging examples include “Delete next folder”, “Open next folder”, “Switch to Expenses folder”, etc. (as compared with “Delete next”; “Open next unread message”; etc.). Assuming that a user desires to view a message contained within a different “Expenses” folder, complex paging commands might include “Switch to Expenses messages” or “Open next Expenses message”), among others.

The last command, however, is not currently implemented in the OE voice-interface, since OE does not retain appropriate positioning when a folder is exited and in all or most other cases, as would be preferred. (Note how the verbiage utilized is the same or similar to that without intermittent-contexts to the extent that this is possible, meets communicative factors and provides an intuitive control capability despite the more complex tasks enabled.) Also, since commands cannot currently be associated to a sub-window region as is desirable (see above), some folder-list commands currently require an explicit extended-designation; if not recited, then an available equivalent message command will unfortunately be executed in the present OE voice-interface.

Switching Considerations

NS use of OE controls and OE inconsistencies with regard to controls useful in referencing were also problematic with regard to implementation. For example, the Folders pane, New messages fields and window labeling all required new referencing capabilities in order to provide a reliable and consistent user experience. The folders pane and message list, for example, provide no controls with which they can be selected; therefore, an NS mouse-click command is used within a blank region of the folders pane; a folder is then selected or the folders pane is used as a reference-indicator to switch to the message list. The New Messages window further not only lacks controls for selecting fields, but also adds and removes an attachment field as needed. It might also be desirable to return to a last cursor position in the message region (which, unlike the above noted instances, is retained by OE where no further repositioning is conducted). Therefore NS mouse-clicks are used within the “To” field and the To field is then used as a reference indicator to select other fields (e.g. by tabbing or shift-tabbing between fields as needed). Additionally, a message marking method is also provided for enabling referencing of positions other than the exited cursor position. (A “Return” or “And return” can be used to cause the mark to be found and deleted where a command causing intermittent-determination and automatic return is unavailable or an alternative is recited.)

Ideally, however, OE and/or NS would be modified. For example, presuming current NS GUI-control, a more straight forward solution would be to actively label all fields in all application programs. More preferably, however, modifiable tags would be provided for use in referencing various items individually, as linked and/or as part of a determinable grouping. Such more direct and flexible referencing would further facilitate other related capabilities using 3-dimensional and other more flexible and multimedia-capable environments as compared with traditional windowing. (For example, simple or object-oriented tags might be used to provide direct referencing and/or variable virtually configurable referencing.)

Prefix Labeling and “Re windows”

Window labels also posed problems with regard to intermittent-context and various other OE voice-interface implementational elements. As noted earlier, NS-tools are currently attachable to windows; therefore, creating a communicative interface required a coordination of communication-based voice-commands with disjointed windows. Additionally, window labels are inconsistent with not only each other, but also with reasonable pronunciation and intuitive linking among communicative other usability factors. The OE voice-interface implementation therefore provides for opening and cycling through known windows where the use of multiple or selectable windows is desirable (See example below).

The OE New Messages and Preview windows are further titled by OE during message creation to match the contents of the new message Subject field. Thus, the complete window title will match the user's subject, or include an initial “re:” or “fw:” for new, reply or forwarded messages respectively, making it difficult to apply NS commands on an ongoing basis. The OE voice-interface implementation therefore includes a new “blank” window that enables NS commands to be invoked within the Preview window for any message including two or more words with a space (or “blank”) between them. Unintended selection by NS of Blank window code (which is apparently randomly selected by NS in other circumstances) was further resolved by matching functionality between windows utilizing matching voice commands. Assuming window-based code utilization is continued, at least a speech-tool modification such that window polling for command execution in a consistent order (e.g. even alphabetically) would be a more preferable solution.

The OE voice-interface implementation also uses a window-title reference or “prefix” method for providing more efficient window-item designation and association. That is, a reference or prefix is added to a window title that is more easily pronounced and consistent with other conversational factors; the prefix can then be used to refer to a class of windows as well as (using a singular common prefix) to reduce the number of commands required using window-associated code, such as with NS.

More specifically, the OE New Messages window title is initially set for wholly new email messages as “New Messages”; upon entry of a subject and in all other cases (e.g. forward or reply messages), the window title is set as the contents of the window's Subject field. In such cases, the OE voice-interfaces currently assures a singular typographical Subject field prefix of “re:” (upon initial window entry or creation), thereby establishing the same typographical window title as a reference with which further NS commands issued within the window are associated. The OE voice-interface also assures a corresponding verbal reference of “RE”, thereby establishing this verbal reference for designating such windows via voice-commands.

Since no prefix, “re:” and “fw:” are otherwise automatically added respectively for a new message, reply or forward, the desired prefix is respectively added, left for automatic addition or replaces the existing prefix. This method recognizes that, despite differences leading up to creation of a new message (e.g. automatic addressing in a reply), remaining message formation and addressing are substantially the same in all three cases. Therefore, a single Subject element is used which does not draw question as to tampering with messages, yet provides at least a common designation and basis for attaching code. Additionally, a single designation requires only one-third of the commands that might be otherwise needed if blank, re: and fw: were each utilized. (Note however, that multiple references could be utilized in a similar manner and—given speech tools enabling instance specific commands—the reference could further be modified upon sending an email message; thus, the “re:” reference might, for example, be modified to provide one or more differing references, an “fw: reference might be restored prior to sending a message, etc.)

The above window referencing methods can also be used to extend the capability of an underlying application even where conventional interfacing and speech tools are utilized. For example, issuing a “Merge and reply to these three” command from the OE Outlook window messages list or a “Merge and reply to these three messages” from the folders list first creates a new reply message including the received current message. Thereafter, control is switched to the Outlook window and each of the two following adjacent messages are merged using window cycling. More specifically, a first merged message is opened in the Preview window, its contents are copied and the Preview window is closed, thereby switching back to the Outlook window. Control then switches to the reply message and the copied contents are pasted. The copy and paste steps are then repeated for the remaining message (also inserting a graphical separator between messages, such as a line). A similarly implemented “Merge and forward” feature is also provided.

Prefix titling can also be used to increase implementational efficiency in conjunction with commands such as merge and reply/forward, where further user interaction might be desirable. In the merge and reply case, for example, a direct-addressee is necessarily provided as the sender of the message used to create the reply; however, a user might want to add additional addressees, comments, attachments, a signature etc. before sending the message. In the forward and reply case, a user must (using the above commands) further provide a primary direct-addressee before sending the message. Replacing the subject prefix in the forwarded-message case (during initial message creation) enables the same Re-window command set to be utilized for both forwarding and replying.

Automatic Initiation/Completion

It should not, however, be concluded that a user must necessarily direct his/her attention to every message that is created and sent. Rather, the experience of working through a group of items can be enhanced even further by enabling a user to issue commands that “automatically” initiate and complete related tasks, such as completing and sending messages (particularly though not only when using voice commands). For example, an “automatic-reply” message can be populated with a determinable user reply such as “x is currently out of the office”, “the project is not completed”, etc.; the message can further be marked confidential, augmented and automatically signed and sent using even currently available tools. Using more advanced tools and/or otherwise available capabilities, a sender voice print, encryption key and/or other identification/security confirmation might further be utilized, among other possibilities.

The above Merge and reply command can also be automatically sent with an optional signature and/or other elements in a similar fashion. While selectable alternatives are not readily implemented current tools, a user can specify such options using, for example, a continuation permutation, such as “Merge and reply to that and send”; an ordinary reply can also be sent in a similar manner using, for example, “Reply to next and send.” Forwarded messages might also be “completed” by specifying a particular contact (assuming that variable and predetermined command elements can be combined in more advanced tools), or by using such methods as the below discussed special contacts. Nevertheless, assuming an otherwise traditional window-based interface exists, a more efficient manner of window designation is desirable. For programming purposes (particularly according to window-based programming constraints), a hierarchical wholly, partially or not displayed designation convention would instead be preferred. That is, a hierarchy can be established according to which voice-commands can be associated with an underlying application and successive more narrow levels of underlying application elements (e.g. windows, views, panes, fields, regions, etc.). For user feedback, intuitive linking and/or intermittent-context purposes, a selectable and/or modifiable reference would also be preferred. Sender and/or recipient indicators might be desirable but for current recognition problems with “random” data, such as names. Other similarly compatible selectable and/or modifiable references, such as date, conversation indicator, etc. might therefore be more preferably implemented at present. (Similar methods could also be utilized with segmentable interface constructs other than windows and/or —with new applications—might further support conversational factors, such as contexts, broad and narrow purposes, tasks, etc.)

Random Designation

A further designation method utilized in the OE voice-interface (and having generic applicability) is “random designation.” Unlike most other voice-command types, the primary task of random designation is merely to select items; also, as with only a small number of other instances, random designation is viewed as a sequence of multiple commands in which a first command effectuates an initial task portion that can be complete in itself or completed in one or more further task portions. More specifically, random designation is initiated by designating a first item; thereafter, further “continuation commands” are optionally utilized to setup and execute designation of further items. Once selected, the items can then be processed using the previously discussed commands (e.g. with a “these” designation).

Connecting Commands

The OE voice-interface implementation of random designation, for example, preferably incorporates the above relative-item designation command structure and verbiage with a new continuation command type having the structure

connecting term> <non-continuation intermediate or non-intermediate command>.

In this instance, the connecting term is “and”, and the resultant commands are referred to hereinafter as “And commands.” The non-continuation command portion is further typically a “select” or “move” command. Processing-based And commands (e.g. “And flag that”) might also be provided; however, a user most often tends to expect separate processing capability and a strong need for including such commands has not yet been demonstrated. (Also interesting is that while a random designation might also begin with an And select command performing in its usual manner, this possibility has not occurred during testing.)

In practice, first, an initial “Select command” is given (e.g. “Select next 3”). The select command operates to end or “cancel” any previous designation that might have been issued and designates one or more initial items (e.g. by moving a pointer and then performing a selection). Thereafter, the designation can be cancelled or continued.

The manner of cancellation further demonstrates the communicative nature of interfaces according to embodiments of the invention. For example, the designation can be cancelled by a further selection if a user so desires (and not by predetermined constraints). A user can also issue a new local command that also performs a designation to cancel a current designation (again if “Goto”) “my computer”, “drive x”, etc. A user can further designate items multi-dimensionally (e.g. “Move right 3 and down 2”) and can change listings, scroll, “Open/Close” a folder, etc. Additionally, random and other designation methods are also currently provided. However, commands that process as well as select are less intuitive (e.g. “Open folder right 3 and down 2”; “Attach file down 2 right 3”; etc.). Capabilities are also limited to otherwise essentially selecting items within a current file or folder; items also cannot be referenced by name in a single command.

Thus, several improvements would be desirable. For example, at least a displayed item numbering should be added in a simple, intermediate or complex form should be provided (e.g. respectively by item, rows and columns as with spreadsheets, or a separated folder/file hierarchy both visually and alphanumerically). Another possibility is to simply abandon aspects of the traditional approach entirely and provide a graphical file drawer, folder, sub-folder and file paradigm supported by graphical and other non-speech multimedia elements (e.g. 2-dimensionally separated indicators, a 3-dimensional environment, etc.). Using such more robust capabilities, efficiency could be greatly improved in accordance with intermittent-designation, integration of variable names and/or other methods.

Associative Designation

An “associative-designation” method further facilitates the creation of more rhythmically consistent and easily recited voice commands. Broadly stated, in a first embodiment, a class is defined for more than one item; then, when an applicable voice-command is recited, a second item within the class is designated as one corresponding to a first recited item and the recited class. (More preferably, such associative-designation is applied with regard to an item and/or item an attribute on a process basis within a conversational context.) In a second embodiment, the second item and/or item aspect is designated without explicit recitation of the recited class, among other potential embodiments.

For example, the OE voice-interface provides several mechanisms for altering the way in which the message list is displayed in the Outlook window (and Find Messages window). The first embodiment is implemented in accordance with selection of columns from among those that OE is capable of displaying. In this case, it is found that a second column can be designated by first defining a column class including more than one available columns; one of the columns included within the class can later be designated by a voice-command in which a first column and the class are explicitly recited.

More specifically, a date class is defined as including the “Sent” and “Received” columns; the Sent and Received columns are further associated with columns in which each is found to be most likely desirably displayed (i.e. the “From” and “To” columns). Voice-commands are also formed in accordance with conversational factors such that column pairs can be designated. These include “To and Date” (or “Recipient and Date”) for designating the To and Sent columns, and “From and Date” (or “Sender and Date”) for designating the From and Received columns.

As a result, a user experience includes the ability to freely create new folders into which any variety of messages to and from various contacts can be moved or copied (e.g. by customer). The user need not be concerned as to OE defaults concerning the columns that will be displayed or their ordering, since he can readily effectuate display changes. He can, for example, tell his assistant to “Replace the fourth and fifth columns with Sender and date”, and “Make the third and fourth columns recipient and date” (which is reversible as “Make recipient and date the third and fourth columns”). A user can further perform other column handling, such as displaying (or inserting), hiding or moving columns, changing column widths, etc. in a similarly consistent manner.

Implementationally, it was found that displayed column titles are not reliably selectable using current OE/NS tools, and instead, the Column window is used to designate and/or re-order columns. Thus, the above commands reference/designate columns in accordance with a combination of feature-designation and pre-determinable column-titles consistent with the Column window capabilities. More specifically, control is shifted to the Columns window. Once there, columns are “displayed or “hidden” by (starting from the top of the list) moving downward according to the recited column positions or names and selecting “display” or “hide” respectively. Positioning columns is somewhat more involved. Unfortunately, the current and desired positions of column-items are not ascertainable directly, since columns-items are deposited at the bottom of the list when hidden and no further positional references are provided by OE. However, the total number of column items is known and the final column positions are recited in the respective voice-commands. Thus, each new column can be “moved up” by the total number of columns with “extra moves” being ignored; each column is then moved downward according to the recited display position. (Width can be modified directly by altering a provided width field data value.)

Continuing with the preceding illustration, uses of the second associative-designation embodiment include column sorting. In retrospect, such use can be more easily viewed as a communicative application of more conventional “context-sensitivity” approaches using voice-commands. More specifically, OE provides both for selecting columns as a basis for sorting and for selecting a sort ordering as ascending or descending. Unfortunately, the multiple step procedure required for individual selection is undesirable as being inefficient, the applicability of the ordering selected by OE is often unclear and the resultant item referenced is often non-ideal for current purposes.

One solution is to provide more communicative control of individual aspects using voice-commands including “Sort messages by <designation> by <ascending or descending> “and ”Sort . . . by <ascending or descending> <column-title>” (or its reverse of “Sort <messages> by <column-title> <ascending or descending>.” In this case, the user himself resolves the above OE mis-ordering by reciting a desired ordering. However, it is possible that a user might want to continue referencing the already-designated message resulting from prior voice commands (and the OE-NS combination does not provide an efficient mechanism for returning to such message or for modifiable options); therefore, the referenced message is not altered. A further solution is, however, also provided whereby a single sort command designates a recited column and a likely expected sort order consistent with the task permutation of sorting the particular column; the command further performs sorting and then references/designates the first message. The same approach is also applicable to other processing alternatives, items other than messages within a message list and/or more specific item aspects.

A further form of associative designation that was not efficiently implementable using the NS and OE combination was the ability to consolidate messages from correspondents having different email addresses. For example, it might be desirable to “find messages” to and/or from a number of different persons according to a classification or to and/or from a correspondent having multiple or changing email address. In this case, a more appropriate method would be to provide the name, email address, a designated email, etc. as criteria according to which all corresponding messages (or some other recited voice-command permutation) might be determined. For example, all such messages might be sent, requested (in a pull-capable system) or extracted (e.g. within the OE Find Messages window).

Special-Designation

A further special designation method is similarly applicable as a current fix but is also applicable to generic current and future capabilities. Special-contact designation, for example, broadly comprises establishing pre-determinable identifiers for individuals capable of specifically identifying the individuals according to their class or function; individuals can then be associated with the identifiers and the identifiers are further utilized as name or title alternatives for designating such individuals, additional individuals or their replacements.

Perhaps the closest existing mechanism is using aliases. An alias in this respect is essentially a pseudonym created and utilized as needed by a particular user to mask his identity or provide him with his own unique alternative identity. By way of contrast, a special-contact designation more clearly identifies individuals according to an identifying type or class that is typically created ahead of time; special-contacts also apply to a given individual only so long as remains a member of the indicated classification; when his classification changes, his special-contact designation preferably no longer applies (although a different designation might apply at that point). Special-contact designations can also refer—preferably hierarchically—to groups and/or to aspects other than contact names.

In the OE voice-interface, special-contact designations are predetermined as command designations (as necessitated by NS-tools) and matching entries within the “display” fields of various OE contacts created for this purpose. Designations are primarily of the structure <designation indicator> <reference> <optional data>, and include such designations as “my secretary”, “my boss” and “my cousin” (see Partial Command list). The term “my” primarily serves 2 purposes: to distinguish the reference as relating to a special contact (e.g. versus a name or alias); and to provide grammatical flow and rhythmic consistency. The term “secretary” or “boss” distinguishes the particular designation from other types. That is, presuming the user has but one secretary or boss at any given time, whomever constitutes the current secretary or boss can be specifically designated by the reference; that person's contact and miscellaneous information can also be entered as contact information for that reference.

The reference can also indicate more than one individual (in conjunction with optional data) by exploiting OE operation apparently targeted for other purposes. First, the Display field character capacity for its intended purposes is limited, but is often sufficient for adding a name or other data (e.g. “My brother John”). Two references having the same name are also rare and can be accommodated by an additional easily voiced and recognized character, though currently requiring recognition engine training (e.g. My brother John2); in other cases, the unique instances of the same reference can also be entered without violating any OE constructs (e.g. “My brother Bob”). Further, each such reference will list properly using OE Address Book functions and corresponding voice-commands. (Preferably, the above limitations would be resolved by expanding data entry capability and enabling the definition of allowable unique entries to consider other data, such as other contact information, other information fields or a special user entered and/or user-confirmed delimiter or flag.)

Another feature enabled by the use of special-identifiers, and particularly special-contacts, is that checking can be conducted where a special-identifier is entered. Thus, where multiple entries might correspond with a recited special-identifier, the various choices can be displayed and the user can further select from the available choices (or modify entries in an appropriate manner to avoid the multiple matches). For example, OE will display multiple entries matching what it presumes is an alias. Such a feature might also further be expanded to include varying email address and/or other information (again, enabling user selection and/or modification of the entries).

Special-identifiers can also be used in unique ways in combination with other aspects of the invention. For example, the accompanying figures illustrate how permutations, connecting commands and partial/joined commands can be used to greatly increase user efficieny in creating and addressing messages. As shown, a user within the OE Outlook window (or other windows) can initiate a new email using the voice commands “Send an email” or “Send an email to.” The “Send an email” (Root) command swtiches from a current window, initiates a New Message window, enters the “Re” designation (see above) and switches to the “To” field. A user may then recite additional voice commands for addressing the email and/or performing other tasks.

Alternatively, a user can recite a “Send an email to” command (which is also a Root command) to produce other results. The word “to” is used as a further mental, verbal and programmatic connector included in all natural cases (e.g. it is not “forced” on a user, but is included singly or as an alternative in all applicable cases). Surprisingly, the connector “to” maintains an experiential continuity both directly and in an anticipatory manner, as illustrated by the remaining alternatives. (It also turns out to be used in an extremely intuitive manner for selecting each of the alternatives via inclusion or exclusion of specific verbiage types.) In a second alternative, a user can recite a “Send an email to <special-designation>” permutation, such as in sending an email to a special-contact. Here, stating the special contact performs the “Send an email” command and enters the associated addressee; upon checking the addressee entries (which would otherwise be performable automatically, but here requires a further voice-command), OE will confirm the entry as listed in the address book, provide a list of matching potential addressees from the address book or suggest alternatives and enable entry of a new contact. (Adding a particular reference to special-contacts would also increase efficiency should such features be adopted.) Again, the word “my” is generally used to indicate a special contact.

In a further alternative, a user can recite a partial command of “Send an email to the” or a joined command of “Send an email to the <folder name>”. Such commands invoke a “Send an email to” command and further switch control to the OE Select Recipients window (by virtue of the word “the”, “a” or “an”). The partial command further opens the contact folder list, thereby enabling a user to “complete the command” by reciting a folder name of which he need not have previously be aware. Surprisingly, the user anticipation created by the partial command creates an experience in which rhythmic flow (or at least flow continuity) is largely preserved. The joined command invokes a “Send an email to the” command and further selects a folder, closes the folder list and (at present) places the user at a data entry field. A user than then make a more specific selection (if needed) for listing appropriate contacts.

In a still further alternative, a user can recite the joined command “Send an email to <field or window name>, which invokes a “Send an email” command and further transfers control to an apporiate window and (optionally) an appropriate field within that window. More specifically, this set of commands transfers the user to the Select Recipients or Find People windows. (Other commands invoke address book windows, pages and fields in a similar manner). The term joined (or “transitional”) is used to express the rhythmic/context modification enabled by such a command. For example, a user might recite “Send an email to phone number”, which not only selects the phone field for subsequent user entry of a telephone number, but also effectively changes the context and rhymic meter. That is, the new context of criteria based extraction also enables an intuitive shift in rhythmic flow appropriate to the context (ignoring enabled alternatives). Here (as with similar address book instances) the rhythmic flow is much simpler. The user can simply state a field and then separately state the data to be entered in that field (e.g. “555-5555” . . . “Name” . . . “John”, etc.).

While necessitated due to NS inability to use variable new data, clearly the abilities to change context and rhythm, and further to use partial commands would remain useful alternatives even when the NS deficiency is corrected in providing a complete and thus intuitive and efficient conversational experience. Additionally, other interface aspects are also used in both the address book and Find People cases whereby an arrow (here, a mousepointer) is used to indicate an entry field. However, continued use of the pointer is maintained only within the address book. Preferably, such use is determined based on the complexity of the display as well as the tendency of the feedback utilized to either clarify or distract a user, among other factors.

5. Analyzing the Potential Command Forms to Determine Their Compatibility with Other Commands Having Converging Similar Contexts and, If Needed, Adding Alternative Commands.

The remaining step serves as a final check to make sure that the interface provides a more complete conversational experience for varying users. If needed, superfluous and/or conflicting contexts, task inferences, dictation conflicts, etc. can be resolved in accordance with the above methods. Additionally, command verbiage and/or command alternatives can further be provided. As was briefly noted in the foregoing, such alternatives serve as optional replacements for corresponding verbiage and—if needed—other aspects of or even whole commands. It will be appreciated that—aside from reversible commands—such changes can have a tremendous impact and should therefore be utilized sparingly.

The foregoing description of the preferred embodiments of the invention is by way of example only, and other variations of the above-described embodiments and methods are provided by the present invention. Components of this invention may be implemented using a programmed general purpose digital computer, using application specific integrated circuits, or using a network of interconnected conventional components and circuits. Connections may be wired, wireless, modem, etc. The embodiments described herein have been presented for purposes of illustration and are not intended to be exhaustive or limiting. Many variations and modifications are possible in light of the foregoing teaching. The system is limited only by the following claims.

[image]

[image]

[image]

[image]

[image]

[image]

[image]

[image]

[image]

What is claimed is:

1. An interfacing method comprising:
receiving machine information corresponding to a machine;
determining objectives corresponding to the machine information; and
determining conversant commands corresponding to the objectives.

2. A conversant interface formed according to the method of claim 1.

3. An interfacing system comprising:
means for receiving machine information corresponding to a machine;
means for determining objectives corresponding to the machine information; and
means for determining conversant commands corresponding to the objectives.

4. A computer readable medium having stored thereon computer code for causing a computer to perform the steps of:
receiving machine information corresponding to a machine;
determining objectives corresponding to the machine information; and
determining conversant commands corresponding to the objectives.
